(19) United States
(12) Patent Application Publication
(10) Pub. No.: US 2005/0007257 A1
(43) Pub. Date: Jan. 13, 2005

(54) System and method of preventing aircraft wingtip ground incursion

(76) Inventor: Rodger H. Rast, Gold River, CA (US)

Correspondence Address: RODGER H. RAST, 11230 GOLD EXPRESS DRIVE, SUIT 310 MS 337, GOLD RIVER, CA, 95670, US

(21) Appl. No.: 10/909,106

(22) Filed: Jul. 30, 2004

Related U.S. Application Data
(63) Continuation-in-part of application No. 10/245,909, filed on Sep. 15, 2002.
Application No. 10/245,909 is a continuation-in-part of application No. 09/854,028, filed on May 11, 2001, now Pat. No. 6,486,798.
(60) Provisional application No. 60/394,160, filed on Jul. 1, 2002.
(60) Provisional application No. 60/203,564, filed on May 11, 2000.

(51) Int. Cl. G08B 5/22

(52) U.S. Cl. 340/815.45; 340/983

(57) ABSTRACT

An apparatus and method for tracking aircraft wingtip position during taxi operations to prevent wingtip ground incursion. A patterned illumination source is attached proximal the wingtips to project a readily discernable target pattern in the direction of taxi travel. At least a portion of the target pattern is reflected off of any obstructions that lie in the straight-line direction of travel, such that the pilot can maneuver to avoid striking the obstruction. By way of example, the patterned illumination source comprises a laser module positioned with the navigation and/or strobe light of the aircraft. The device may be retrofitted to existing aircraft without additional wiring with the control of activation being selectable via power cycling of existing aircraft lighting controls. One aspect of the invention provides a tip tracking module bulb that may be retrofitted into existing light sockets to simplify system installation.

### CROSS-REFERENCE TO RELATED APPLICATIONS

This application is a continuation-in-part of copending application Ser. No. 10/245,909 filed Sep. 15, 2004, now U.S. Pat. No. ______ issued ______ Priority is also claimed to application Ser. No. 09/854,028 filed on May 11, 2001, issued as U.S. Pat. No. 6,486,798 on Nov. 26, 2002, and from regular application Ser. No. 10/867,615 filed Jun. 14, 2004; provisional patent application 60/478,900 filed Jun. 14, 2003; provisional patent application Ser. No. 60/394,160 filed Jul. 1, 2002, and from Ser. No. 60/203,564 filed May 11, 2000.

This application is related to copending application serial number 09/730,327 filed Dec. 5, 2000, and to provisional patent application Ser. No. 60/153,084 filed Sep. 9, 1999, which are commonly assigned with the present invention.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to aircraft safety systems and more particularly to a system and method for preventing collisions between the wingtips of an aircraft moving on the ground and obstructions.

2. Description of the Background Art

Aircraft are subject to a variety of collision situations both in the air and on the ground. Air traffic control equipment and infrastructure assures safe flight paths. Recently, advanced GPS systems have been proposed to allow pilots to verify separation between themselves and other aircraft.

Yet one form of collision situation has not been fully addressed are the ground incursions that can occur when an aircraft is being taxied near other aircraft and obstructions. These ground incursions may be of the “hangar rash” variety, while in other cases enough damage is sustained to render the aircraft not airworthy.

Airports are often overcrowded with aircraft, while the taxiways are small and may be subject to further encroachment by poorly-parked aircraft. The problem is especially difficult for pilots taxiing in small airports as it is difficult to maneuver the typical 25-40 foot wingspan of a private aircraft or small commercial aircraft amidst a crowded taxiway while keeping the tips from striking other aircraft or obstructions that exist alongside the taxiway. In order to maintain clearance from other aircraft, the pilot must look in front of the aircraft while closely monitoring the wingtips on either side of the aircraft.

The difficulty in judging whether a distant wingtip may strike a distant obstruction, such as the empennage, propeller, or wingtip of another aircraft, should be appreciated. For example, if the tip of the wing is twenty feet (20 ft.) from the pilot, then the pilot must attempt to verify that the nearby obstructions are more than twenty feet (20 ft.) away. Any error in making this distance judgment can lead to damages to both aircraft. The situation is far different from a driver attempting to park a car, because a driver is close enough to the periphery of a car, or even a side of the motor home, to judge the side-distance and generally may only require help in judging the in-line distance to the obstruction.

In considering an aircraft, however, the position of the obstruction is far removed and distance must be judged in relation to a wingtip which is also far removed from the pilot. During taxiing the pilot is continually attempting to judge if an obstruction is in a forward line with one of the other wingtip. Furthermore, it will be appreciated that the pilot must correctly judge the distance well before the tip of the wing approaches the obstruction so that sufficient maneuvering room exists for getting around the obstruction.

As few aircraft have the ability to reverse engine thrust during low speed ground operations, the pilot facing insufficient clearance situation is required to shut down the aircraft and use a tow-bar or get the assistance of a tug if an obstruction is detected too late, such that insufficient maneuvering room exists. The lack of clearance information coupled with the “embarrassment” of exiting the aircraft to check if proper clearance is available or to back up the aircraft, leads many pilots to push a bad situation wherein damage is often the result. In some cases the situation is further aggravated when damage is not reported and aircraft having structural damage or damaged lighting systems may be flown.

As can be seen, therefore, the development of an apparatus and method for tracking wingtip position in relation to forward obstructions can prevent a number of minor collisions, and reduce “hangar rash”. The system and method of preventing aircraft wingtip ground incursions in accordance with the present invention satisfies that need, as well as others, and overcomes deficiencies in previously known techniques.

### BRIEF SUMMARY OF THE INVENTION

The present invention is a system and method for tracking the relative position of the wingtips of an aircraft by utilizing an illumination pattern projected forward of the wingtip to aid the pilot in judging the proximity and relative alignment of nearby aircraft or obstructions. The system employs a set of forward projecting beams, such as from a laser light source, which are configured on the aircraft to project forward of the wingtip a two dimensional pattern to illustrate conditions of an impending collision so that the pilot can easily avoid the obstruction.

The beams are projected from the wingtip in a pattern that preferably yields information to the pilot as to both obstruction forward distance and lateral distance. The beams are preferably projected as patterns which shown up as two dimensional when striking an obstruction surface. It will be appreciated that a single dot of illumination or even a line does not provide distance information and furthermore it can not provide information as to the relative lateral separation. By way of example and not of limitation, the beams may be projected as circles, cross-hairs, boxes, and so forth, whose projected size is an indicator of forward distance, and whose projected position on a subject obstruction determines the amount of the obstruction that may be struck should the aircraft continue traversing a straight path.

It should be readily appreciated that although it is preferable to generate at least one beam from each wingtip to provide feedback from both sides, the invention can be practiced using a beam from a single wingtip. Although this implementation would not provide clearance indications from each wingtip, it would still provide advantages to the pilot relying on distance indications from a single side of the aircraft.

A number of embodiments are described for implementing the patterned illumination source and control of the present tip tracking system. It will be appreciated that multiple illumination sources may be incorporated to more precisely gauge distance, or angle, or for aiding with the detection of distance for other aircraft surfaces, such as the tail surfaces. For example, one embodiment is exemplified utilizing a pair of central vertical-fan laser beams coordinated with spiral-rotation laser beams on the tips wherein the distance and relationship of the wingtip and the upcoming object is represented by the light pattern thrown-up on the obstruction.

The cross section of the projected illumination is preferably a discernable two-dimensional pattern, such as circular. The pattern may be formed dynamically, such as nutating pattern, or statically, such as with a grating or mask. A nutating pattern is preferred subscribes a conical pattern. One preferred spread angle for the pattern provides a circle diameter in feet C_{f}=D/5. At five feet from an obstruction the circle diameter is one foot while at ten feet the circle diameter would be two feet. Having one or more predetermined spreads allows the pilot to very accurately gauge both the forward and lateral distance from the wingtip to possible obstructions. The speed of rotating pattern being preferably sufficiently rapid so as to be perceived as a circle, but slow enough that the beam motion within the pattern is discerned. Preferably the nutation is generated between about 80-200 RPM.

The angle of the pattern being projected may be fixed, or controlled within the present system either manually or automatically. For example, the unit may generate a sequence of pattern sizes (pattern angle spreads) wherein different conditions, such as turning may be automatically accommodated. This may be accomplished using a mechanical nutation actuator, for instance one that alters the diameter of nutation in response to changes in rotational speed. Alternatively, the user can be allowed to select the angle over which the pattern is generated.

The tip tracking system may include a single patterned illumination unit installed near each wingtip of the aircraft, such as retrofitted within a navigation light, strobe light, landing light, or otherwise connecting into electrical systems of the aircraft. Embodiments are described for adding the tip tracker system to an aircraft being built, and for modifying existing aircraft to accommodate the tip tracking functionality.

Embodiments are described in which the patterned illumination element of the tip tracking system may be installed as a module, integrated with a tip lighting element, or installed as a replacement lighting element (i.e. bulb) that may be readily retrofitted to existing aircraft. Within a replacement bulb, the patterned illumination source (i.e. laser) is collocated with the traditional navigation lighting element (or a substitute thereof), wherein an extremely simple installation is assured. A replacement bulb providing similar aspects of the tip tracking system may be created for other applications as well, such as in other forms of vehicles that are currently provided with incandescent bulbs, for instance automobiles.

Although, clearance is not typically a problem in automobiles the illumination may be provided to attract additional attention and/or as an entertainment or customization element. The additional projective illumination source (i.e. laser) in this instance it is preferably oriented substantially toward the top of the bulb. The illumination by the laser may also be preferably adjusted so that it is directed down toward the ground so as not to become a nuisance to other drivers.

A number of embodiments describe methods of controlling the operation of the tip lighting beams, such as wired connections, superimposing power-line signals, reversing power-line voltages, and even the use of radio-frequency communications between the pilot and a controller which regulates tip lighting beams. These embodiments allow the system to be retrofitted easily readily within existing systems or designed into new installations.

Embodiments of the tip-tracker may be described in a number of ways including as an apparatus for generating a horizontal collimated beam from a lighting element mounted proximal to the wingtip of an aircraft, comprising: (a) a laser element coupled to an electrical power regulating device and configured for outputting a collimated beam of light; (b) a single-axis actuator coupled to the laser element and configured for modulating the direction of the laser element along a single dimensional axis; and (c) means for optically redirecting the collimated beam across a second dimensional axis in response to the collimated beam traverses the single dimensional axis.

An aspect of the present invention may be described as an illumination bulb module, comprising: (a) a housing adapted for receiving power from a bulb receptacle into which it is inserted; (b) at least one solid state light emitting element (i.e. LEDs) joined to the housing and adapted to generate a partial or fully omni directional lighting pattern; and (c) a laser diode illumination source within the housing, adapted for directing a narrow beam of illumination in a predetermined direction. The partial or fully omni directional lighting pattern is configured to be equivalent to a conventional illumination element, for example a bulb within the navigation lights of an aircraft. The light may be restricted to a a portion of the area about the bulb such as facing forward on the case of an aircraft navigation bulb. The lighting system into which the bulb may be utilized may be any of the following: airplanes, automotive, truck, motorcycle, boats, or other lighting system. A controller circuit is preferably incorporated within the housing, adapted for controlling the power applied to the laser diode element.

Another aspect of the invention may be generally described as a light beacon apparatus for increasing aircraft recognition during flight comprising: (a) a housing having transparent portions and configured for attachment to an aircraft; (b) a power connection from the housing to receive power from an aircraft to which the housing is connected; (c) a laser light source retained in the housing; (d) a power supply receiving power from the power connection for regulating the current applied to the laser element in the laser light source; (e) at least one substantially non-directional light source configured to generate a flashed or rotating light output in response to power received from the power connection; and (f) means for directing the laser or its output light beam in a circular pattern about a substantially horizontal plane.

Another aspect of the invention may be generally described An apparatus for registering aircraft loading as an aircraft taxies, comprising: (a) a plurality of weight sensors configured for application to a taxiway and oriented at multiple different angles in relation to a given compass direction; and (b) means for generating aircraft loading information in response to the output signals from said plurality of weight sensors.

It will be appreciated that the present invention describes a number of beneficial aspects, including but not limited to the following.

An aspect of the invention is to provide additional positional feedback to the pilot of the aircraft relating the position of their wingtips to nearby obstructions.

Another aspect of the invention is to create a tip tracking system that provides a forward distance reference for the pilot between a wingtip and a possible obstruction.

Another aspect of the invention is to create a tip tracking system that provides a lateral distance reference indicative if incursion along a travel path is likely.

Another aspect of the invention is to provide a tip tracking system that may be easily retrofitted to existing aircraft.

Another aspect of the invention is to provide a tip tracking system that may be installed by replacing the existing navigation light bulb with a unit which contains a means for generating the distance indicating beam directed forward of the wingtip.

Another aspect of the invention is to provide a tip tracking system that does not require that additional wiring be routed through the wings of an aircraft.

Another aspect of the invention is to provide a system of tip tracking that is reliable for both day and night operations.

Another aspect of the invention is to provide a system that can optionally provide very accurate distance information from the aircraft to obstruction.

Another aspect of the invention is to provide feedback to the pilot so that operation of the system can be verified.

Another aspect of the invention is to provide an automatic means of shutting down the tip tracking system to reduce the likelihood of inadvertent airborne operation.

Another aspect of the invention is to provide a tip tracking system that may be mounted to the airframe with minimal airflow disruption and commensurate drag.

Another aspect of the invention is to provide a tip tracking system that may be mounted to the airframe with minimal airflow disruption and commensurate drag.

Another aspect of the invention is to provide a tip lighting system having multiple high efficiency distributed lighting elements, such as LEDs.

Another aspect of the invention is to provide a tip lighting system having multiple distributed lighting elements which can be modulated to create additional lighting effects such as twinkling, flashing, for example to enhance the safety of ground operations.

Another aspect of the invention is to provide embodiments of nutation actuators for the tip beam which are readily fabricated at low cost.

Still further objects of the invention provide

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is plan view of an aircraft which is in imminent danger of collision during taxiing, wherein the tip tracking system according to the present invention has illustrated the impending collision to the pilot by “painting” a circle on the upcoming obstruction.

FIG. 2 is a front view of the aircraft of FIG. 1, wherein the forward emitting pattern from the lasers is shown clearly.

FIG. 3 is a side view of the aircraft of FIG. 2.

FIG. 4 is a schematic of a navigational light circuit shown with the tip tracking circuit according to one aspect of the present invention.

FIG. 5 is a diagram of a motor-driven rotational laser source utilized within an embodiment of the present invention.

FIG. 6 is a side view of a vertically mounted wingtip laser source employing a mirror for directing the beam forward.

FIG. 7 is a top view of the wingtip laser source of FIG. 6.

FIG. 8 is a top view of a simple form of automatic shut-off device according to an aspect of the present invention.

FIG. 9 is a facing view of the automatic shut-off device of FIG. 8.

FIG. 10 is a side view of a light element for a tip tracking system which is configured for mounting in combination with a conventional navigation or strobe light.

FIG. 11 is a plan view of an aircraft to which the tip tracking units of FIG. 10 have been mounted according to an embodiment of the present invention.

FIG. 12 is a side view of a light element upon which a light patterning device have been attached according to an aspect of the present invention.

FIG. 13 is a facing view of the light patterning device of FIG. 12 configured for mounting to a strobe or navigation light according to an aspect of the present invention.

FIG. 14 is a side view of another embodiment of the tip tracking system according to the present invention, shown configured as a removable module for insertion within an adapter configured for use with a particular form of navigation lighting installation.

FIG. 15 is a facing view of the embodiment depicted in FIG. 14.

FIG. 16 is sectional side view of navigation bulb element into which a projective light source is integrated according to another embodiment of the present invention.

FIG. 17 is a sectional top view of the navigation bulb depicted in FIG. 16.

FIG. 18 is a sectional side view of a lens housing fitted with reflectorized lens according to an aspect of the present invention.

FIG. 19 is a sectional side view of a pattern projection element oriented for direct projection within the bulb housing according to another embodiment of the present invention.

FIG. 20 is a detailed view of a positioning adjustment mechanism according to an aspect of the present invention.

FIG. 21 is a side view of a power takeoff element according to an aspect of the present invention shown for deriving power for the tip tracking unit from a fixture into which a conventional lighting element would be retained.

FIG. 22 is a sectional view of a light pipe being utilized for redirecting projective illumination according to an aspect of the present invention.

FIG. 23 is a side view of a reflective member for redirecting the angle of the projective illumination source according to an aspect of the present invention.

FIG. 24 is a schematic of a circuit which allows for operating the projected illumination source when the power has been interrupted, according to an aspect of the present invention.

FIG. 25 is a schematic depicting another embodiment of the circuit shown in FIG. 24.

FIG. 26 is a schematic of a circuit which allows for controlling the activation of a strobe light that is connected to the same power connection as the navigation lights and the tip tracking system, according to another embodiment of the present invention.

FIG. 27 is a schematic of a circuit that may be utilized for powering the tip tracking system in response to reverse currents on the power line, according to another aspect of the present invention.

FIG. 28 is a schematic of a circuit for superimposing activation signals on a power line for controlling the tip tracker system, strobe, or other units, according to another aspect of the present invention.

FIG. 29 is a schematic of a simple separate switch circuit for superimposing activation signals on a power line for controlling the tip tracker system according to an embodiment of the present invention.

FIG. 30 is a schematic of a circuit for controlling the operation of the tip tracking system when operated from a separate power source according to an embodiment of the present invention.

FIG. 31 is a top view of a motored nutating drive for a tip tracker lighting device according to an aspect of the present invention.

FIG. 32 is a side of the motored nutating drive of FIG. 31.

FIG. 33 is a schematic of a mechanism for converting planar motion to a nutating pattern for a lighting system according to an aspect of the present invention.

FIG. 34 is a perspective view of a electromagnetic nutating actuation system for a lighting system according to an aspect of the present invention.

FIG. 35 is a schematic for the nutating actuation system of FIG. 34.

FIG. 36 is a side view of a muscle wire actuation system for a lighting system according to an aspect of the present invention.

FIG. 37 is a schematic of the muscle wire actuation system of FIG. 34.

FIG. 38 is a side view of a lighting system according to an aspect of the present invention, shown utilizing discrete LEDs as a navigation lighting element.

FIG. 39 is a top view of a self-illuminating material according to an aspect of the present invention, showing flexible electrical generating protrusions.

FIG. 40 is a side view of the self-illuminating material of FIG. 39.

FIG. 41 is a schematic view of the self-illuminating material of FIG. 39 and FIG. 40.

FIG. 42 is a side cross-section of a power generating material according to an aspect of the present invention.

FIG. 43 is a side cross-section of another power generating material according to an aspect of the present invention.

FIG. 44 is a facing view of an aircraft having propeller identification lighting according to an aspect of the present invention.

FIG. 45 is a schematic of propeller identification lighting according to an aspect of the present invention.

FIG. 46 is a perspective view of a RFID sensor according to an aspect of the present invention, shown drawing power in response to turbulent fluid flow.

FIG. 47 is a schematic of an RFID sensor as depicted in FIG. 46.

FIG. 48 is a side view of an aircraft lighting beacon according to an aspect of the present invention.

FIG. 49 is a side view of another aircraft lighting beacon according to an aspect of the present invention.

FIG. 50 is a side view of an aircraft landing alignment system according to an aspect of the present invention, shown with the aircraft approaching touch down.

FIG. 51 is a top view of the aircraft landing alignment system as depicted in FIG. 50.

FIG. 52 is a side view of an aircraft power limiting apparatus according to an aspect of the present invention, shown actuating from full power to idle.

FIG. 53 is a schematic of the aircraft power limiting apparatus of FIG. 52.

FIG. 54 is a block diagram of a second level aircraft alert apparatus according to an aspect of the present invention, shown coupled to a moving map display.

FIG. 55 is a block diagram of an in-aircraft weight registration system according to an aspect of the present invention.

FIG. 56 is a block diagram of an automated aircraft weight and balance detection system according to an aspect of the present invention, shown implemented on a taxiway at an airport.

FIG. 57 is a cross-section view of weight registration strips for the embodiment of weight and balance detection of FIG. 56.

FIG. 58 is a block diagram of the automated aircraft weight and balance detection system of FIG. 56.

### DETAILED DESCRIPTION OF INVENTIVE EMBODIMENT

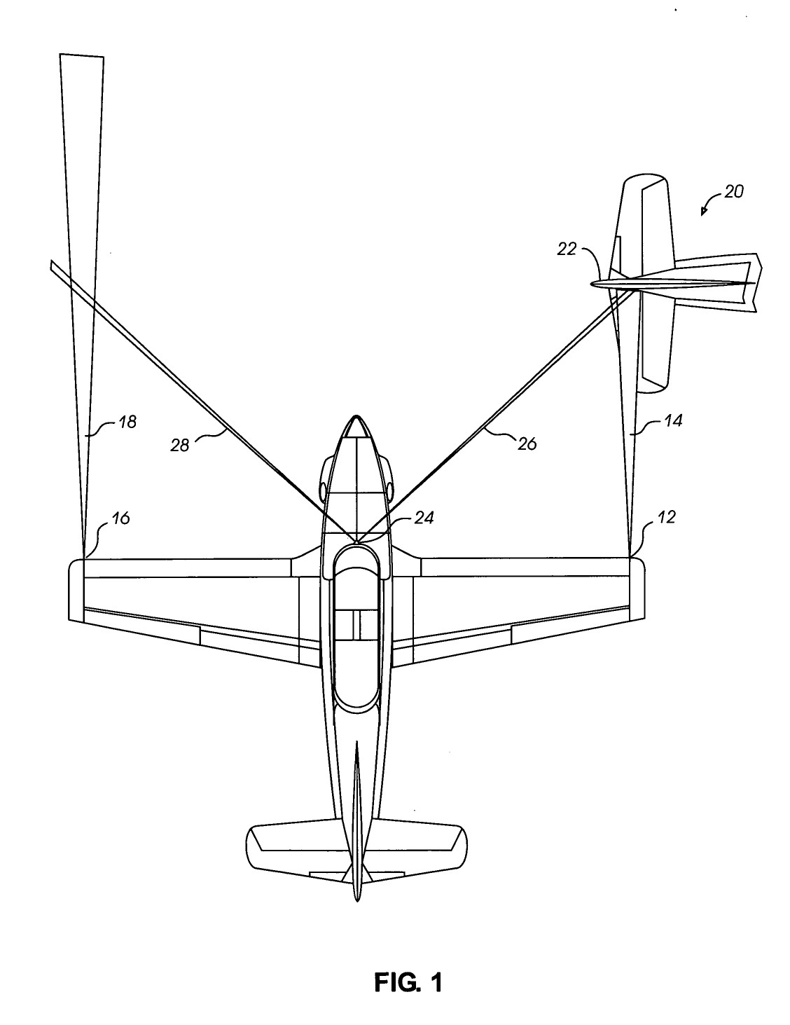

Referring more specifically to the drawings, for illustrative purposes the present invention is embodied in the apparatus generally shown in FIG. 1 through FIG. 30. It will be appreciated that the apparatus may vary as to configuration and as to details of the parts without departing from the basic concepts as disclosed herein.

1. Introduction.

FIG. 1 illustrates an embodiment of the tip tracking system in use while an aircraft 10 taxies toward an obstruction. The illustration depicts a single obstruction being designated by the system, however, it will be appreciated that in general the pilot has sporadically spaced obstructions on each side and is attempting to navigate a path between the obstructions, a path in which the wing tips are not to contact obstructions on either side. The tip tracking system comprises a first wingtip illumination (light) pattern projection source 12, such as a laser, which casts a beam 14, a second wingtip light pattern projection source 16 which casts a beam 18. Beam 14 in the figure is shown being reflected by a portion of the tail surface of obstructing aircraft 20 primarily on the vertical stabilizer 22. When the beam strikes an obstructing surface it can be said to be “painting” the obstruction, in a similar pattern of terminology utilized for radar equipped fighter aircraft.

1.1 Light Intersection Distance Correlation Unit.

An optional distance correlation unit is implemented as a twin beam distance correlation unit 24, which is shown projecting additional distance reference patterns 26, 28, such as vertical slit beams, to accurately register distance information on the same obstruction.

1.2 Tip Mounted Projective Illumination Sources.

The illumination pattern projection source 12, 16 are preferably attached to the wingtips on the farthest protruding section of the tip, however, it is represented by this figure that the beams can still be utilized when attached more inwardly if mounting limitations exist. The angle over which the pattern is projected allows useful lateral distance information to be provided even when the beam is emanating inboard of the wingtip. A significant advantage accrues, however, as a result of mounting the beams on the farthest extension of the wing, wherein the projected beam is capable of registering lateral obstruction distance in a highly accurate manner even as the closing distance is reduced to only inches.

The tip tracking beams are shown directed in a horizontal plane relative to the aircraft in a taxi configuration and positioned in line with a forward direction of travel such that the beam is painted on a portion of any obstruction that may interfere with the forward movement of the wingtip. In use on a crowded airfield the pilot can maneuver the aircraft so that equal fringes of projection appear on opposing sides of the aircraft when traveling in a straight taxi path. If the pilot has sufficient clearance, then as the aircraft gets closer to the obstruction the projected patterns will no longer “paint” the obstruction, that is they will no longer be visible on the obstruction. If the edge of the beam is still painting a surface as the pilot and aircraft draw near, then the pilot should maneuver in the opposite direction if sufficient clearance exists on that other side of the aircraft. It will be appreciated that the beams travel generally in a forward direction and thereby when turning, the distance for which the tip tracker correctly paints an obstructing surface will be reduced.

1.3 Conical Patterned Illumination.

One preferred beam pattern is that of a circular cone which subtends an arc of preferably five to ten degrees (5°-10°) that is generally not to exceed twenty degrees (20°). The shape of the pattern can be altered to comprise any recognizable two-dimensional pattern of sufficient size that will provide forward distance and lateral distance feedback to the pilot. Projecting a single laser beam, however, is prone to mislead the pilot and provides minimal recognition regardless of dimension, while the non-unique, not easily discernable pattern is easy to miss when “painting” obstructions.

The use of a small beam would be further hindered by the fact that the wingtip is of finite dimensions and a small beam would not provide a range warning or a degree of clearance for the wing. Furthermore, the obstruction may contain irregularities, such as cutouts, voids, notches, and grooves, that may conceal a small patch of light.

1.4 Other Patterns of Illumination.

It will be appreciated that the patterning of the projected illumination preferable comprises the projection of a two dimensional pattern onto an obstruction surface, such as a circle, square, ellipse, and so forth which has both horizontal and vertical components and for which size may be relatively easily gauged by a pilot as an indicator of wingtip to obstruction distance, and lateral distance. The aforementioned pattern may be created in the illumination by a number of known mechanisms, for example, optical masks, graticules, lenses containing masks, faceted lenses, mirrored reflectors, optical redirection, and mechanical redirection. The latter approach is utilized within this embodiment with the wingtip beams being projected as circularly rotating beacons to increase recognition and interface with the upcoming surface. Rotation is generally preferred over using a circular graticule as it provides more apparent light to the eye and greater ease of recognition traversing over varied surfaces. A moving mirror or lens may also be utilized for redirecting the projected beam to traverse a desired pattern. However, it will be appreciated that the use of a graticule or other light pattern spreading mechanism can generally be implemented within the present invention at a slightly lower cost and within a more compact form factor.

1.5 Illumination Sources.

The preceding generally describes the use of a laser light source as it provides a high intensity collimated beam of projected light. Other sources of illumination may be alternatively utilized, such as non-collimated light sources of sufficient intensity, such that the amount of patterned light which is projected in the direction of travel is sufficient for the pilot to properly discern distances. A non-collimated light source may alternatively be collimated into a projected patterned beam by the use of lenses, mirrors, or housings which partially surround the light source and allow a column of light to escape from an aperture therein. Numerous alternative optical mechanisms can be utilized to provide a beam covering a set forward angle (or a variable and/or adjustable angle) with light for painting the surface of a forward obstruction. The central twin beam distance correlation unit 24 is preferably implemented to cast vertical slit beams 26, 28 out forward of the wings as a vertical projection which intersects the tip beams at a fixed distance as shown. It will be appreciated that multiple beam correlation units could be utilized. A graticule or alternative optical device may be used for generating the slit beam.

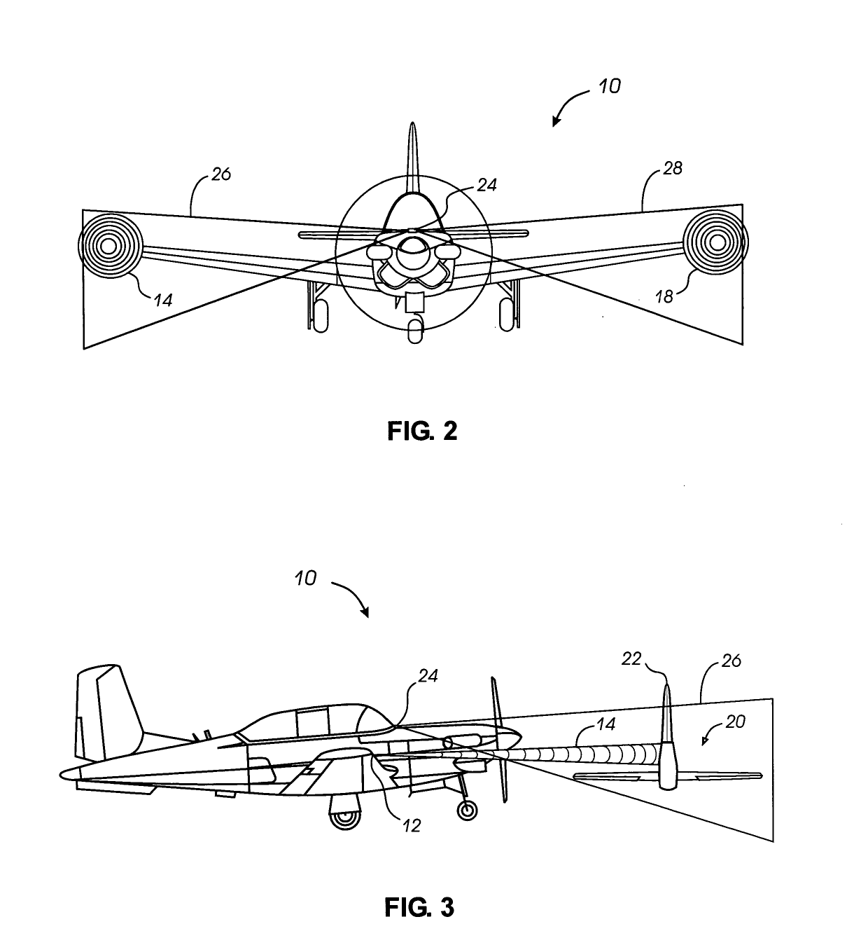

Alternatively the central twin beam unit may project a series of vertical projections in similar fashion to a scale wherein different forward distances are thereby represented by the intersection with the wingtip beam units 12, 16. At a predetermined fixed distance, the vertical line projected by the central twin beam unit 24 splits the circular pattern generated by one of the wingtip beams 12, 16 on the obstruction painted by the beams. It should be recognized that the diameter of the beam painted on the obstruction indicates, albeit less precisely, the distance from the wing tip to the obstruction. FIG. 2 and FIG. 3 provide additional views of the light beam patterns emitted and their interaction with the obstruction.

2. Circuit Considerations.

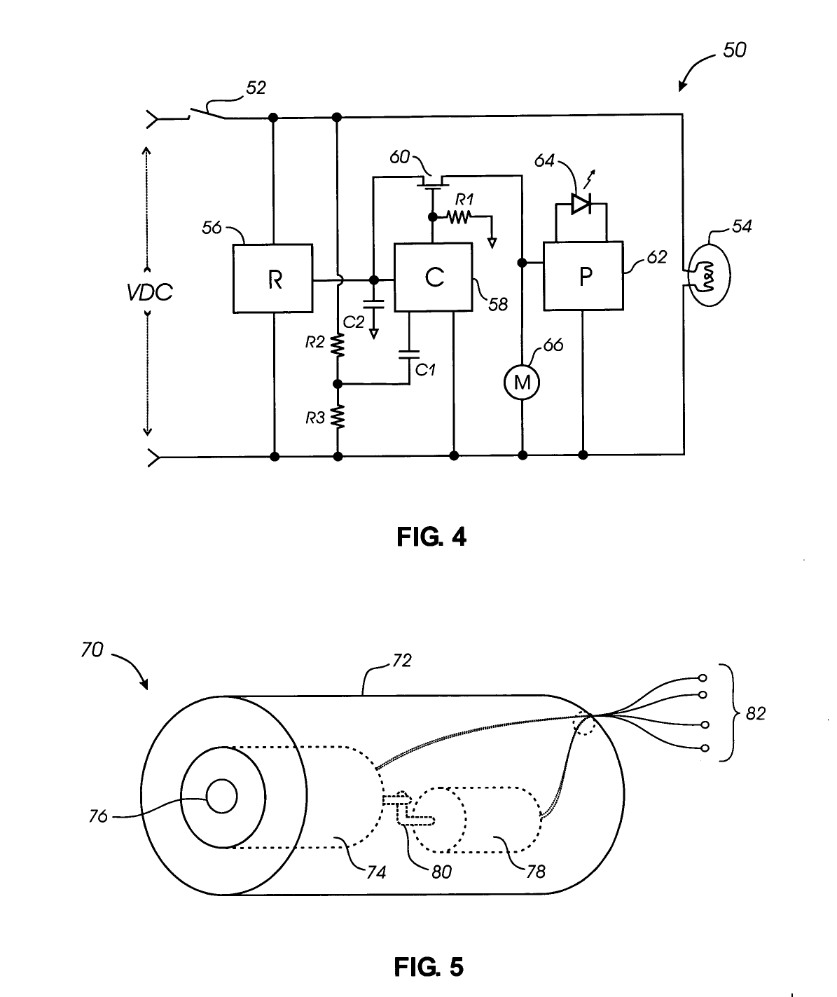

FIG. 4 depicts a power activation circuit 50 for driving wingtip light pattern projection sources 12, 16 as shown in FIG. 1, which by way of example are considered to be laser light sources. Power activation circuit 50 is configured to activate the patterned projection sources upon receiving an electrical signal from a control device. A number of control devices may be utilized for controlling the power activation circuit, including other devices, switches, or existing power switches that are cycled in a pattern.

2.1 Retrofit Installations.

The tip tracking system may be installed in a new aircraft with a separate control switch and a set of power control wires routed to the patterned illumination units. However, it is generally more difficult to retrofit existing installations as access is not available to the wiring or switches. Therefore, a large portion of the application addresses different modes of providing installation on existing aircraft. Conventional navigation light systems provide a direct current voltage source through an activating switch 52 to one or more incandescent tip light 54, such as running lights or colored navigation lights (either red or green).

2.2 Controlling Tip Tracker Activation.

The tip tracker circuit 50 is preferably connected into the power to the tip light such that a regulator 56 provides a stepped-down voltage to a controller 58 which is capable of modulating a switch 60, preferably a FET, through which power is provided to a laser diode power supply 62 powering a laser diode 64, and supplying power to a small motor 66 for driving the beam in a circular rotation (nutation).

The system is shown for use in an aircraft, wherein no additional control wiring need be routed from the cockpit. In this implementation the pilot merely toggles a pilot accessible activation switch mechanism, such as the running lights (nav lights) in a sufficiently predetermined pattern to create an electrical signal for detection by the power activation circuit. For example, the pilot toggles the navigation lights ON, OFF, and then ON again wherein the first ON and OFF intervals are between approximately one half second, and one and one half seconds, (½ S to 1½ S), which signals the power activation circuit of the tip tracker system to enable and operates the patterned projected illumination beams, laser diode 64, for a fixed period of time. Controller 58 powers-up when power is first engaged and is preferably configured with a timer circuit to disengage power to the patterned projected illumination sources after a selected interval of time has elapsed.

Controller 58 is configured to remain operating even when the power is off for a number of seconds, the amount of time being determined by the value of capacitor C₂ that retains a charge sufficient to sustain operation for 1-2 seconds. The controller upon power-up monitors for a subsequent OFF period (of less than 1-2 seconds) after which power is restored. Upon meeting these conditions the controller activates switch 60 to engage the laser LED and engage the motor 66. After engaging them, the controller 58 preferably metes out a period of operating time, such as one minute, after which the unit shuts down the motor and laser as they need not be operating during flight operations. If the pilot later encounters a constricted taxiway they may resequence the power to the running lights to gain additional system operating time. The circuits on the opposing wingtip and the central dual beam unit can operate with identical circuitry.

It will be appreciated that the tip tracking system may be alternatively adapted for operation directly from a source of power, wherein it operates whenever power is available to the navigation lights, or other form of system power to which it connected.

In addition, the system can be connected with the strobe unit, however, strobes typically operate from extended voltages generated by a step-up power supply located within the aircraft fuselage and run through the wiring to the wingtip—although such voltages can be converted by the power unit shown in FIG. 4, additional design considerations and compatibility issues may arise.

When deployed in a new aircraft design it may be desirable to utilize a separate switch and power routing to individually control power to the tip tracking unit. It will be appreciated that many forms of selective activation may be alternatively implemented by a person of ordinary skill in the art without departing from the present invention.

It should also be recognized that the tip tracking pattern projection lighting and control elements may be integrated within a navigation light, a combination navigation and strobe light, a strobe light, or other wingtip mounted systems.

2.3 Creation of a Nutating Pattern of Illumination.

FIG. 5 depicts a tip tracking illumination beam 70 wherein a tube 72 houses a laser diode module 74 that preferably contains the circuits 50, shown without switch 52, and incandescent light 54. A motor housing 78 is shown positioned within the tube 70 and the shaft of the motor 80 is configured with an angled crank for rotating the end of the laser 74 to provide angular rotation (nutation) thereof. The crank from the motor can also be configured with a compliant member, or a mechanism, whereby the speed of the motor can provide for modulating the angular displacement of the laser during rotation, so that the controller can generate spirals or other features by varying the speed of the motor.

The motor may be controlled by the controller independently of the laser to provide for independent actuations of the laser and motor for such features. The end of laser 74, opposite the attachment with the shaft of the motor 80 is flexibly attached within tube 70, such as by an encircling compliant ring, flexible attach points, or gimballing.

In addition, the laser 74 is preferably provided with shock mounting within tube 70, as the performance of presently manufactured laser diodes is negatively impacted when subjected to a shock force of a sufficient “G” level. Although the wingtip itself by virtue of its long-moment arm and flexible structure generally isolated from sufficiently high G impacts to damage the solid state laser element.

A number of masks, grates, lenses and so forth are available for projecting a beam with any desired pattern. In addition, nutation of the beam can be accomplished in a variety of ways. The use of a static pattern may be used in combination with nutation so as to provide enhanced recognition, such as a small circle, or cross-hairs, that are driven in a nutating pattern.

One method of creating nutation is by using actuators which impart the two axis of movement to the laser diode head to change the angle of emission. This has a number of advantages: (1) the nutation angle and speed of nutation may be changed by the controller; (2) the shape of the pattern emitted may be varied or user selected; (3) the positioning of the center of the beam may be set during a calibration phase (i.e. emit single dot and adjust center location using an input to controller which stores center value in a non-volatile memory).

By way of example, muscle wire actuators may be utilized for tilting a stage upon which the laser diode head is mounted. These may comprise muscle wire strands or actuators powered by muscle wire. A tilting mechanism described under “Controlling Articulated Elements”, is described in patent application Ser. No. 60/394,160 filed Jul. 1, 2002 which is commonly assigned with the present invention. It will be appreciated that muscle wires may be utilized in conjunction with a compliant pillar member, or stage, to modulate the tilt of the platform in an X and Y direction, wherein a circular pattern may be generated as the controller outputs drive power to change the angle so as to follow a desired circular pattern of a desired size. A number of embodiments may be created using this form of stage, or any convenient method of moving the beam in a nutating pattern. It will be appreciated, therefore, that the laser output angle may be modulated by various other means which will be readily apparent to one of ordinary skill in the art.

The light pattern projection sources may be mounted in various ways to the wingtips of an aircraft. For example, laser tube 70 can be mounted in the leading edge of the aircraft tip nacelle, or otherwise in a forward facing portion near the wingtip by various forms of mounting hardware. The tip beam and central twin beam unit may be suitably mounted on high-wing, low-wing and mid-wing aircraft. It should be recognized that other extended aircraft surfaces, such as the tips of the horizontal stabilizer, may be additionally protected in specialized instances by use of its own tip tracking system.

2.4 Use of a Separate Wingtip Housing.

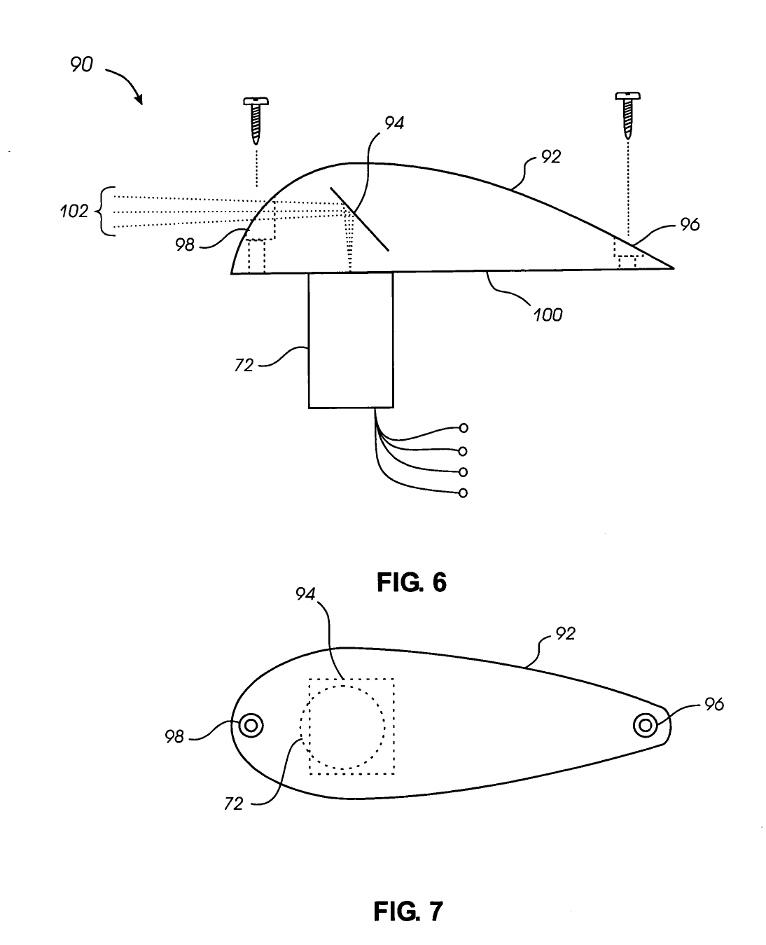

FIG. 6 and FIG. 7 depict an easy to install wingtip beam module 90 having a teardrop shaped housing 92 that utilizes a mirror 94 for redirecting the beam forward. The housing 92 is configured with attachment points 96 and 98 to allow fasteners to engage the unit with the aircraft. The laser beam 102 is shown projected forward of the aircraft. Using the teardrop shaped housing provides for a simplified mounting of the unit to either low or high wing aircraft and facilitates adjustment. It will be recognized that additional beam adjusters, such as threadable shafts engaging the mirror, may be included to provide for additional calibration of beam position after the units have been mounted.

2.5 Preventing Tip Tracker System Activation During In-flight Operations.

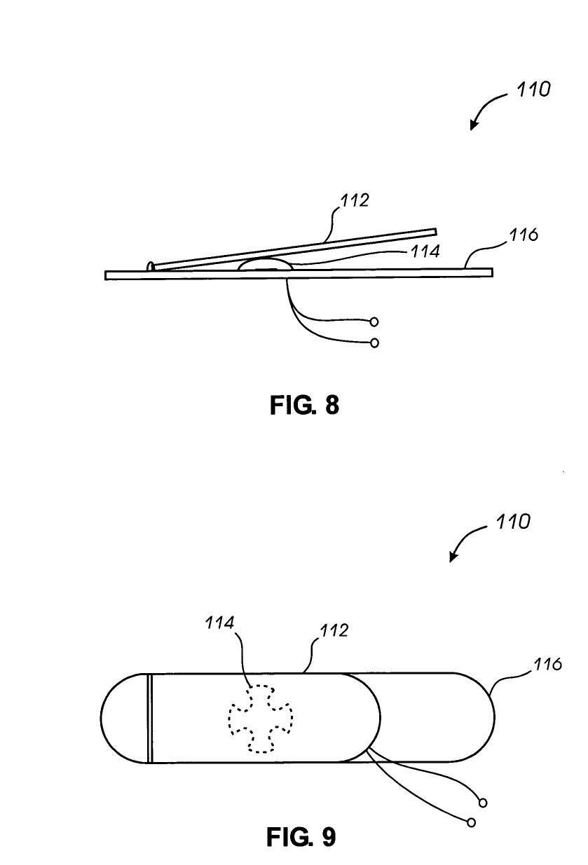

FIG. 8 and FIG. 9 depict a simple automatic shut-down circuit 110 that can be employed to assure that the unit shuts down prior to becoming airborne. A bifurcated flapper style switch comprising a front surface 112 a dome contact 114 and a rear surface 116 having contacts which are electrically bridged upon the collapse of dome 114 that occurs upon a given air-pressure level being achieved.

Numerous variations of speed sensors are common in the art, wherein temperature differences, pressure differences, or acoustic changes may be sensed.

When the speed of the aircraft increases beyond taxi speed the switch closure is sensed by the controller unit which shuts down the tip tracking system.

The speed of the aircraft can be sensed from a central point, or driven from the aircraft speed sensor, such that the power to all navigation lights is interrupted for a period exceeding a few seconds to assure that all tip tracking beams are reset by the controller to an off-mode. Preferably an additional watchdog circuit is incorporated within each controller circuit to monitor the conditions and output of the principle controller and to shut down the units principle controller, laser beam, and motor if the principle controller attempts to operate erroneously.

The airspeed pressure sensing switch described above is preferably incorporated within a tip tracking system module to assure that unit operation is terminated at speed, while the timer further operates to cut off circuit power.

3. Installing Tip Tracking System with Existing Navigation Lighting.

To provide a tip tracking system that may be readily mounted on different aircraft, the unit may be configured as a small module having either a patterned and/or nutating illumination source and control circuitry. The module may then be installed to existing lighting systems or to the airframe. It is preferable that the number of adapters be minimized wherein the units may be readily installed on any aircraft having a lighting system.

3.1 Light Slice Configuration.

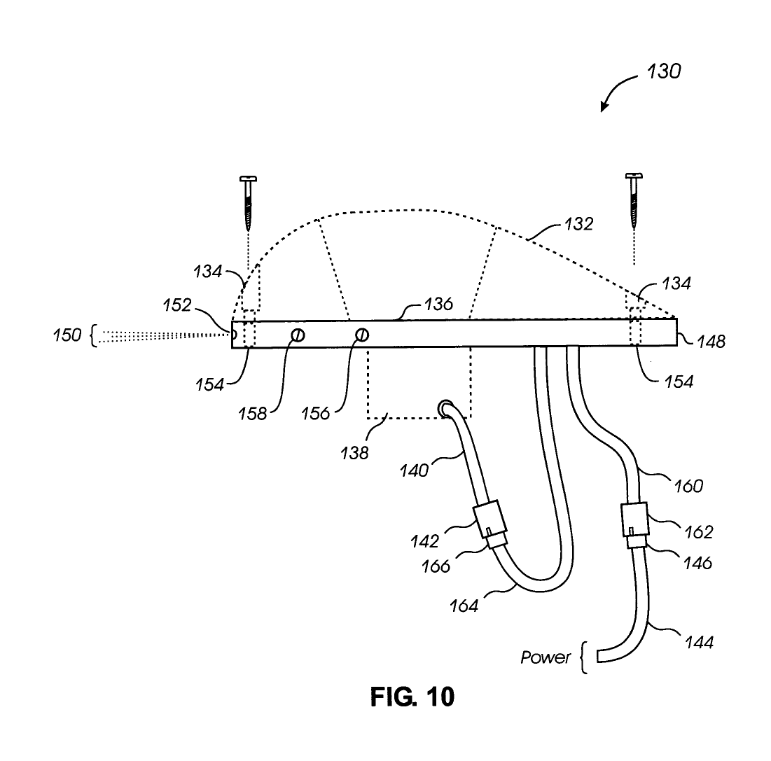

FIG. 10 exemplifies one preferred modular installation 130 of a navigation light system that may be referred to as a “light slice configuration” in reference to how it appears as a slice cut from the extended housing of the navigation light assembly. The light slice module comprises a tip tracking system light projection element 148. To minimize cost and installation difficulty the tip tracking system may be combined to mount in association with a conventional navigation light 132 (shown in phantom). The conventional navigation light 132 is configured as a transparent lens having mounting holes 134 and an inner surface 136 which is retained against the wingtip of the aircraft, or now in this case the light projection element. Typically, an inwardly extended portion 138 of the original navigation/strobe lighting extends into a cutout in the wingtip. Wiring 140 exits the navigation light unit and terminates in connector 142 which is configured for connection to a navigation light power cable 144 configured with connector 146.

Light projection element 148 is shown containing the light pattern projection source and electronics, and requiring only a source of power for operation. It should be appreciated that the system may be implemented by simply installing the “piggyback” style devices on either wingtip and optionally adjusting the units for proper alignment. No additional electronics, wiring, or other configuration needs be performed in order to complete the simple installation shown. The housing is configured to mount in combination with a navigation light unit, strobe light unit, or combination unit. The unit is configured to emit a patterned beam 150 from a light pattern light source 152. The housing for the tip tracker is configured with similar mounting configuration, such as holes 154, to mount in combination with the conventional light assembly 132.

It will be appreciated that few vendors exist (i.e. Whelen®) for the navigation lighting systems and therefore mounting patterns are generally standardized. The direction of the emitted light pattern can be preferably adjusted through a predetermined range by a horizontal adjustment 156 which changes the forward angle in relation to the direction of travel, while vertical adjust 158 is used for altering the vertical projected pattern so that it is projected horizontally in front of the aircraft when it is configured for taxiing.

During installation of the tip tracking system, cable 144 and connector 146 for navigation light power has been reconnected to the tip tracking module through a cable 160 with connector 162. The tip tracking module thereby receives operating power and signals and routes power to the conventional navigation light through cable 164 having connector 166 which is interfaced to connector 142 of the navigation light unit. It should be readily appreciated that the tip tracking unit may be integrated into the design of a combination tip tracker/navigation light, or one that alternatively, or additionally comprises a strobe light unit.

4. Projecting Single Pattern from Each Wingtip.

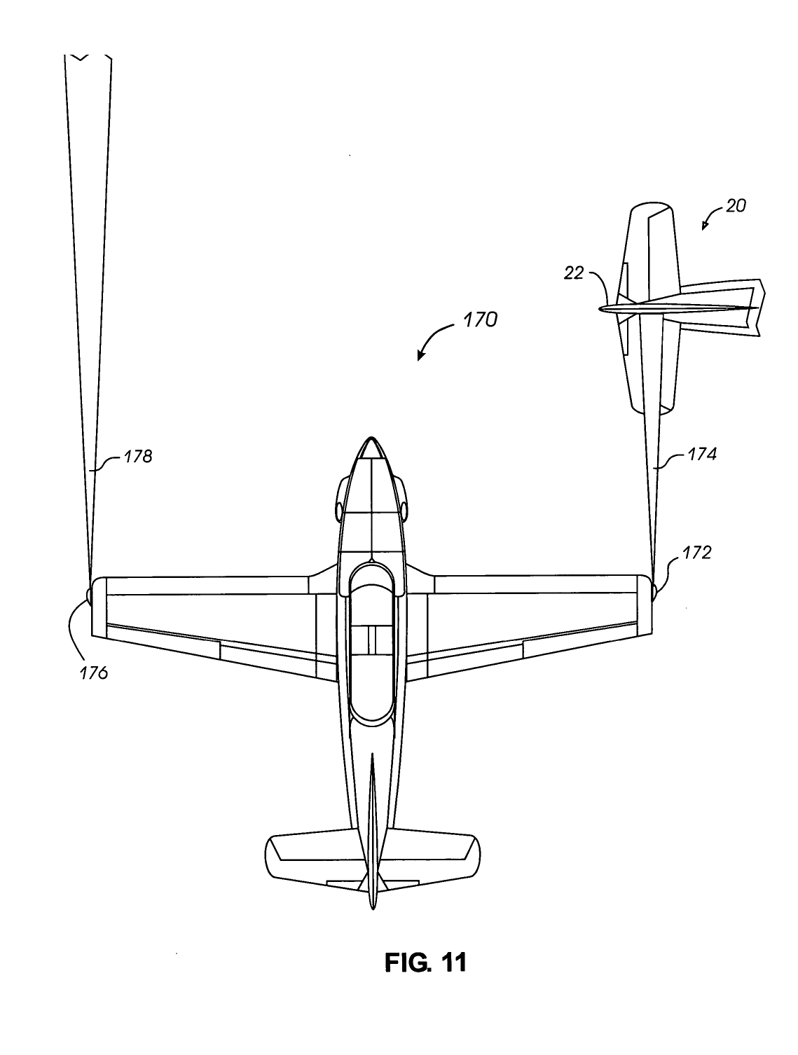

FIG. 11 illustrates an aircraft 170 with tip tracker units 172, 176, installed which are similar to that of FIG. 10. Tip tracker unit 172 projects illumination pattern 174 and tip tracker unit 176 projects illumination pattern 178. As these tip tracker units are shown mounted within approximately one to two inches of the extreme tip exterior they are capable of registering a possible collision at closer ranges than projection unit mounted further inboard, such as shown in FIG. 1. It will be appreciated that the tip tracking system may be employed without the central dual beam distance correlation unit for providing accurate distance marking beams which intersect the beams from the forward facing wingtip beam units. Aircraft 170 is shown having a simplified installation of the tip tracker system which utilizes light projection units on only the outboard wingtips of the aircraft without the use of a distance correlation unit.

The preceding descriptions of tip tracking systems utilize a general method of detection wherein a source of illumination is generated; patterned into a shape that conveys position and distance while being easily discerned from background illumination; and the projecting of the patterned illumination in the direction of travel at the extremity of the aircraft object, such as wingtip, that is subject to encountering obstructions.

The pattern of the light source may be created by numerous methods such as by using masks, or preferably by varying the direction of illumination projection. As continuous operation of the tip tracking system could be distracting to other pilots and airport personnel, the tip tracking system is preferably configured for activation upon receipt of an activation signal, whereupon it operates thereafter for only a brief time period. The power activation circuit detects the signal and engages the illumination sources by supplying them with power which is converted to light energy. The tip tracking system may be deactivated manually, and is preferably subject to a timed deactivation, or optionally an airspeed driven deactivation to reduce the unwarranted projection of light. A number of activation and control mechanisms for use with the tip tracking system are described later in the application.

5. Selecting and/or Modulating Illumination Patterns.

A number of benefits can be derived by providing illumination patterns that span different angular spreads, such as between 50 and 200. For example, changing the angular spread is particularly useful when traversing corners, as a close-up narrow pattern would miss an obstruction that may be struck, such as with the right wing when turning right. The pattern angle may be modulated automatically, such as changing nutation diameter periodically, wherein the pilot gets distance feedback for a range of situations without the need to adjust the illumination angle manually. The pattern angle may be modulated automatically in response to other sensed conditions, such as the rate of turn, wherein the tighter the turn the larger the angular spread generated to compensate for turning angle. The pattern angle may also be set manually, such as by having the pilot select the angle necessary for a given situation.

5.1 Automatic Modulation of Pattern Spread.

If the tip tracking system includes “means for directing the patterned illumination”, then this may be operably coupled to a controller to execute angular spread changes. Alternatively, the means for directing the patterned illumination may be configured for executing a pattern automatically, such as using mechanical means such as cams, or other forms of pattern changes.

Considering the case of changing the pattern spread by changing the nutation angle upon which one or beams are angularly spread. Automatic cone angle changes may be created by configuring the nutation mechanism to transition through a set of fixed patterns, such as angular spread. For example, the aperture of the cone may be varied through multiple angles, (i.e. two, three, or more angles), wherein the circular pattern is displayed in multiple sizes. The wider apertures allow detection of objects farther off line horizontally which may become a problem during a turn in that direction, while the narrower patterns provide more precise information. An output from the controller can be coupled to an electromechanical rotating drive to alter the diameter of rotation. It will be appreciated that multiple circles may be simultaneously generated using optical elements such as splitters. As with any of the features described herein, this aspect of the invention may be utilized with any embodiments of the invention described herein or prior applications.

5.2 Manual Control of Pattern Spread in New Installations.

It should be appreciated that in new installations it is relatively easy to wire in an additional control, such as a potentiometer, or preferably multi-position switch, for setting the angle of pattern spread. The separate control may include an “intensity” control or other scalable input device that would normally be provided along with a set of wiring connected to the laser tip tracking lights. The single control input would preferably control both the activation and the angular spread of the illumination pattern.

5.3 Manual Control of Pattern Spread for Existing Installations.

If a scalable pattern spread is desired for an existing installations, then it is preferably that a signal be communicated to a circuit within the tip tracker control unit. This may be readily accomplished by transmitting a signal over the wires running to the NAV light from an input selector, such as a lighting control switch. The tip tracker control circuit extracts the signal from the line and sets the angular spread accordingly.

To provide a simple pattern spread control between one or two different settings, additional power transitioning, or signal injection, may be performed on the power line and sensed by the tip tracking system. By way of example, angular spread may be selected by: (1) sensing extra power transitions of the NAV switch to select spread, (2) time delays between transitions, (3) the transitions of strobe light power, or other equipment, can be sensed as a control input.

Alternatively a signal for controlling angular spread may be communicated to a remote light unit using a cockpit control connected an RF transmitter that communicates the information to a circuit proximal to the pattern illumination source which is mounted near the wingtip. The use of a remote control mechanism would preferably provide for control of both activation and pattern spread whenever power was provided by the navigation lights, strobes, or other power source available near the tip to which the circuitry of the tip tracking system is connected.

Non-Laser Pattern Projection.

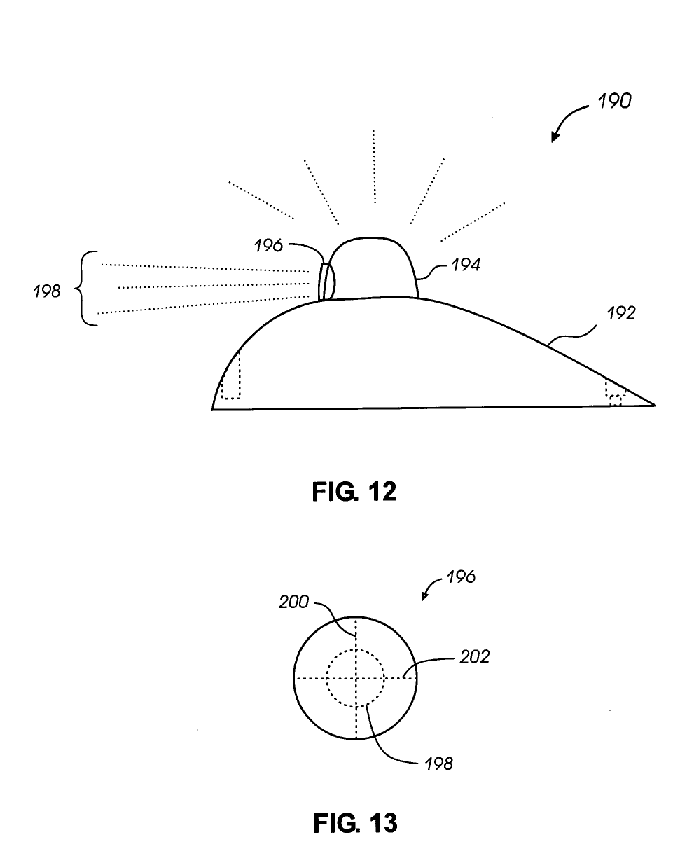

It will be appreciated that wide variations in circuit implementation may be provided for without departing from the teachings of the present invention. A less preferred version is shown in FIG. 12 and FIG. 13 which utilizes the light power of the strobe to provide targeted illumination through a patterned lens, or graticule. A combination navigation light/strobe light 190 is shown in FIG. 12 with a navigation light 192 into which is integrated a strobe light 194. Tip tracking is achieved with the strobe light by affixing a light patterning device 196, such as lens containing a graticule or pattern, onto the forward exterior of the strobe light. FIG. 13 shows a view of a preferred pattern for the light patterning device 196 which is shown configured with a circular light obstructive pattern 198, a vertical line obstruction 200, and a horizontal lines obstruction 202.

A lens shaped device can be made for attachment to existing strobe lights, such as by utilizing optically clear adhesives, to provide the patterned light effect. It should be realized, however, that the resultant tip tracker may be subject to a number of drawbacks, such as loss of pattern definition, due to the non-point source nature of the illumination, and a limited range over which the pattern will be visible. Furthermore, since the strobe light is a white light, it may prove difficult to view the system during operation in daylight.

A light patterning device could be similarly created for use on the navigation lights, however, it will be appreciated that the light intensity of the navigation lights is far less than that of the strobes such that recognition of the pattern in a possible obstructive surface may be further reduced.

A separate patterned illumination source may be incorporated into the strobe system, such as a laser light (static pattern or nutating), which is activated in response to strobe power and fluctuations thereof. Furthermore, a patterned illumination source may be located in relation with a navigation light and yet be powered in response to strobe light activations. It will be appreciated that activating the tip tracking system from the strobe circuit may be desirable if the projected light is to be generated during flight operations to increase forward visibility. Strobes are not generally used on the ground, however, they may be activated in conjunction with the tip tracker patterned illumination or the tip tracker circuit pulsed for activating the tip tracker while leaving the strobes off.

7. Alternative Mechanical Installations.

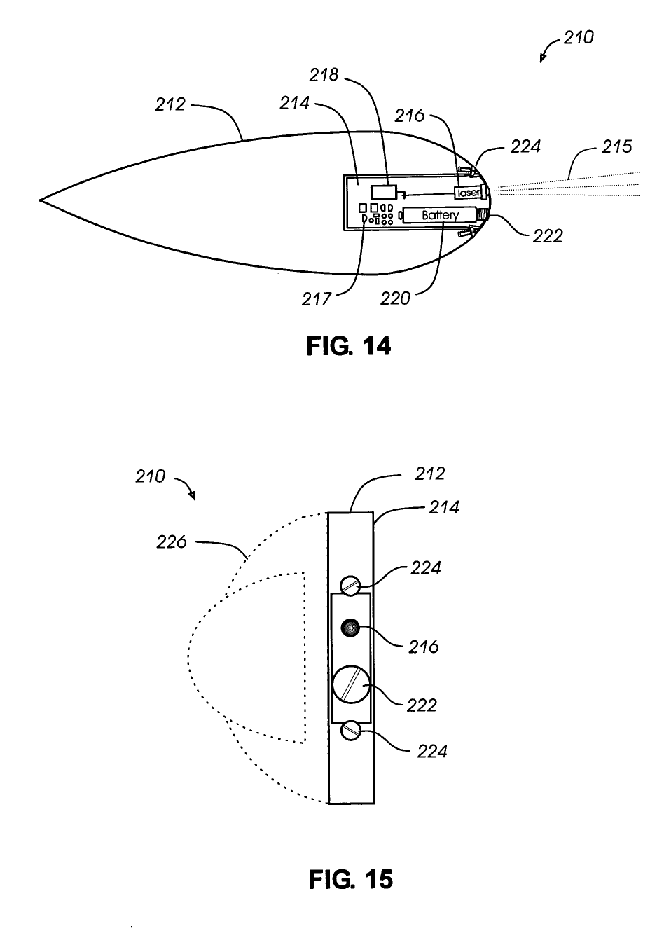

FIG. 14 and FIG. 15 depict a preferable aftermarket modular assemblage 210 of the unit that may be connected beneath conventional navigation, and nav/strobe lighting. This module is shown generally having a similar shape as that depicted in FIG. 10 with an adapter housing 212 that matches that of the navigation light assembly, however, it is configured with a replaceable module 214 containing a battery source (the electronics being described later). It should be appreciated that aspects of tip tracker embodiments may be mixed and matched to create a number of alternative embodiments, which are not described herein for the sake of brevity.

The modular unit 210 is shown in a side view and an end view. A patterned projection source and control module 214 is preferably mounted on a single base (i.e. printed circuit board). Projected patterned illumination 215 is shown being emitted from a patterned illumination source 216 preferably a laser module. Control circuits 217 are shown within module 214 for driving the patterned illumination source 216 and an optional actuator 218, preferably comprising a motor whose output is mechanically coupled to the illumination source 216 for imparting a nutation thereto.

Illumination source (laser) 216 is shown with a positioner controlled by actuator 218, such as a pager motor which is activated to nutate the beam. The diameter of nutation may be controlled roughly by biasing the control shaft exiting the rear of the laser toward the center of rotation of the offset coupling to the motor shaft; wherein as the RPM of the motor are increased the centrifugal force operating on the weight of the shaft overcomes the bias force to extend the angle of nutation. The controller therefore may control the angle by pulse width modulating the output signal to the motor, wherein motor speed is then dependent on duty cycle. Alternatively a stepping motor may be utilized wherein the controller is able to directly and accurately control the speed of rotation. Any convenient method may be chosen for modulating the exit beam angle so as to follow a desired pattern.

Battery power 220 is shown retained within module 214 by a cap 222 allowing ready replacement of the battery. Preferably a self test mode is entered upon powering up the tip tracking system wherein the battery condition is communicated to the pilot, such as by temporarily modulating the light intensity being output, or varying the pattern generated, in response to the measured battery condition so that the user can replace the power source in a timely manner.

The light and control module 214 may then be fitted within a selected adapter mount 212 (the teardrop shaped item illustrated) which adapts the module to a variety of different aircraft and mounting installations. Module 214 is shown retained by retention screws 224, which hold the module securely let allow it to be removed for repair or replacement. Using a small replaceable module, allows the tip tracking system to be readily configured for use on different aircraft, by providing different forms of simple adapters 212, instead of having to create a different tip tracker housing for each installation. It will be appreciated that the front surface of the light module is preferably configured in the same shape for use in all adapters.

8. Integrating Patterned Illumination Source within Bulb or Similar Element.

One elegant method of incorporating the tip tracking system within an aircraft is to provide a module that replaces existing navigation bulbs (or less preferably strobe lights or other elements). This approach has a number of benefits, including that the tip tracking system may be installed by anyone qualified to replace the bulbs, and no modifications to the aircraft or lighting systems is necessary. The tip tracker module which replaces the traditional bulb element unit, is configured to generate the conventional navigation illumination (or strobes, etc.), and additionally to generate the patterned illumination projecting a distance from the front of the wing.

This module may be referred to as a “tip tracker bulb module”, and it preferably contains both a bulb (or solid state equivalent) along with control electronics and a laser configured to generate the desired illumination pattern directed horizontally forward of the wing. It is preferred that the bulb and laser element be detachable from the module to simplify field replacement.

For simplicity the laser element described within this embodiment may utilize a patterned lens element to generate a conical pattern emitting horizontally from the tip of the wing, instead of a nutating electromechanical arrangement. It should be appreciated, however, that a nutating beam, such as driven electromechanically, or using muscle wire actuators, MEMs mirrors, and so forth may be alternatively implemented despite its slightly higher complexity.

It will be noted that only a small number of styles of navigation lighting bulbs exist. The more typical units have a large bayonet mounted base (approximately 0.5 inch diameter) and a bulb of approximately one inch diameter or more. Many of the large bulbs utilized have a reflective coating on a portion of their interior to direct the lighting to the forward quadrant from the wing (so the lighting is seen from the front and side but not from the rear. The large size of these typical bulbs makes them a good candidate for being replaced by a hybrid lighting unit which includes a tip tracking system.

The tip tracking bulb module provides a bulb shaped housing which is manufactured with the correct mounting base, such as bayonet, yet the evacuated bulb portion is replaced with drive circuits, a patterned illumination source (typically a laser), and a small light emitter comparable to the original bulb. The small light emitter may comprise a smaller bulb (many of which are available, i.e. halogen) configured for mounting within a socket or other connector within the form factor of the original bulb. The small light emitter is typically a small incandescent bulb, which may be tungsten, halogen, or any other approved form of light element.

It will be appreciated that as nanostructured forms of incandescent bulbs become available they will be more preferable than using conventional wire filament bulbs in that they generate comparable light approximately 5-15 times more efficiently than conventional incandescent bulbs which lack the nanostructured filament element. Optionally, a reflector may be incorporated to match the characteristics of the original bulb.

As conventional incandescent navigation bulbs have a life expectancy of approximately 300 hours, they are subject to regular replacement. The replacement therefore of the lights with a module containing the tip tracking system is a simple process. In addition, since the light bulbs are radially asymmetrical, such as with a reflector for directing light in the forward quadrant, the mounting socket is already oriented in a fixed direction so that the tip tracking system should require little or no angular adjustments.

8.1 Embodiment of a Tip Tracker Bulb Module.

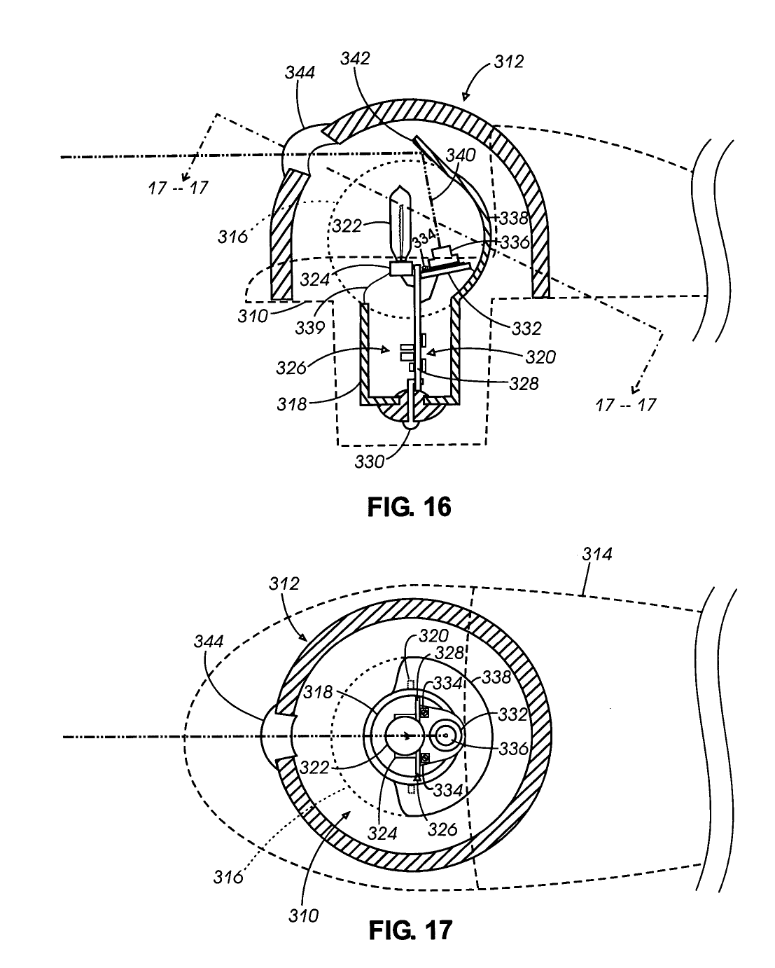

FIG. 16 and FIG. 17 depict a tip tracker bulb module 310 within a conventional spherical colored lens 312 mounted within a housing 314. The outline of a conventional navigation bulb 316 is shown in an outline, in connection with a conventional bayonet mounted base 318 with two extended pins 320 for retention within a slotted spring mounted light fixture (not shown). It will be appreciated that the present tip tracker lighting element follows the general contours of the bulb outline 316 and base 318, so that it may fit within any installation that will accept the bulb. Tip tracker bulb module 310 is shown adapted with a small conventional incandescent bulb 322 to provide navigation illumination. Conventional bulb 322 is shown preferably inserted within a socket 324, although it may be permanently mounted (permanent mounting is less preferable unless a solid state form of long life lighting element is utilized (i.e. LED).

A laser control and power circuit 326 is shown mounted within base 318. Preferably the circuits are mounted on a printed circuit board 328 that makes contact with the pin contact 330 and base 318. The small circuit board after testing is preferably installed within the base, soldered in place whereafter a non-conductive potting compound is used to surround the circuit to provide environmental protection and mechanical stability.

A preferably replaceable laser module 332 is retained within module 310, such as by fasteners 334 which also provide electrical connectivity for this embodiment. A packaged laser diode 336, preferably with lens, is connected to module 332. The laser may be extended on a flexible post or stage wherein the output angle may be modulated in two axis. Laser module 332 is preferable secured into conductive retention apertures connected to the printed circuit board 328 and mechanically secured therein so as to be aligned with the top of the potting compound (which may be ground to fine positional tolerances).

A reflector 338 is shown surrounding a portion of the tip tracker bulb module 310 following the contour of a conventional bulb 316. A tracking beam 340 is shown being emitted by laser diode 336 toward a mirror surface 342 (top portion including mirror is not shown in FIG. 17 for clarity of the underlying elements), wherein it is reflected forward of the wing to “paint” targets in front of the wing to prevent collisions. The position of the mirror may be adjusted slightly to direct the beam in a horizontal line in front of the wing.

The laser beam is capable of penetrating colored lens 312 (red or green), although a certain amount of beam attenuation arises. Therefore, an optional clear lens 344 is shown fitted into lens 312. The lens may be configured with the small clear portion, or the large navigation bulb lens may be adapted for use with the laser beam output. For example, after mounting and aligning the laser, the lens may be trial fitted and marked with the location through which the laser passes. A hole is then drilled of a predetermined diameter at that location. The clear lens element 344 is then inserted and glued (such as with polycarbonate cement, or cyanoacrylic adhesive) to the colored lens 312.

It will be appreciated that a red laser can be transmitted through a red lens with less attenuation than when being transmitted through a green lens. Alternatively a laser fabricated for emitting green laser light may be utilized with the green lens. Due to the more complex fabrication the current prices of green lasers are about an order of magnitude higher than for a red laser, however, the costs are expected to drop as the manufacturing processes mature. Although a mirror 342 is shown as part of reflector 338, other embodiments may be provided which direct the laser light by other means.

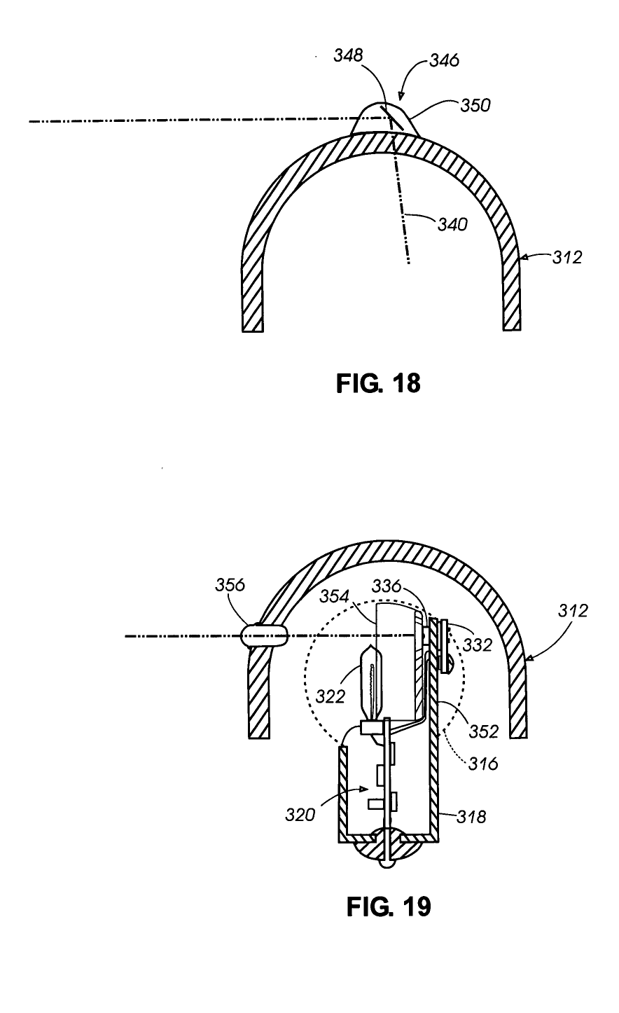

FIG. 18 depicts a combination mirror reflector and lens 346 attached to a colored lens 312, the tip tracker bulb and housing are not depicted. Mirror reflector 346 comprises a mirror 348 embedded within a clear (preferably solid) material 350. The unit may be attached over the tip of lens 312 in alignment with the laser, which has a uniform spherical tip portion. The uniform spherical tip of colored lens 312 simplifies moving the angle and forward and backward orientation of mirror reflector and lens 346 with embedded mirror 348 therein, to properly direct the laser beam for the proper forward direction during taxi operation.

Navigation lens assemblies may be fabricated with an aperture at the tip for receiving the reflector assembly. The vertical angle may then be adjusted for a taxi attitude while the horizontal angle may be adjusted using a set screw, or other adjustment mechanism, within the mirror assembly. In this way the units may be readily fitted to navigation elements and adjusted for the particular angular relationships for the given aircraft.

FIG. 19 depicts direct mounting of the laser element without a mirror assembly. This embodiment eliminates the need of a reflector assembly and directly orients the laser through a portion of the navigation lens forward of the wing so that obstructions are “painted” by the tip tracker. An elevated member 352 is utilized to extend the height of laser element 336 above the height of light source 322. This embodiment shows a portion of the cylindrical base extending upward and upon which a laser module 332 is attached to contacts extending down to the circuitry. The positioning of the laser light may be altered by simply bending the metallic member supporting laser element 336, until proper forward alignment is achieved. An optional section of curved mirror reflector 354 provides redirecting a portion of the light from bulb 322 and is adapted with an aperture through which the laser light is directed. The reflector may be alternatively incorporated within the upwardly extending member 352, implemented with other structures, or left off entirely.

An optional form of cylindrical lens is shown 356 in phantom, it will be appreciated that such a lens takes up little room and does not alter the beam pattern. Furthermore, the direct illumination embodiment shown should suffer from slightly less attenuation due to the direct nature of the laser light output.

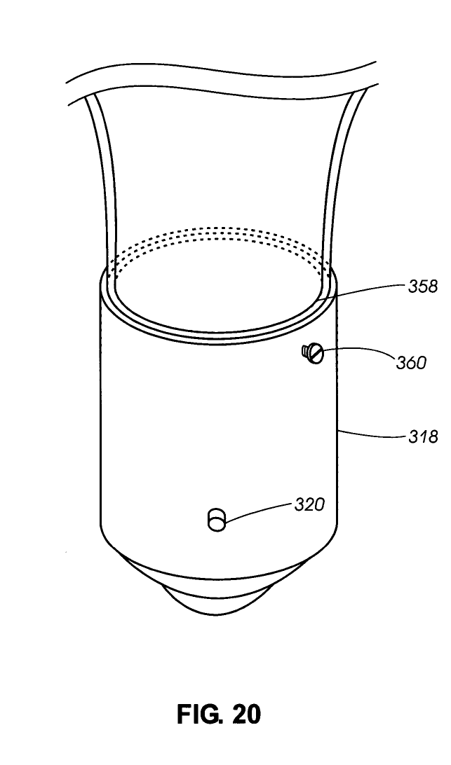

FIG. 20 depicts a mechanism for adjusting the direction that the patterned illumination source is being directed. It will be appreciated that in some instances the bulb mounting, such as bayonet 320, may not properly direct the illumination in the optimum path forward of the wings. Therefore, it may be desirable to provide an adjustment to the direction in at least one axis. This figure depicts an inner housing 358 that is slidably engaged within an outer housing 318 and retained in a selected position by a fastener 360 such as a set screw. One of ordinary skill in the art will readily recognize that mechanical or optical means may be utilized for providing user adjustment in any desired axis of motion.

Intercepting power for Tip Tracker.

Intercepting the navigation light power (or other tip directed signal such as strobes) may be performed within the socket of the navigation light so that the tip tracking system may be installed without the need to remove the entire navigation light assembly to access the power cable attached therefrom.

By way of example, a thin circular shaped disk may be attached to the base of the light bulb which routes the power to a separate circuit and the laser element mounted nearby. The disk is preferably approximately equal to or less than 1 mm thick so that insertion pressure of the bulb within its spring-base socket is not unduly increased.

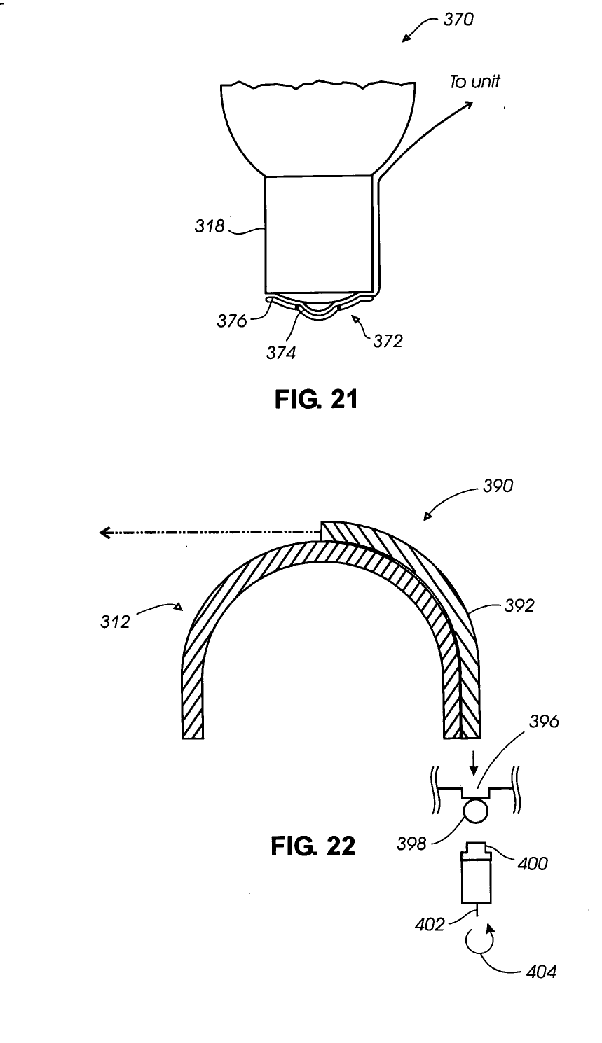

FIG. 21 depicts a power takeoff 370 comprising a circular shaped disk 372 with tip contact and base contact 374. Power takeoff 370 is preferably attached, such as by soldering, to the base of the lamp for accessing the power and ground signals therein, so that the navigation light assembly need not be removed from the aircraft for connecting to power and ground.

By way of further example, a bulb may be fabricated which routes signals to a remote laser unit. The electronics may be located within the base of the lamp or in the external controls.

Directing the Patterned Illumination Utilizing Optical Pipes.

The laser light may be redirected along the desired horizontal forward path using a light pipe with a terminal lens.

FIG. 22 depicts a light pipe embodiment 390 shown in cross section. A lens 312 is adapted with an attached light pipe (may be fabricated with it or it may be attached thereupon). The light pipe terminates in a coupling 394 adapted for connecting with a mating element 396 of the light source. A bead lens 398 is shown in this embodiment for coupling the optical energy from the laser source 400 to optic pipe 392. The end of the laser tube is shown with an extension 402 to which rotation is applied 404, such as by a motor or similar electromechanical device to nutate the beam of the laser while it is still directed toward the front of the wing. It will be appreciated that the laser module may be inserted within the wing parallel to the wingspan which simplifies mounting.

Directing the Patterned Illumination Utilizing Moving Mirror Assemblies.

The use of a mirror assembly can simplify the positioning of the laser so that it may be located more conveniently. Furthermore, the use of a mirror at the extreme tip of the wing allows more precise forward and lateral clearance to be determined.

The mirror may be configured in a number of ways, such as (a) simple reflective mirror; (b) motor driven rotating mirror with curving surface to nutate reflections; (c) MEMs mirror array which is electrically driven with all elements in parallel (same angular offset) which subscribes a circle for nutation, or other patterns to generate different patterns of light.

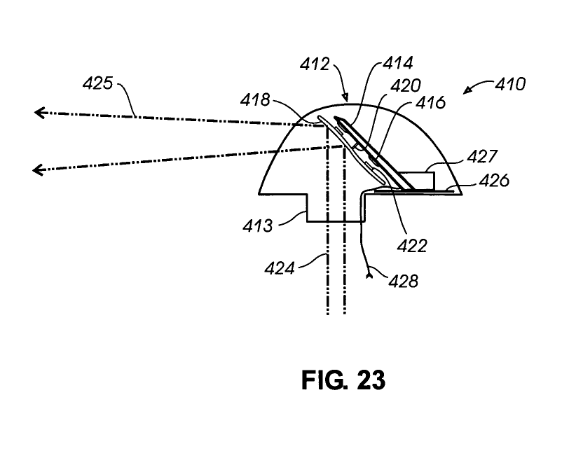

FIG. 23 depicts a motorized tip mirror assembly 410 (a stationary mirror has already been depicted). A housing 412 is configured for attachment to the navigation light lens, (or other tip mounted structure such as strobes). The mirror assembly may be integrated with the lens or configured for attachment to an existing lens. The housing is shown configured with a cylindrical alignment portion 413 that is configured for inserting within a hole drilled in the lens at a location to align with the exit path of the laser beam through the lens. It will be appreciated that the housing may be mounted, such as adhesively, to the exterior of the lens, however, the laser light is then subject to attenuation as it passes through the colored lens for reflection from the mirror assembly.

A mounting plate 414 which may be implemented as a circuit board is shown with coils 416 mounted thereon. A mirror 418 is attached at pivot 420 to mounting plate 414. Magnets 422 are attached at the rear of mirror 418 for inducing movement within mirror 418 about pivot 420 in response to the sequential energizing of coils 416 following substantially conventional principles of electric motors.

The surface of mirror 418 is adapted with curving surfaces that are adapted to reflect the impinging light 424 in a nutating pattern that follows a conical section 425 extending from the mirror. The shape of the mirror may be easily determined using optical CAD software using parameters for the desired amount of beam spread.

Power for this “motorized mirror” may be provided from an optical power cell 426 which converts light incident upon itself to operate a control circuit 427 which provides the intermittent power to the coils of the motor. It will be appreciated that external power 428 may be routed to the motor unit through wiring, which may be exceedingly small, even using transparent traces within a flexible circuit so that they are nearly invisible within the interior of the lens to which the mirror assembly 410 is attached.

If the mirror can be made to pivot sufficiently friction-free, then the radiation heating may be used to drive mirror rotation. These effects are commonly seen in sealed units for demonstrating “solar winds”, and for heat engines.

Integration within Aircraft Lighting Systems.

It should be readily apparent that it is generally easier to integrate the tip tracking system within new aircraft lighting systems as the number of design constraints is reduced. The above described methods of mounting the tip tracking circuits and illumination source are all applicable to that for new installations. In addition, the illumination source and circuit may be built into the lighting module for generating illumination which is emitted at any desired location within the lighting unit. These integrated lighting systems may incorporate the patterned illumination sources at different locations within the housing and be constructed with a number of variations without departing from the teachings herein.

Controlling Activation of Tip Tracking System.

The tip tracking system is typically only needed during brief periods of time when a pilot is taxiing near obstacles, such as planes, fences, vehicles, and so forth which incurs upon the taxiway. It is preferable therefore that the lights within the tip tracking system only be activated when needed and that they be turned off soon thereafter. It should be appreciated though, that the operation of the units during all or a portion of flight operation phases may provide beneficial long range directed lighting, wherein aircraft along the flight path of the aircraft can more readily see the patterned illumination from the laser source than from a conventional light source—which increases distance recognition. There is little chance for the laser to pose an optical nuisance problem as the light is diffused over the large separation distances. In flight lighting is particularly beneficial if color appropriate red and green laser lighting is projected forward of the aircraft.

If it is desirable, (i.e. FAA requirement or preference), then the operator should be able to control the activity of the patterned light source, which would preferably shut down after a predetermined amount of time or in response to a given set of conditions, such as airspeed beyond a given limit. However, the existing power systems on many aircraft do not make provisions for such a lighting system. For example, older systems may provide a single power control for both strobes and NAV lights. The following describes a number of activation methods and circuits for the tip tracker system. The following activation methods apply to any form of navigation/strobe light setup, however, a number of these are particularly well suited for use on systems that provide a single switch for navigation and strobe lights.

13.1 Activating Tip Tracking for a New Aircraft Installation.

For new installations in which additional wiring and switches may be easily provided, the tip tracking system is preferably installed with a controller within the cockpit having a user interface, such as activation control and optionally a beam pattern and/or spread control. The pilot can thereby command the control circuit as to how the tip tracking is to be operated. Furthermore, the tip tracking system may receive one or more of various status signals available in the aircraft. For example, a signal from the gear up switch may be communicated to the tip tracking system to automatically deactivate the tip tracker lasers. Furthermore, the tip tracker control circuit may receive signals from other cockpit controls, gauges, and sensors for controlling the activation and deactivation of the unit as well as the configuration of the tip tracking system.

The following describes techniques for controlling tip tracker operation which may be utilized in either new or retrofit installations. It should be appreciated, however, that for new installations the inclusion of additional wiring and controls is less difficult and may be preferred.

13.2 Activation at Time of Need.

Power to the tip tracking system may be coupled directly to navigation and/or strobe lighting wherein it activates when these lights are turned on. Preferably, the tip tracking circuit is adapted with a timing means to turn off tip tracking system lighting after a predetermined amount of time, such that the taxiway lighting of the tip tracking system does not remain active.

It will be appreciated that having active strobes during taxiing, especially at night is a source of annoyance for pilots taxiing other aircraft as well as ground personnel. It may be preferable, therefore, that the strobe lights not be activated during taxi operations. If a single control is provided for the navigation and strobe lights, then it may just be left in the off position (other than perhaps the landing light) until the pilot (user) encounters a prospective obstacle. Upon activation, the tip tracking system preferably operates for a short period of time (i.e. 3 minutes), which should provide sufficient time for the obstacle to be cleared.

13.3 Controlling Activation and Operating Interval.

It is generally preferred that the time of activation and operating interval be controllable within the present tip tracking system. Providing this level of control requires understanding the various forms of aircraft lighting installations.

Wingtip navigation and strobe lights on aircraft are installed using a wide variety of models of lighting sets, although few manufacturers produce the units. The control over the lighting varies, while variations exist in the manner in which the lighting is installed on the wingtips.

As an example of navigation/strobe light control, it should be noted that older aircraft may have a single switch for activating both navigation and strobe lighting, while some older aircraft did not provide strobe lighting. Modern aircraft typically have a split system for separately activating the navigation lighting and the strobe lighting.

As another installation example, some aircraft incorporate the strobe lighting on the front corner of each wingtip beneath a transparent cut out. Various locations for navigation lighting also exist. The conventional tip mounted lighting units may contain just a navigation light, or a navigation and strobe light. In some instances the lower base portion of the lighting unit is recessed into the tip of the wing.

13.3.1 Controller Selected Operating Duration.

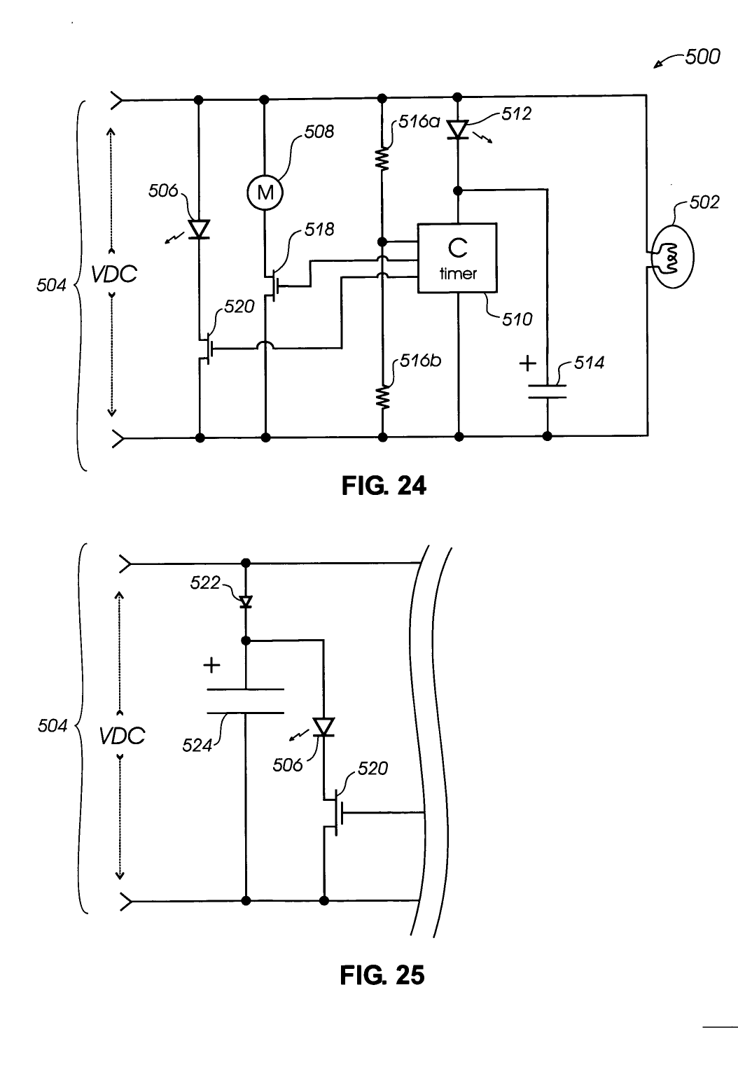

FIG. 24 exemplifies a circuit 500 for activating a laser light and a motor for controlling the direction of the laser light, as in a nutating pattern, in response to the power applied to the navigation light. A navigation light element 502 is connected to a power line 504 to the tip, alternatively the ground may be formed by a chassis ground. A laser light element 506 for providing the horizontal forward illumination and an optional motor 508 for driving the pattern of laser 506, are shown for use with the tip tracking system control element 510. Power is provided to controller 510 through a diode 512 wherein operating power may be stored on capacitor 514, allowing controller 510 to continue to operate despite short power interruptions. The controller can sense the state of power 504 through a sense circuit herein depicted with a voltage divider 516a, 516b detected by controller 510. Outputs from the controller drive switching elements 518 and 520 for controlling the activation of the laser 506 and motor 508 respectively.

13.3.2 Pilot Control of operating Duration.

It may be desirable to allow the pilot to control the duration of tip tracking system operation. This mode of operation may be implemented by operating the tip tracking illumination with stored power, which does not thereafter require a power source until the charge energy is depleted. A very high value capacitor (referred to generally as supercaps or dual layer capacitors) charge up for driving the laser illumination source.

The supercap may be charged in response to a momentary power on the navigation and/or strobe circuit.

By way of example, by modulating power through the switch: flick power ON, (wait 2-3 S) OFF, ON, (wait 2-3 S) OFF. The capacitor charges during the ON cycles thereby providing sufficient energy to operate for a few minutes. The amount of time available for operation thereby depends on the amount of time the unit is charged in response to the ON states of the switch. It should be appreciated that no timer is required within this embodiment, just a rectifier into a capacitor whose power is available only when the power is off subsequent to a signal being received, such as provided by the described power cycling. It is preferred that the stored voltage be supplied to a voltage conversion power supply (step down and/or step down&up) (not shown) to provide efficient operation.

FIG. 25 depicts a charge storage solution, shown without the voltage conversion power supply (or V regulator), as an alternative front end to the circuit of FIG. 24. Charged through a diode 522 a super capacitor 524 can be utilized, or other electrical power storage means, for storing laser operating power. The controller then can activate the laser through switch 520 in response to the correct activation sequence, wherein the laser will continue operating until charge is depleted from the supercapacitor.

13.3.3 Powering Nav and Tip Tracker while Blocking Strobe Power.

On installations having a single power control for navigation lights and strobes, the strobe power may be blocked in response to the signals on the power wiring, such as switching transients following a predetermined pattern or superposing other signals.

The tip tracking unit may be powered from a combination navigation light/strobe circuit by incorporating a strobe light power control circuit.

By way of example the controller may be configured to response to power line transients for controlling the lighting. For instance, the laser comes on when nav/strobe power switch to set to ON. The tip tracking unit operates for a given (or user selectable) duration. Once deactivated can turn OFF and ON again for more time. Power to the strobe, however, is blocked unless power is cycled through an OFF-ON-OFF-ON pattern or other predetermined transient pattern within a short period of time. It should be appreciated that a number of mechanisms exist for communicating an activation signal to the tip tracking unit and a deactivation signal to the strobe light.

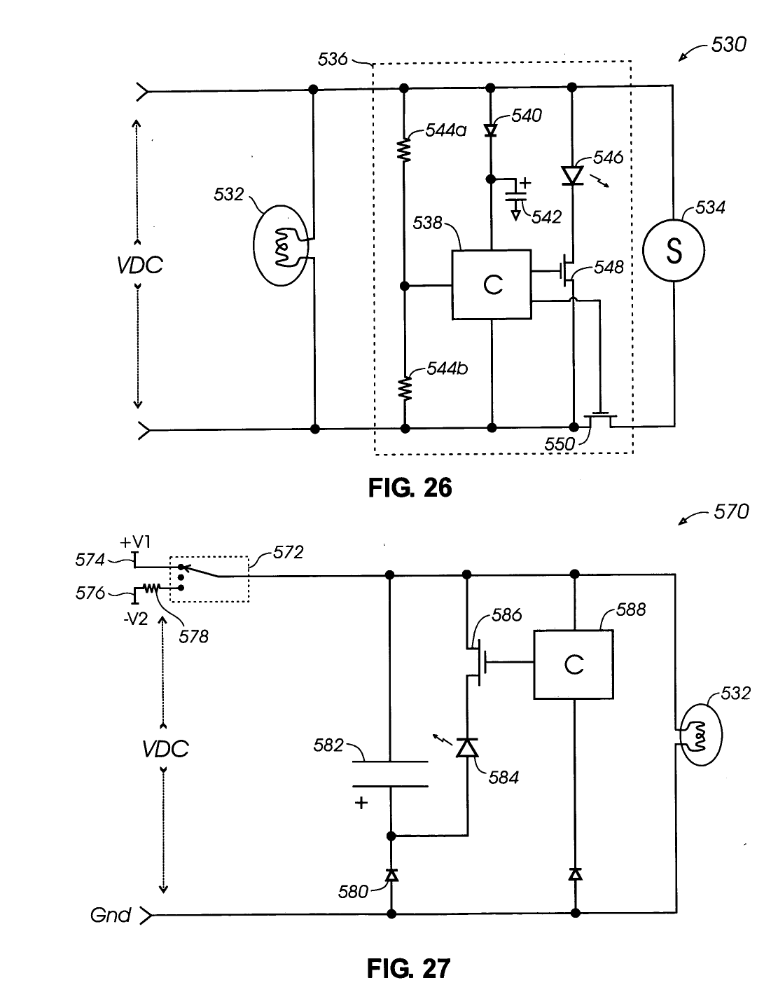

FIG. 26 exemplifies a circuit 530 for controlling the activation of a strobe light and a laser tip tracking light. To prevent a strobe light from being activated in conjunction with a navigation light and in this instance a tip tracking light, the circuit operates to prevent strobe activation under given conditions. In this way the tip tracking light may be activated in association with the navigation light.

A navigation light 532 and a strobe light 534 are shown connecting to a power output across which a voltage is supplied. It should be appreciated that a strobe light typically comprises a strobe light element and a controller which generates high voltage pulses from a low voltage (14V or 28V) source, the combination being generally represented by the strobe unit 534.

A controller module 536 is shown connecting to the power source between the power source and strobe light 534. A control circuit 538 regulates the activation of strobe light 534 and the tip tracking functions. Power is supplied to control circuit 538 through a diode 540 charging capacitor 542, wherein power may be maintained for the controller despite power fluctuations or switching transitions of a switch through which the power is supplied. Control circuit 538 can sense the voltage being supplied through a voltage divider comprising resistor 544a, 544b, a center of which is connected to an input to the controller which is adapted to determine whether power is active or inactive. It will be appreciated that numerous mechanisms may be provided for determining the presence or absence of power across the source.

A solid state laser device 546 is exemplified in series with a switching element 548 whose activity is controlled by control circuit 538. The control circuit 538 can modulate the operation of laser 546 in response to the state or activity as sensed on the power supply. For example, the laser may be activated when the power is applied, in response to an ON-OFF-ON pattern, in response to reverse voltages, or controlled in response to other transitions or conditions that may be sensed on the power line.

Control circuit 538 also regulates the activation of strobe 534 through switch 550, wherein the strobe can be activated separately from the activation of the navigation lights and the tip tracking system. For example, strobe 534 may be activated in response to an OFF-ON sequence when the navigation lights have already been activated, or to an OFF-ON-OFF-ON pattern, or to any other desired signaling as sensed by the control circuit 538.

It should be appreciated that control circuit 538 may be provided separately from the present tip tracking system, as a separately claimed aspect of the invention, to allow aircraft navigation lights to be controlled separately from aircraft strobe systems. It will be noted, that a module containing control circuit 538 may be wired into the existing lighting system without needing to change the power control switch, wiring to the light units, or the light units themselves.

Ambient light detection is depicted as an ambient light sensor 552 connected to controller 538. This is an optional feature allowing the tip tracking system to modulate the intensity of laser light output, preferably according to pulse width modulation so that the laser light intensity being output will properly match the conditions. It will be appreciated that as it is more difficult to see a beam of illumination during daylight that the intensity of the laser source may be output at full power, whereas at night the intensity may be held at a much lower power output. It will be appreciated that the ambient light detector should be positioned so that it is not effected by the light generated by the aircraft. If shielded or separated mounting is not easily achieved, then other lighting should be temporarily disabled by the controller when ambient light measurements or detection threshold are checked.

It will be appreciated that a number of optical sensors may be utilized for detecting ambient lighting conditions, which may provide digital output, or analog output. One preferred method is to utilize a photocell to charge the gate capacitance of an input to controller 538, wherein the I/O line is set to output a ground to discharge the capacitance, and then the I/O line is put into a input mode and the time required for the input to reach the threshold voltage determines the ambient lighting.

It should also be appreciated that the laser diode element, or other optically sensitive circuit elements within the controller, may perform double duty wherein their characteristics are checked when off in response to ambient light intensity.

13.3.4 Powering/Activating Tip Tracker from Reverse Voltages.

Navigation lights, being generally incandescent, can generally be operated without regard to polarity. This ability may be utilized for signaling, or providing power for operating the tip tracking system.

By way of example, consider the following embodiment in which the navigation power switch is configured with a reverse voltage position. The single polarity navigation lighting power switch is swapped out with a two polarity ON-OFF-ON (reversed) switch. A normal ON position directs current at a first voltage to a given circuit, such as NAV, but that is not utilized by the tip tracking system for activation. A second ON position directs a low voltage of a polarity that is reversed from the first voltage. The tip tracker system then preferably operates from the second voltage and/or it may be triggered into an activation state by the second voltage, wherein it may operate from the first voltage when the switch is returned to that position. If other equipment could be harmed by the reverse voltage, or impose too much load, then a blocking diode may be placed in line with them to prevent reverse currents from flowing.

FIG. 27 exemplifies a circuit 570 in which power is supplied by reversing the voltage supplied to the lighting system. A three position switch 572 (ON1-OFF-ON2) may be utilized to replace existing two position switches (ON-OFF). A conventional voltage V1 is supplied to the navigation light 532 upon conventional switch activation. A second ON position brings a second, reverse polarity, voltage 576 for supplying power to the tip lighting, optionally with a current limiting device 578 exemplified as a resistor. Preferably the reversed voltage is generated at a lower voltage level so navigation lighting and strobe lighting will be activated. If the reverse voltage poses a danger to the particular strobe lighting circuit in use, then a diode or other blocking circuit may be utilized to prevent reverse current flow.

It will be appreciated that a reverse voltage may be easily generated from a switching power supply circuit, such as utilizing switched capacitors. The reverse voltage being preferably in the 3 to 6 volt range with limited current capability. Through a diode 580 a capacitor 582 is charged, such as a super capacitor, having sufficient capacitance for powering the laser 584 for a sufficient period of time. A switch 586 is regulated by control circuit 588, which can activate laser 584 for a period of time after the reverse voltage becomes available.

It should be noted that the use of reverse voltage may be limited to signal activation, wherein the control circuit power would be provided as depicted earlier in a non-reversed configuration. Alternatively, the power from the reverse voltage may be utilized to charge an energy storage device, such as a supercapacitor, for power the tip tracking system when the reverse voltage is no longer present. The reverse voltage may also be used for storing a control voltage on a capacitor. The charge stored on the capacitor can then be used to determine the duration of tip tracking system operation.

13.3.5 Superimposing Signals on the Navigation power wiring.

An embodiment may be implemented in which a momentary contact, such as within a modified switch element or an auxiliary switch is utilized for communicating activation and optionally spread angle and/or duration, to the tip tracking system. Upon activating the momentary switch, such as by pressing it the switch generates a signal down the navigation light/strobe power line for activating the tip tracker system.

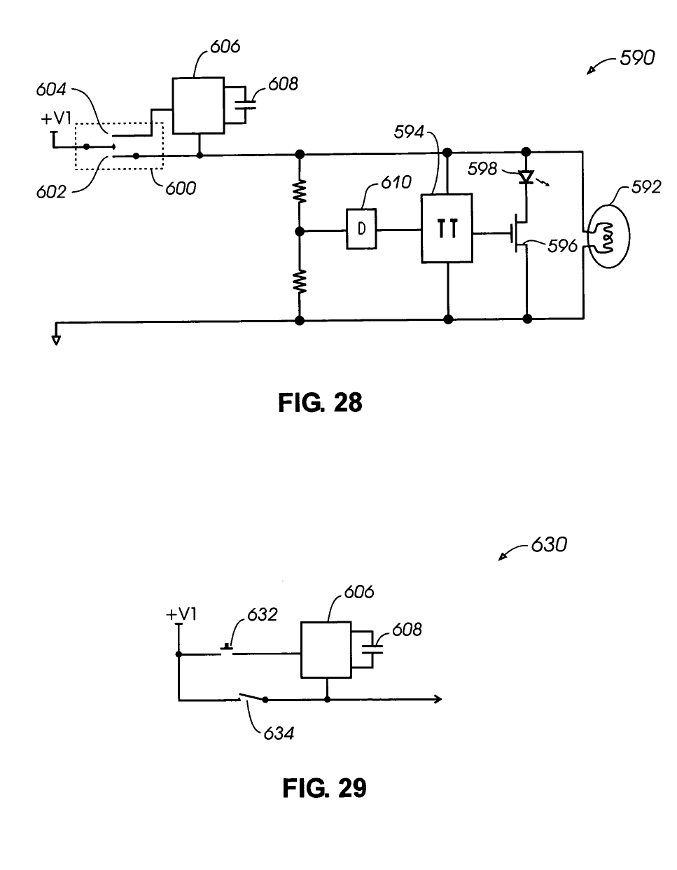

FIG. 28 exemplifies replacing a conventional switch with a switch having an additional momentary contact that is engaged upon applying sufficient pressure to the switch while in the ON position. This additional momentary position, allows the pilot to communicate signals over the existing wiring to the navigation and strobe lighting.

A circuit 590 is shown with a navigation light 592, and a tip tracking system controller 594 which controls a switch 596 for modulating the power through laser diode 598. A switch 600 is configured with a first contact 602 that may assume an ON position for directing power +V1 down the wiring to navigation light 592. A second contact 604 is provided within switch 600 as a momentary switch, wherein power is routed to a power conversion module 606 which provides a charge storage device 608 and is connected to the wiring for transmitting a signal which is superimposed on the voltage +V1 for signaling the tip tracking system 594, which may detect the signal states using a detection circuit 610. For example, circuit 606 may generate a voltage that exceeds +V1 by using capacitor 608 in a switched capacitor mode, wherein the voltage on the wiring, upon application of charged capacitor 608 jumps to a higher voltage prior to the charge being depleted. The detector 610 then communicates that condition to the tip tracking system controller 594 so that the state of the laser light 598 may be properly modulated.

It will be recognized that the voltage may be provided as an identifier comprising a sequence of bits, wherein the tip tracking system control circuit is capable of distinguishing the transitions from those associated with spurious noise.

It should also be appreciated that this method and circuit may be utilized for controlling the activation of a strobe light, or other lighting units within the aircraft that are connected to a single power source.

FIG. 29 exemplifies one simple alternative 630 to the switch of FIG. 28, wherein a separate momentary push button switch 632 is connected, for use with a conventional ON-OFF switch 634, to a power conversion module 606 with capacitor 608. This allows the user to configure a separate switch for controlling Tip Tracker operation without the need of altering the wiring carried in the wing to the navigation and/or strobe lighting.

13.3.6 Operating Tip Tracking System from Self Contained Power.

It may be desirable to NOT have the unit connected to the aircraft power system, so that it can not effect the aircraft electrical system. Although properly designed electrical equipment is extremely reliable, this aspect of the invention may be desirable in some instances. The tip tracking system may be configured as an isolated system operating from its own power (i.e. battery such as lithium) and not connected into the aircraft power system battery. Activation of the lights may be via a remote control, or by sensing an ON/OFF/ON power transition within a specific time range. The power transitions can be sensed inductively, wherein the electrical system for the aircraft is left totally undisturbed.

The unit can additionally/alternatively sense the power to the strobes with another inductive loop that is conditioned and sensed by the controller. Upon activation of the strobe lights the laser system can be deactivated. Typically general aviation pilots taxi with only the navigation lights on, and then activate the strobes during a run up prior to taking the active runway for takeoff. Therefore, sensing of strobe activation can provide another simple means of deactivating the lasers and may be utilized separately or in combination with the other techniques described.

Alternatively, the unit can sense activation of the navigation lights and/or strobe lights by sensing the actual light output, such as using an optical detector. However, this form of sensing is generally more complicated and somewhat more prone to false detections.

Each wingtip lighting unit may be configured with a self contained power source, such as a 12V cylindrical lithium battery, as shown in FIG. 14 that may be preferably inserted into a receptacle from outside the unit without the need to remove the lighting system. The battery opening is preferably sealed, for example by using a cylindrical slotted aluminum plug having an O-ring to seal the battery compartment. The service life for the battery source under normal conditions is expected to at least exceed one year and should be operable for up to two years or three.

An inductive loop of wire wrapped around one or more of the wires carrying power to the navigation lights/strobe, or other form of power sensing, can generate a signal to activate battery power for a controller circuit, such as an eight bit, eight pin, PIC microcontroller from Microchip Incorporated. Once coming out of a reset condition the controller senses the power changes to the nav/strobe and determines if a predetermined set of conditions has occurred, such as the transitioning of the lighting from ON/OFF/ON within a period of up to about two seconds. If this occurs then the controller outputs an activation signal to activate the laser light and any optional electromechanical drive as may be used for instance for generating a circular pattern.

If an optional speed sensor switch element is provided then it would normally be set in the ON position and transition to OFF as the speed extends past taxi speed. This optional switch would be in series with the laser light and any electromechanical drive, wherein even though the controller was still generating an activation signal the speed sensor would block the current at beyond safe taxi speed.

It should be noted that the deactivation of the laser system can also provide an additional indicator to pilots that they are taxiing at an unsafe speed. Normally the pilot would complete the “close quarters” taxi operations within a couple of minutes and may then cycle the NAV (or strobes) through an OFF/ON cycle which is detected by the controller and used to deactivate laser power and controller unit power. The controller tracks the elapsed time from activation, and if they have not been otherwise deactivated the controller will at a predetermined time, such as 3 minutes, 5 minutes, or whatever the unit is implemented for (or for which a user selection value is read), discontinues the activation signal (turn off the laser and any electromechanical drivers) and turns its own power off such as biasing off a FET, as is commonly done on conventional small electronic apparatus.

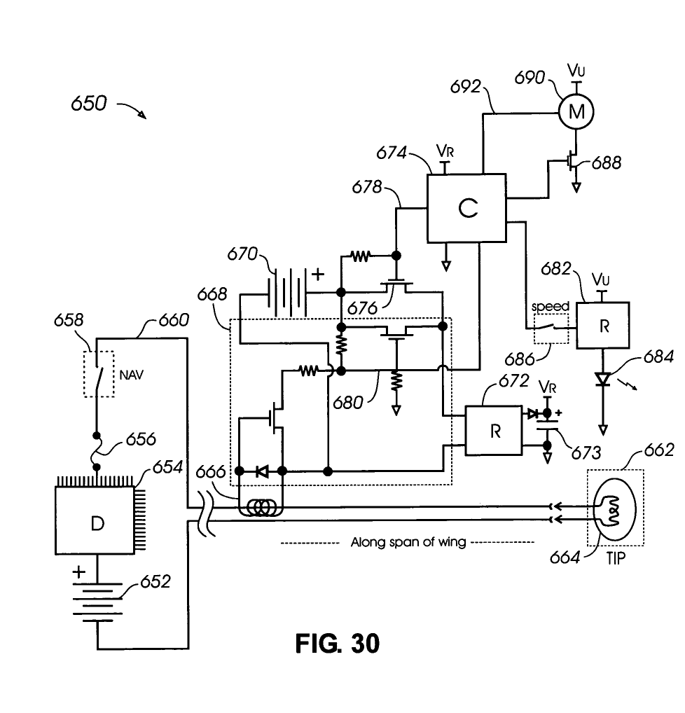

FIG. 30 exemplifies an embodiment 650 of the use of a remote power source within the tip tracking system. The aircraft systems are shown with a battery source 652 connected through a power distribution system 654, fuse 656, cockpit switch 658 for NAV lights. The power from the NAV switch 660 (or may be used less preferably with strobe switch) is routed out to the wingtip navigation lights (NAV, NAV/strobe, or other lighting) 662 which are simply represented by the use of an incandescent light filament 664.

An inductive loop 666 is shown adjacent to or encircling one of the conductors (wires) leading out to the NAV strobe. It will be appreciated that since a large current (in the vicinity of one ampere) flows through the wire a significant voltage is induced in inductive loop 666. Power transitions sensed by inductor 666 trigger an activation circuit 668 wherein power from a remote power source 670 is switched on to regulator 672 in response to the sensed current transitions above a given threshold. Power source 670 is depicted as a battery providing unregulated output Vu, to regulator 672.

A controller circuit 674, preferably an inexpensive microcontroller, controls the operation of a power sustain circuit 676. Controller 674 upon exiting its reset condition can pull down an output 678 to latch power from remote battery 670. Controller 674 then senses the state of inductor 666 through a conditioning circuit 680 to detect the subsequent OFF/ON transition, which it may utilize to determine how power should be controlled.

If the correct pattern of current fluctuations is detected from inductor 666 then controller 674 outputs power to power supply 682 for a laser diode 684. If an air pressure sensing switch is utilized, or other activation prevention circuit 686, then the controller 674 although it generates an activation signal will not cause laser source 684 to activate. Controller 674 may additionally output signals for controlling related elements, such as electromechanical devices or other lighting. Controller 674 is shown connected to a driver 686 for a small motor 688 (i.e. paging motor) for generating a nutating pattern of laser illumination. Optionally, the controller may output an additional control signal 690 for selecting different patterns for motion of the laser source, such as changing the conical angle of nutation.

Controller 674 retains power to the circuit via sustain circuit 676, so that power is supplied to the controller and all related circuits, while controller 674 times the activation interval. After the predetermined interval has elapsed, controller 674 deactivates the projected illumination source 684 and any electromechanical outputs 688 and powers itself down by deactivating the sustain circuit 676 from the battery source. The circuit will be awakened in response to subsequent large switching transients found on the power line.

It should be appreciated that a rechargeable power cell, or fuel cell, may be utilized in place of the battery power described. For example a photocell may be utilized to collect energy stored on a power storage devices such as a supercapacitor. The photocell, or other photo responsive material, may be included on the top surface of the unit for charging the energy storage cell. It should be appreciated, however, that such an installation would be less preferred as such power sources are not generally sufficiently reliable.

Modulating Output of Patterned Illumination.

The output from the patterned illumination source may be modulated, preferably by a controller, to provide a number of effects and for providing added communication. The following being provided by way of example. The controller preferably modulates the illumination in a PWM (pulse width modulation) manner wherein the power to the laser diode is modulated at a fixed or variable frequency and for which the duty cycle may be altered to control the intensity.

Modulate the intensity of the projected illumination in response to detected ambient lighting, as described earlier in reference to FIG. 26. The tip tracker system may contain an optical sensor, or alternatively sense optical energy based on characteristics of the laser diode when in an off-state in response to ambient lighting. In this way high intensity output may be utilized at night with lower intensities being selected for night operations. This feature can significantly enhance the usability of the tip tracking system.

Increase apparent brightness and/or efficiency. Increased ability to discern the light output can result from modulating the intensity of the illumination. Furthermore, at non-maximum output power levels the illumination is more effective when controlled according to PWM control, and similar.

Communicate information to a remote location by modulating the laser light output. Some instances arise in which it may be desirable to communicate information from the aircraft to surrounding environment. By way of example, the laser light output may be modulated to communicate an aircraft identification. Optical detectors near the taxiways may be adapted to collect information on aircraft utilizing the taxiway, to better control the flow of traffic and to increase safety from ground operations, terrorism, and so forth. In addition, as the aircraft taxies to a fuel service island the identification of the aircraft can be automatically registered to enhance the process of charging and distributing the fuel.

If the preceding technique is being utilized as a security measure, it may be generalized to including an RF transmitter coupled to the power bus of the aircraft, or from the magneto power (if the aircraft could be started without power to the bus). The RF transmitter would be configured to generate an identifier for a short period of time (i.e. periodically during ground ops, or periodically over a short interval) so that stolen aircraft could be more readily identified.

Alternative Patterned Laser Outputs.

Incorporated by reference is application Ser. No. 10/867,615 filed Jun. 14, 2004; and associated provisional patent application 60/478,900 filed Jun. 14, 2003, which contain descriptions of alternative nutating drive mechanisms. These embodiments include motor driven nutating drive and a mechanism for converting a linear motion variation to a circular motion variation by an elongated shaped lens or reflector, which curves along the span over which the laser is directed toward creating a nutating pattern from a linear motion applied to said laser. By outputting along only a portion of the linear range of the reflector a patterned output can be produced, such as generating semicircles, arcs, or other patterns indicative of size in response to distance from target.

It should be appreciated that the present invention may utilize a number of forms of actuators for driving the laser output direction or alternatively the angle of deflecting the laser beam, such as from a mirror or through a lens or prism. These outputs can be driven by motors with a variety of coupling means for creating a laser output pattern, o using other forms of actuators including but not limited to voice coils, magnetic deflection, and piezo motor mechanisms as well as others for rotating or deflecting the beam in a desired pattern.

15.1 Geared Motor Driven Nutation.

FIG. 31 and FIG. 32 depict another embodiment 710 of driving the laser output direction. A first gear 712 is coupled to pivot 714 and has gear teeth 716 for being driven by teeth 718 of second gear 720 of motor 719. A slot 722 in gear 712 receives an end of positioning rod 726 having retainers 724 on either side. An optional biasing means is provided, depicted as spring 728 retained in slot 722 to allow changing the angle of laser nutation in response to speed of rotation. Pivot 714 of first gear 712 is shown coupled to a housing member 732 and containing bushings 730 to reduce friction.

An opposing end of positioning rod 726 is coupled to laser 736 which is flexibly retained in a retainer 738, such as an O-ring, wherein the laser output 740 of laser 736 is directed according to a nutating pattern whose divergence angle is created in response to the speed at which motor 719 is being driven. Motor 719 is preferably driven by a control circuit using pulse width modulation (not shown).

15.2 Linear to Nutating Output Converter.

FIG. 33 depicts a device 770 for generating a nutating output within the tip tracker device from a linear movement of the laser. An elongated reflector strip 772 having curving outputs 773 along its length deflects the beam from a laser 774 attached to pivot 775 and moved by a single axis actuator 776. The single axis laser sweep 777 impinges on the curving reflector strip 772 each portion of which controls both an elevation and a lateral direction of the laser, creating circular pattern 778. It will be appreciated that the circular pattern 782 appears as a laser line circumscribing from one point on the circle around a full circle and then back again in the opposing direction. Limiting the linear sweep alters the amount of the circle which is traversed.

15.3 Magnetic Actuation.

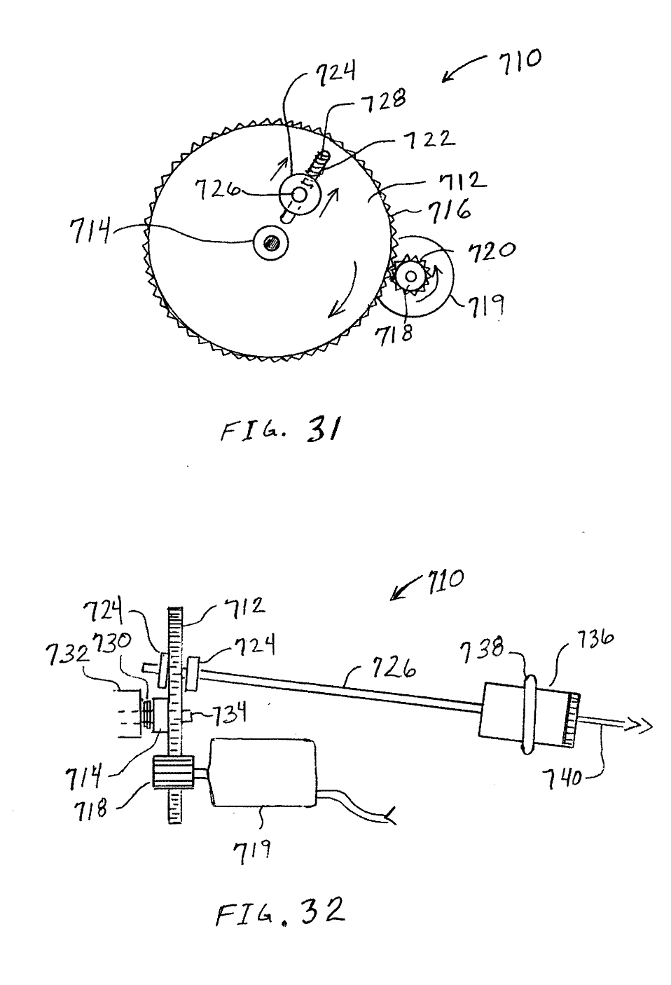

FIG. 34 illustrates an embodiment 780 utilizing a magnetic actuator having a number of discrete magnetic coils to which a magnet or ferromagnetic material (i.e. steel, iron, etc.) is pulled in response to actuation current. A laser 774, as in FIG. 33, is configured in this embodiment for generating a patterned output 777. Attached to the laser is gimbol 782 having a first and second axis. For example, the first axis can comprise pins extending from opposing sides of laser 774 (or from a ring slid over the laser housing) which engage ring 784 from which pins 785 extend to engage an exterior housing (not shown). The gimbol allows the laser to be easily deflected in forming the output pattern.

A stalk 786 extends from laser 774 and terminates in a magnetic material 787 (pole), such as a magnet (i.e. rare earth magnet), or a ferromagnetic material (i.e. steel, iron, etc.). A plurality of electromagnets (inductive coils) 788a-788f can be energized to pull the material 787 to the inductor. If the magnetic material comprises a strong magnet with a polarity oriented vertically in the figure, then the inductors can be established in a first polarity to draw pole 787 toward the magnetic field, or established in a second polarity to push pole 787 away from the inductor. By modulating the energizing of the inductors pole 787 is moved in a desired nutating pattern, such as circular. It will be appreciated that the number of inductors and pattern of the group of inductors can be varied to alter the desired shape of the pattern. In the figure, six inductors are utilized providing a push-pull arrangement in three “phases”, providing a hexagonal pattern when driven at low speed (DC). At higher speeds the inertia of pole 787 rounds outs the motion creating a truly circular pattern. It should be appreciated that four inductors could similarly be utilized for creating a square to round pattern depending on actuation speed. Other geometric arrangements may also be utilized, such as triangular, pentagon, septagon, octagon, and so forth without departing from the invention.

It should be appreciated that this same approach can be implemented in alternative ways, a few of which are described herein and from which one of ordinary skill in the art can modify or combine to create other implementations without departing from the teachings of the present invention. (1) magnet/ferro-material coupled to sides of laser with surrounding magnetic coils; (2) magnet/ferro-material coupled to the base of the laser with surrounding magnetic coils; (3) magnet/ferro-material plate extending from base of laser under the periphery of which is positioned the electromagnets (which allows a flatter form factor for the combined laser and actuator; while other approaches and combination may also be utilized.

FIG. 35 illustrates an example of a drive circuit for the diagram of FIG. 34 utilizing a microcontroller 790 having six digital outputs 791a-791f which drive the coils. Pairs of coils are arranged in opposing polarity positions (vertical polarity orientation to match pole 787), wherein a current in a first direction causes one electromagnet to produce a first polarity and the series connected electromagnet to produce the opposing second polarity. The controller can use PWM techniques to provide desired transitioning forces between power applied successive phases, assuring smooth operation and the desired pattern results. A laser power supply 792 is shown coupled to a laser diode 794. The power supply is preferably integral with the laser diode so that temperature is properly compensated. The controller also controls the activity of a switching means 796, such as a MOSFET transistor to controls the power being applied to the power supply and laser diode. It should be appreciated that this microcontroller can perform the other functions of the TipTracker, such as interfacing to determine the selection of operational states, the timing of operations, and other aspects of operation.

15.4 Muscle Wire Nutation Stage.

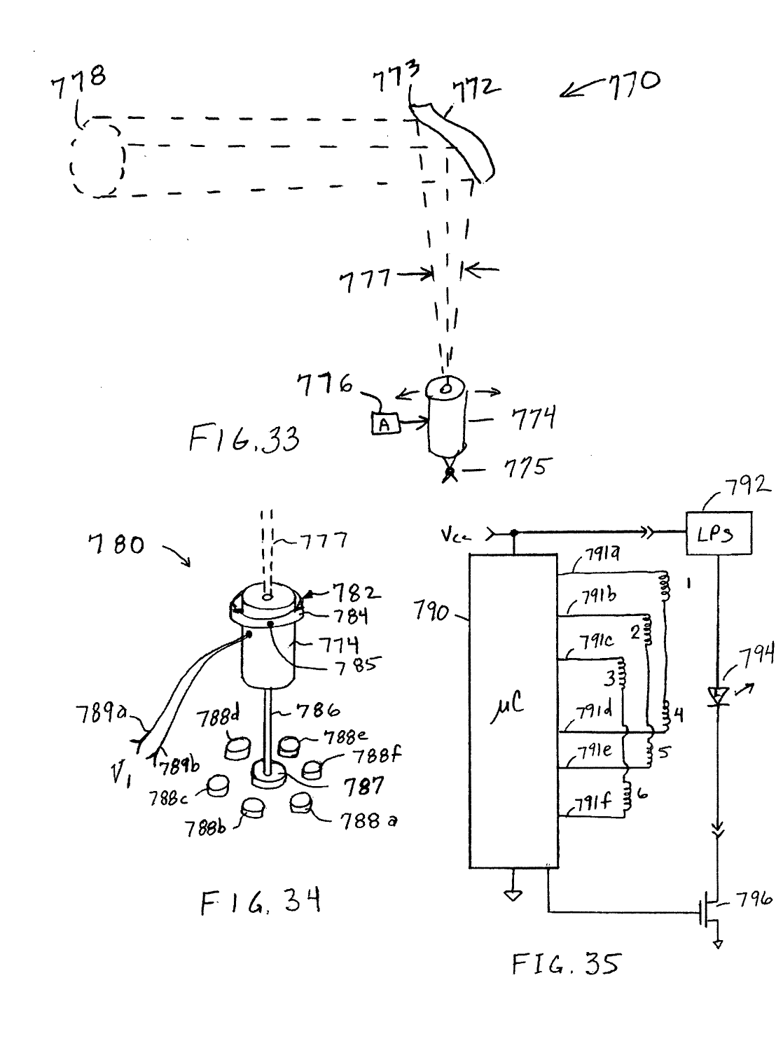

FIG. 36 illustrates an example of a muscle wire driven laser beam output 810 embodiment according to one aspect of the present invention. The application describes a laser element 812 for projecting a beam 814, in a controlled pattern, such as a nutating conical pattern. A compliant member, spring 816, applies pressure at the base of the laser 812. Preferably the spring is configured as a ground lead for the laser, and can also aid in dissipating heat. A power connection is depicted as insulated wire connection 818. An attachment plate 820 is retained on a first side of laser 812, to which are coupled a plurality of muscle wire fibers, in this example muscle wire (MW) 822, 824, 826. It will be appreciated that at least three muscle wires are generally required in this arrangement to provide two axis of motion of the beam. By alternatively applying sufficient current to the muscle wire, the attach plate 820 and laser 812 are angularly deflected along a path therein nutating the output beam. It will be appreciated that the inclusion of additional muscle wire elements can simplify creating a desired output pattern, such as a square or circle, however, the cost increases accordingly. Spring 816 tensions the muscle wires, wherein they stretch back to original position after activation current is terminated.

FIG. 37 depicts a simplified schematic of the laser head with the laser 812 and three muscle wires 822, 824, 826 being driven with respect to ground 816. It should be appreciated that the power supply for the laser is considered to be within the laser module, preferably along with temperature and/or other forms of power compensation so that laser power can be optimized while maintaining a long service life. Laser 812 with the power supplies is simply depicted as a diode 812 in the figure. It should be appreciated that the laser power supply and conditioning circuitry could be alternatively positioned proximal to the laser diode 812 although typically the compensation circuits need to be positioned adjacent the laser diode to sense the temperature therein. The above embodiment provides another inexpensive means of directing the beam output of the tip tracking beam.

15.5 LED Based Light Module.

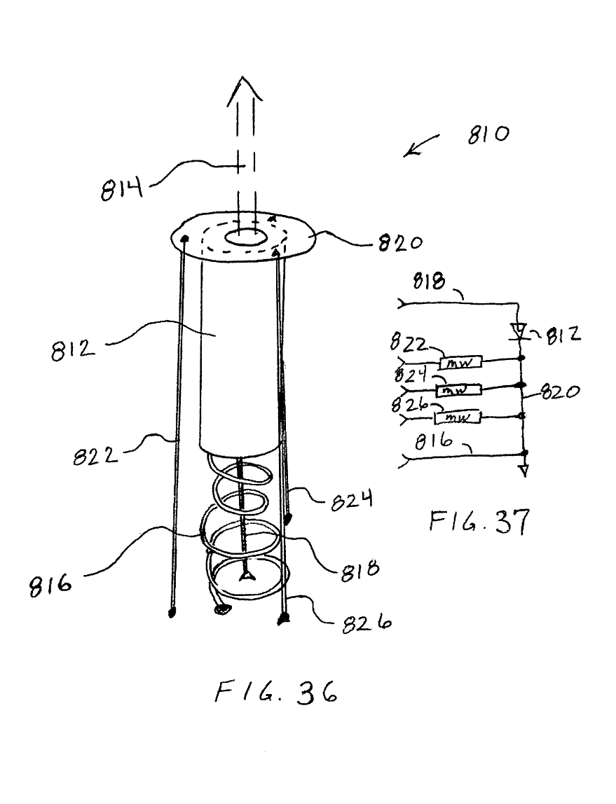

FIG. 38 illustrates an example of one preferred embodiment 850 of the invention in which incandescent lighting is replaced with other forms of illumination sources. In this embodiment, red and green LEDs are utilized to replace the incandescent lighting (multiple elements provides redundancy), wherein the red and green navigation lighting can be produced without the need of the traditional colored lenses. It will be appreciated that other forms of efficient colored lighting may be utilized to generate the navigation lighting. Red and green LEDs are being manufactured with steadily increasing light outputs, for example 32 cd red and green LEDs being currently available with higher output lighting becoming available. The present implementation using LEDs results in less heat buildup than arises with incandescent lighting, and the units can be fabricated in a number of alternative ways, such as molded into a single piece. It will also be appreciated that the use of a clear lens (cover) can reduce the attenuation of a laser source, such as a red laser (i.e. 635 nm) shining through a transparent green lens.

By way of example and not limitation this embodiment is shown utilizing a muscle wire actuation stage, as depicted in FIG. 36 and FIG. 37. The laser module 812 is shown generating collimated beam 814 and attached by spring 816 to a laser base 828. The spring 816 provides a first electrical contact and wire 818 provides a second electrical connection, additional electrical connection may be included if desired. On the top of laser 812 is an attach plate 820. Between attach plate 820 and laser base 818 are a plurality of muscle wires, preferably at least three, comprising muscle wire 822, 824 (muscle wire 826 is not visible in this view).

A mirror 830 is coupled to the housing for redirecting the modulated laser pattern from an axial direction to the desired horizontal direction. It is preferred that the mirror be adjustable, wherein the user can adjust the laser direction to suit the specific installation. The housing 832 is shown preferably including traces comprising a circuit board to which circuitry can be connected. For example a split housing provides access for attaching circuit elements to the traces on the housing. Alternatively, a separate circuit board can be incorporated for connection of the circuit elements, muscle wires and laser diode module. Navigation lighting is depicted as a plurality of LEDs 34 (i.e. red or green), which are preferably high intensity. Control circuitry 836 is depicted within the housing, such as comprising a laser power supply and compensation circuit along with pattern control for the laser and optionally the LEDs. The housing is attached to bulb base 838 which is configured for replacing conventional navigation lighting elements (bulbs) within aircraft. The bulb base provides for a first electrical power connection and is configured with insulator 840 within which is a second electrical power connection 842 that internally is connected 844 to circuits within the housing. Bulb base 838 is shown configured with bayonet retention tabs 846, which are the most conventional form of navigation lighting connection.

In this embodiment both the laser and the LEDs are subject to having their output patterns controlled by the microcontroller, or other control circuits being utilized. The control of output patterns from circuits within the lighting element are described in prior applications by the inventor. Specifically, the inclusion of control electronics within the lighting module is described in the inventor's patent application entitled “Reaction Advantage Anti-Collision System and Methods” Ser. No. 09/730,327 filed Dec. 5, 2000; and provisional patent application Ser. No. 60/153,084 filed Sep. 9, 1999. The related application describes the use of a Light Signal Controller (LSC) mounted near or integrated within the light element, which may comprise a lighting element with a traditional mounting. The LSC can modulate the lighting from signals embedded in the power line, (which could be otherwise received by the module). The LSC is shown in conjunction with use of a “light bulb” having numerous LEDs connected, wherein the output from the LEDs because of the LSC can generate patterns of output beyond ALL ON and ALL OFF as is the case with traditional bulbs. “The LSC interprets the signals and sets the lighting accordingly.” “The LSC circuitry can be provided as a separate module or fully integrated into a lamp or lamp cluster that may even connect to the vehicle with the same bayonet style mount as used with conventional incandescent lights.” The laser output according to the present invention replacing one of the LEDs wherein the output patterns are controlled by the LSC, which is alternately described herein as a “laser control and power circuit 326” as in FIG. 16-17, and is shown mounted within lamp base 318.

In the embodiment of FIG. 38, the navigation lighting is implemented as a plurality of colored red or green LEDs, depending on which side of the aircraft, instead of the use of incandescent elements whose light is passed through a colored red or green lens. The navigation lighting can further be configured to provide a patterned output, such as a flicker at a high rate (i.e. 2 Hz-20 Hz) which is almost imperceptibly, to increase visibility.

In other embodiments the controller can be utilized to modulate the activity of the lighting element in response to aircraft speed, timing, or user control. For example, in one preferred embodiment the navigation lighting flashes or twinkles to increase recognition. The twinkling arising when different LEDs are being turned on and off, and the flashing being generally considered when all (or a majority) of the LEDs are being turned on and off simultaneously. The modulation of the pattern can be performed in response to time, such as a time after being activated, or in response to other sensed conditions, such as the aircraft speed as indicated earlier. For example, it would be generally beneficial to flash or twinkle the navigation lighting while the aircraft is taxiing, as this increases recognition. Typically, it being a best practice not to operate the strobe lighting while taxiing, in particular at night, as the intensity of the lighting can impair the vision of other pilots on the taxiways as well as those which may be landing or taking off.

The use of LEDs allows for outputting green light on one side and red on the other while utilizing clear lenses, which provide less attenuation of the red laser through the lenses, in particular the traditional green lens.

Additionally, the modulation of the navigation lighting is controlled by the circuits within the TipTracker bulb, such as in response to activation signals received from switching the power switch through multiple transitions.

Furthermore, selectors can be incorporated on the laser navigation bulb, or selection provided in response to signals communicated to the navigation bulb to allow the user to select operating modes. For example the use of snap in jumpers, switches, plugs, rotatable contactors, applying conductive paint over contact pairs, any other convenient option selection means and combinations thereof. Additionally, the options can be selected at the factory with factory set conductive patterns and the like. These options can include output pattern selection, pattern size, speed of pattern, when to activate bulb, duration of laser activation, and other operational aspects. This allows a single bulb unit to be utilized while allowing the user to customize the operation to suit their desire operational intents.

The aircraft navigation lighting switch may also be adapted with a power converter allowing dropping/boosting the voltage being applied to the navigation lighting at the tip for optimizing operation. It should also be appreciated that the LEDs within the navigation bulb are preferably configured in a configuration to reduce power losses arising from use of resistors or other voltage dropping elements. For example, LEDs may be grouped wherein series joined LED are coupled in parallel to one another. Each series set being configured to optimize the available voltage, such as 14V, or 28V. It will be appreciated that numerous LED drive arrangements are available in the art which can be utilized within the present invention, wherein further descriptions are unnecessary.

The system can preferably synchronize the modulation of navigation lights with strobe—example having a timer module near switch(es) which sends pulses or timing pulses for triggering the activity of the navigation lights and strobes. For example, can turn off navigation lights as strobes flash, or can flash or twinkle navigation lighting between strobes.

Increasing Propeller Visibility During Ground Operations.

A number of embodiments are described which can provide for increasing the visibility of rotating aircraft propellers, in particular during ground operations. The increased visibility aids in preventing persons and animals from being struck by the moving propeller which can be virtually invisible when rotating at sufficient speed. It should be appreciated that aspects of these embodiments may also be utilized in a number of alternative applications.

16.1 Self-Illuminating Elements.

A number of applications arise in which it is advantages to generate lighting without the need of external power supplies, even operating at night. Lighting is described which couples a power generating transducer configured for oscillating in response to movement, with an integrated lighting means.

An embodiment of the invention can be implemented using one, or more preferably a plurality, of a piezo-electric transducer elements which generate a voltage output in response to flexure. These elements generating a voltage for driving an output, such as one or more organic LEDs (OLEDs).

To better understand this invention an example embodiment is considered as an applique, tape, planar device, or similar that is applied to elements subject to rapid movement in a fluid, such as on rotating fans, rotating aircraft propellers, and other rotating equipment, or equipment subject to flow, in particular turbulent flow. Protrusions of the piezo-electric transducer oscillate in the flow (liquid or gaseous), which are converted to light output from one or more OLEDS. Changing the size and mass of the protrusions allows for changing the oscillatory pattern and depends on the application to which the present invention is applied. Preferably the generator output charges a capacitance, wherein the OLED output is produced only when the charge reaches a certain threshold level. The capacitor may also be discharged, such as through a leakage resistance, wherein a minimum threshold is created below which the OLED output will never be output (i.e. current generated is all bled off by leakage resistance and charge never builds up).

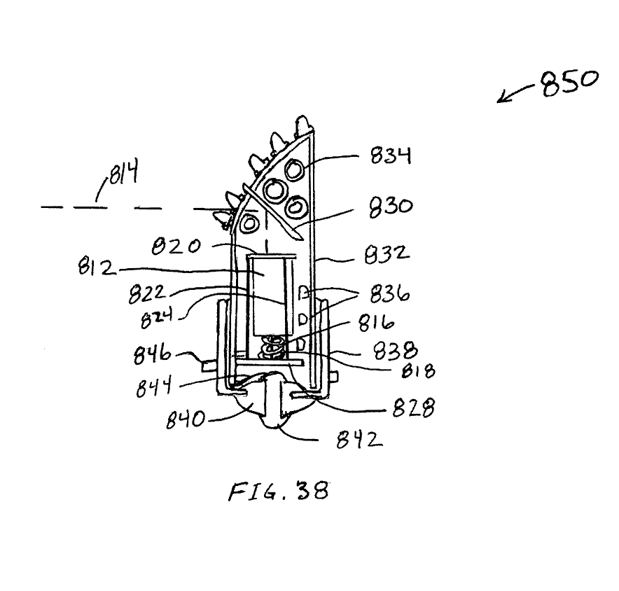

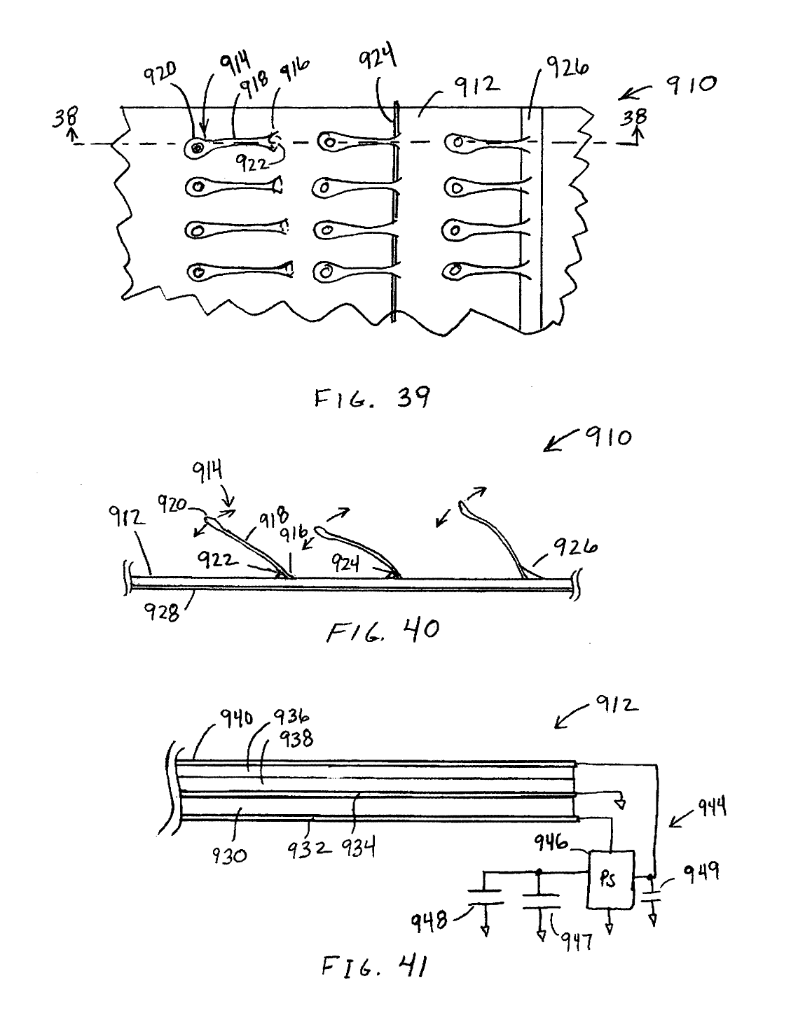

FIG. 39 through FIG. 41 illustrate by way of example an embodiment 910 of a planar material which generates its own light in response to movement of projective elements that protrude into the air stream. The material can be formed in predefined sizes and shapes, or into large sheets, strips and the like from which it can be cut to size for a given application. In this embodiment a multilayer material 912 is configured with a plurality of flexible protrusions 914 each preferably having a base 916 which transitions to an elongated section 918 that terminates in a tip 920. It will be appreciated that the protrusions may be cut through the entire section of material, or incorporate any number of desired layers from that material. Cutting through the entire material has the advantage of allowing the protrusions to be cut according to the application, wherein the shape, length, width and other aspects are controlled to suit the given application.

The protrusions are preferably mechanically biased to protrude into the airflow, although in certain applications, such as when negative pressure arises in response to venturi effects, they may be left near the surface. Biasing may be performing by applying a sufficient bend to base 918 past the elastic deformation stage, wherein the element generally retains a position extending away from base material 912. Alternatively, a biasing means may be incorporated. By way of example, biasing is depicted using a separate biasing member 922, such as placed under the base of the element. In one embodiment the protruding elements can be folded back by a mechanized slotted device, wherein a compliant material such as silicone is applied under the base 918 to retain the protrusion at a desired angle. Alternative biasing is also depicted with a biasing cord 924 which engages a series of protrusions. Another form of biasing is depicted as deposited layer 916, which is deposited over base 918 and shrinks to pull up the protrusion into the proper alignment. It will be appreciated that numerous other biasing mechanisms can be adopted by one of ordinary skill in the art without departing from the teachings of the present invention.

It should also be appreciated that the piezoelectric layer of material described within the self-illuminating embodiment has additional applications, such as for generating power. The output of power supply 946 can be stored in a battery or utilized for driving other sorts of loads than the integrated illumination load described above. For example sheets of the material can be produced and adhered to building surfaces, or supported to allow the entire material to flex thus increasing the energy being created. The protrusions act to prevent damage to the panel while increasing the level of power creation.

In FIG. 40 an optional adhesive backing 928 is depicted to allow the material to be attached to a desired surface, such as to the face of a propeller blade.

In FIG. 41 a layered structure 912 is embodied in which a light output layer, or plurality of distributed illumination elements, is integrated with piezoelectric elements for generating a voltage for powering the illumination means. In this embodiment a piezoelectric layer 930 (or other material configured for generating a voltage output in response to flexure) is bounded by contact layers 932, 934 which carry the voltage output from the piezoelectric transducer of layer 930. An illumination layer or layer, is depicted as semiconducting organic LED (OLED) layers, such as comprising a first organic layer 936 and a second organic layer 938. Power is carried to the OLED by electrodes 934, 940.

A power storage and illumination control circuit 944 is shown which receives power from one or more sections of piezoelectric transducer, and generates a drive voltage for the OLED. It will be appreciated that these sections of voltage generating material may be coupled in any desired configuration, such as in series, in parallel, or in combinations thereof, to provide the desired voltage levels. The control circuit can be adapted with a clock, sequencing logic, ROMs, microcontroller, or other circuits for generating periodic output in any desired pattern or in response to external conditions. Furthermore, controls circuit 944 can be configured with a power conversion stage for converting (i.e. typically stepping up the voltage) the received voltage to a voltage level that is suitable for use in driving the illumination means, such as the OLED in this embodiment. Power and illumination control circuit 944 is depicted as a single integrated circuit 946 which stores power on capacitors 947, 948.

The circuit can be attached to a conductive sets of pads coupled to the material establishing the necessary connections to the piezoelectric material and the illumination means. For example the conductive pads can be distributed across the material wherein the material can be cut to a desired shape and the circuit attached where convenient. To cover larger areas the material can be divided into segments, wherein each segment has its own control circuit and capacitor, or capacitors. Although a single capacitor may be utilized, a distributed capacitance or capacitor can be more readily configured in a flat configuration. An output capacitor 949 is also shown for bypassing noise. Furthermore, the power and control circuit 946 can be implemented within layers of the material, such as a polymeric circuit so that the material including the circuit remains flexible and can be attached so as to conform to areas where it is to be attached.

When a portion of the piezoelectric material 914 is flexed, such as in response to the turbulence of the airflow, it generates a voltage that is collected by circuit 944 and stored on capacitors 947, 948. Circuit 916 then drives the illumination material, or elements, such as OLED layers 936, 938, either constantly or more preferably periodically in response to timing, charge rate, or a combination thereof. Alternatively, the output can be conditioned by additional inputs, such as sensors or other elements coupled to circuit 944.

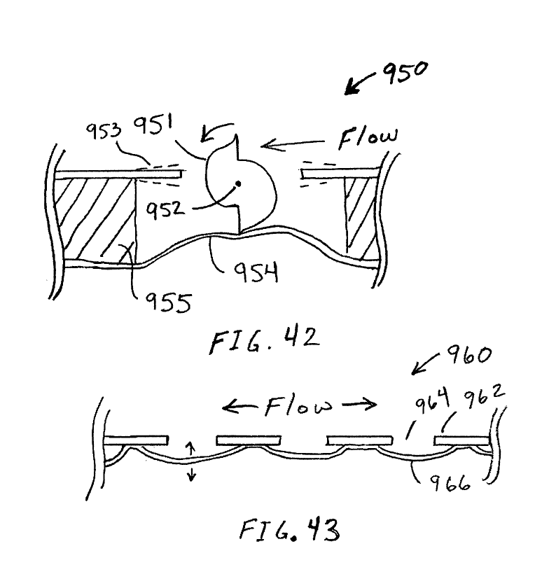

FIG. 42 and FIG. 43 illustrate alternative mechanisms for generating power such as for driving the integrated illumination elements. In FIG. 42 an embodiment 950 is shown with a miniature flow-catching device 951 (i.e. from 1 to 5 mm diameter) is suspended on pivot 952 from or in respect to an upper material layer 953. In response to a flow passing over the material device 951 rotates during which it strikes piezoelectric material 954 generating a voltage. Alternatively, or additionally, material 953 may comprise piezoelectric material, wherein a voltage can be generated in response to the motion of the edges of material 953 as device 951 strikes it during rotation. The embodiment shown is configured for operating in response to flow in a first direction, however the elements can be created, such as in a star pattern, to be responsive to flow in either direction. In addition the axis of rotation, instead of being parallel to the plane of material 953 may be configured as orthogonal to the surface wherein the flow-catching element can lie on the surface and strike protruding piezo elements to generate the desired energy.

FIG. 43 depicts a simpler embodiment 960 which relies on venturi effect in a turbulent flow to generate electricity. A base 962 is shown with apertures 964 to which a piezoelectric material layer 966 is loosely attached. In response to the turbulent flow changing vacuum pressure is applied to apertures 964 causing movement of piezoelectric material 966. In even a simpler implementation embodiment 960 is flipped upside down and the venturies are eliminated. The piezoelectric material 966 in this embodiment flexes in the turbulent flow to generate electricity, but the surface 966 covering structure 962 remains unbroken and its only slight give does not substantially disrupt airflow. The piezoelectric material layer may be augmented with a Kevlar mesh, rip-stop nylon material or similar in applications wherein strength is required.

The illumination material shown in FIG. 41 can be coupled to the piezoelectric material described above and configured for periodic attachment to a structure to provide self-illumination. Each section of the material can be configured with a separate power supply and control circuit as desired, preferably beneath the piezoelectric layer.

16.2 Lighting a Propeller with Self-Luminous Material.

FIG. 44 illustrates an example embodiment 970 of the flow responsive material 910 attached to an aircraft propeller 972 such as near tips 974. The material may be configured with an adhesive backing and made to a specific size or cut to size as desired. The material may also be provided to generate a desired color based on the organic semiconductor materials in use. By utilizing a mixture of organic material layers, or segmenting the material into areas of different semiconductor material, the colors can be modulated by the control circuit, such as utilizing a clock chip driving a binary counter with sequential logic for establishing a desired sequence, or a ROM-based form of sequencer.

Considering the self-luminous material on the tips of an aircraft propeller, the OLED tape generates a light output, which for example can shimmer, in response to the motion of the prop, therein significantly increasing the visibility of the propeller.

It should be appreciated that the motion of the sensors may be driven by turbulence which is always present in some applications, such as an aircraft propeller. The sensors, typically being biased into a first position into the flow and allowing to flex from the first position, the flexure of the piezo-electric material thus generating an output voltage. The piezo-electric elements preferably connected in a combined series-parallel arrangement to provide a sufficient voltage and current output. For example a collection of 100 sensors could be arranged in 10 parallel rows of 10 series-connected column sensors each. By altering the series and parallel configuration the appropriate voltage and current outputs can be produced for a given application.

Alternatively, the protrusions can be configured with a snap action, or other feed forward configuration in which astable activity is promoted, wherein turbulence is not relied-upon for moving the sensors. In addition a number of the sensors may be coupled, such as to operate out of synch with one another, therein also assuring relative motion and charging.

16.3 Indirect Blade Lighting Systems and Methods.

Charging Persistent Material. In a first embodiment a laser beam 975 is directed to one location along the arc of the tip. The incident laser beam energizing a material containing phosphors which provide persistence, therein allowing the blade to be seen along the remainder of the arc. The material containing the phosphors can be a translucent material inserted (i.e. disk) within the interior of the blade, a translucent tip section, regions extending from the leading or trailing edges of the blade, or within a sufficiently translucent portion of a composite blade, and so forth. The laser may generate light at any part of the spectrum (i.e. visible, ultraviolet, infrared) insofar as a compatible phosphor or similar material is utilized which receives the energy and slowly ejects photons therein maintaining a light output. This also has the advantage that the energizing beam may be turned off once airborne, such as automatically in response to speed detection, by pilot command, and so forth.

Backlight Strobed Blades. This embodiment is substantially easier to implement, wherein an illumination source 980 generating light 982 that is directed from the aircraft against the rear of the blades. The light being strobed at a sufficient rate so that the motion of the blades is slowed to where it becomes apparent to those around the area. The strobe can be executed at a fixed, or varying, rate or the system can incorporate a sensor for adjusting the strobe frequency in relation to the RPM of the blades.

It should be recognized that the blades are typically turning at low RPM while the aircraft sits stationary. Therefore, the strobe need only provides a means of appearing to slow down the rate of blade rotation. As has been mentioned, at these speeds the blades can be totally invisible, wherein a person, animal, or bird may walk or fly into, or otherwise come into contact with the path of the blade.

For example, activating the strobe a given ratio of the RPM and offset by an amount so that the blade appears to move at a rate and not be stationary. Consider a two-bladed propeller turning at 480 RPM. In this case a blade passes a given position along the path at a 16 Hz rate. If the strobe were output at the same 16 Hz then the blades would appear stationary, however by offsetting the strobe frequency to say 15 Hz, the blade would appears to turn at 1 Hz (60 RPM), which increases the visibility of the blades dramatically.

A simple embodiment of this system provides a high intensity LED, white or more preferably blue (i.e. could be considered indicative of engine operation), which is affixed to the aircraft and directed at the propeller. On a fixed wing conventional aircraft (tractor propulsion) the strobe lighting would be typically coupled on a forward portion of the engine cowl, such as near or integrated within the landing light housing 984 and facing forward into the propeller. On a canard style aircraft, or other pusher, the light element is preferably directed rearwardly into the propeller.

Reflected Strobe Lighting. In an alternative embodiment at least one strobe light element 976 can be mounted on or within the propeller spinner and can provide a number of advantages. The embodiment shows light 978 being generated from the use of two strobe light elements, providing increased brightness, redundancy, and balance. Advantages include the following. First, the light 978 emanating from the light source can be directed at the propeller from the side of the propeller typically approached, rather than showing the presence of the propeller lighted from behind as a silhouette. Second, the strobe can more readily sense the speed of propeller rotation, such as by sensing speed of motion (i.e. differential temperature probe), pressure sensing of venturi pressure, sensitive acceleration sensing (i.e. sensing gravity contributions relative to position), relative motion sensing of spinner in relation to engine cowling (i.e. mechanical switch, hall effect, light sensor, etc.), and so forth. Although this form of lighting is generally more complex to implement, because of the need to supply power to the electronics, or derive power from the rotation for driving the lighting elements.

Optionally a means of sensing propeller rotation speed can be coupled to the system to control the frequency of strobing. For example a sensor, such as an infrared sensor to detect the motion of the blades. Alternatively, the sensors can be coupled to an RPM gauge, engine vacuum source, or sensors for detecting actual motion of the propeller. In addition, the system can be activated in response to applying power to the engine, also providing an indicator to prevent leaving on the master switch. A switch can be provided to allow the user to turn off the indicator when it is no longer needed, such as in flight. An in-flight sensor can be alternatively utilized, such as described for use with the TipTracker for deactivating the device in flight. The intensity of the lighting can be optionally modulated in response to the detected ambient light intensity, such as by registering light levels on a photocell, or similar.

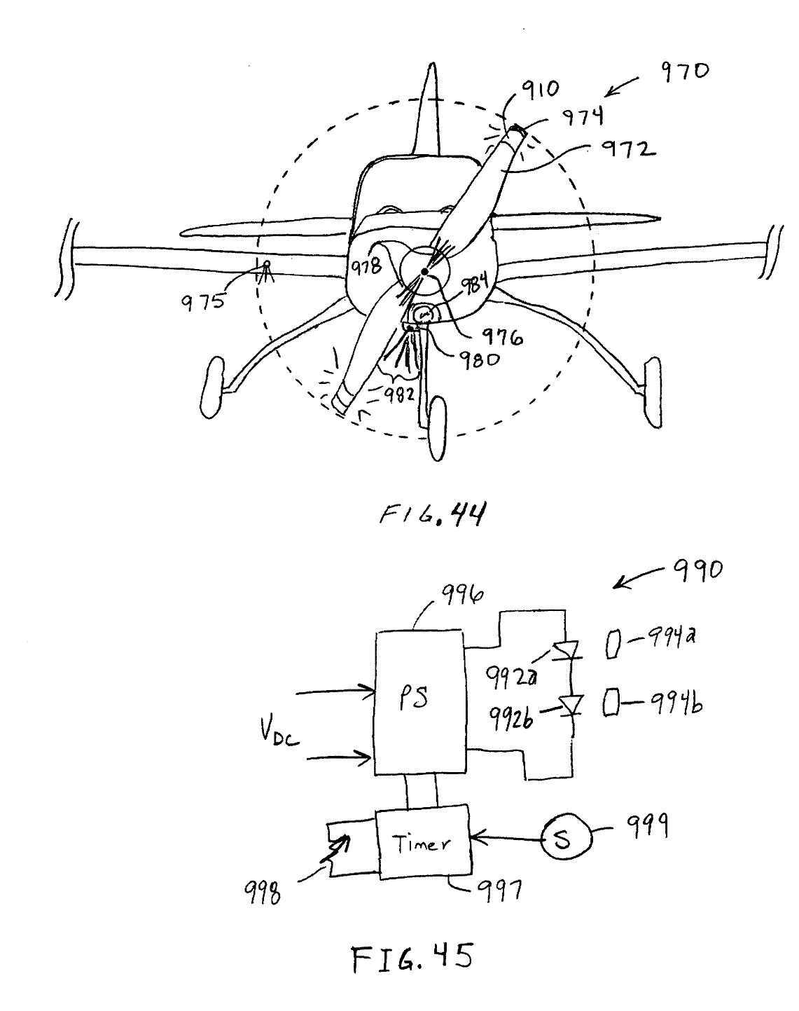

FIG. 45 depicts a schematic for an embodiment 990 in which two illumination sources, such as high intensity LEDs 992a, 992b, are directed through optional lenses 994a, 994b to the blades of the propeller. A power supply 996 controls the current through the LEDs preventing them from being overdriven and compensating for temperature and LED operational characteristics. Optionally, a timer circuit 997 is provided for driving the strobe output, which is preferably set, such as by adjustment means 998 (i.e. potentiometer) to establish a rate at which the propeller is made visible under typical conditions, such as during engine idling. Optionally, a sensor 999 can be utilized for adjusting the rate of the strobe output in response to the speed of the engine, or propeller. The sensor for example can be coupled to a wind velocity sensor, position sensor, G-sensor, or other means for detecting the angular velocity of the propeller. In one embodiment a dual element resistive sensor can be utilized in which a first resistor is in the airflow about the spinner, while a second typically identical resistor is shielded by a portion of the spinner. A current is passed through the resistors and the voltage of the resistors or their temperature (more accurate) is then registered. The speed of rotation can be detected in response to the difference of characteristics (temperature or resistance) between the shielded and non-shielded resistors as each are dissipating similar energy.

17. RFID tag with Elongated Power Generating Sensor.

This aspect of the invention shares a number of inventive aspects with the self-illuminating material described above and shown in FIG. 39-43.

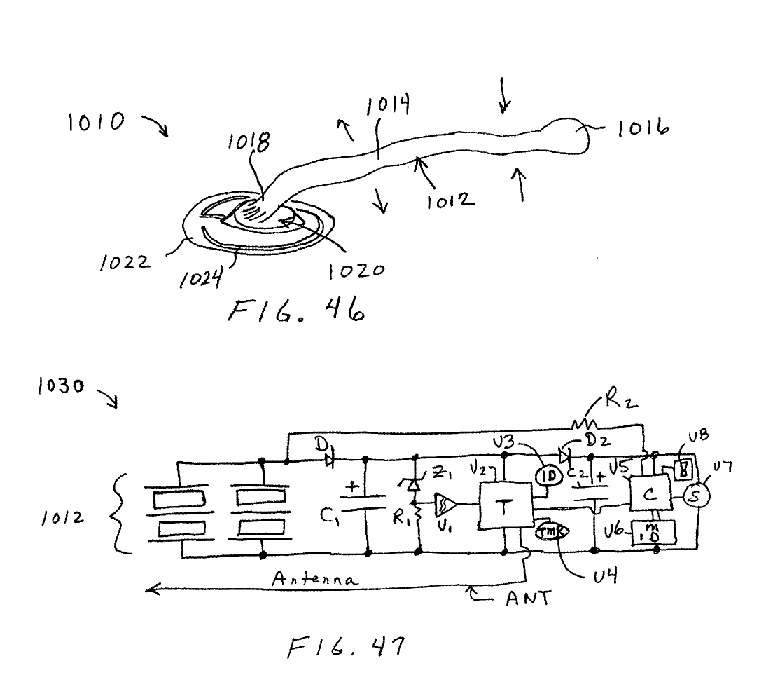

FIGS. 46 and 47 depict an embodiment of a remote RFID sensor that is configured for operation in turbulent fluids. The remote RFID tag utilizes communication aspects of an RFID tag while generating power from a flex-based power-generating element, preferably a strip of piezoelectric material which extends from the RFID into a turbulent fluid flow.

In FIG. 46 an embodiment 1010 is shown of a RFID sensor tag which is powered by the turbulence of fluid flow (liquid or gas) proximal to the sensor. It should be appreciated that most conditions of flow are subject to turbulence. Furthermore even traditionally non-turbulent flows can be adapted, such as with turbulators of one construction or another, so that higher orders of turbulence are created. However, in a preferred embodiment of the invention the RFID sensor is utilized for registering turbulent flow, in which case of course the airflow would not be adapted for the sake of generating increased power.

The flex-based power-generating element 1012 generates a current based on the activity of a surrounding fluid to power the sensor. The power generating element can comprise a strip of polymeric material into which piezoelectric elements are incorporated to generate operating power. It will be appreciated that other materials which generate current in response to flexure can be substituted without departing from the teachings of the present invention. The generating element 1012 comprises an elongated portion 1014 a tip 1016 and a base 1018 which is attached to a circuit enclosure 1020 which itself may be retained on a means for attachment 1022, such as an adhesive or magnetic. An optional antenna 1024 extends from enclosure 1020 to increase the range of the transmitted signal.

FIG. 47 depicts a simplified schematic 1030 of the turbulent flow powered RFID tag. The piezoelectric strip element 1012 may comprise one or a number of separate piezoelectric sections coupled in series and/or parallel to provide the desired voltage and current characteristics. The current output charges a storage element, such as capacitor C1 through rectifier D1. The device is configured to generate an output only when sufficient charge has been collected on capacitor C1, as sensed by voltage threshold detection means, such as comprising zener-resistive ladder (Z1, R1) feeding a Schmitt trigger (U1) whose output triggers a transmitter circuit U2 whose output is directed through antenna ANT.

In the simplest embodiment the device generates a signal at a rate that depends on the level of turbulence experienced. In one embodiment element 1012 can be cut down, such as with scissors to reduce the rate of output (normalize the sensor to some initial condition, etc.). A remote monitoring system can then register the transmitter output signals to collect information about the turbulent flow.

Slightly more sophisticated an ID for the device, such as circuit U3, can be output within each transmission, wherein the receiver can discriminate the location of the sensor to correlate the data.

Instead of being based simply on charge accumulation, the transmissions can be periodically generated, such as in response to a timer U4 which activates transmission periodically (presuming of course that sufficient charge has been accumulated to allow output). For example the charge accumulation threshold may need to be crossed to activate the device which allows the timer to trigger the output.

In more sophisticated versions the device can provide more in-depth information about the turbulence or other sense factors. In this example a controller U5 is powered from its own charge accumulation device, such as D2 and C2, wherein the depletion of C1 after transmission does not affect the charge level of controller U5 allowing it to continue operating to collect data. In this example controller U5 is configured for collecting data about the actual turbulence levels, such as by sensing the voltage on the piezoelectric element via resistor R2. Alternatively, independent sections of the piezoelectric element may be sensed to determine flexure at different locations and so forth. The data collected is stored in a memory U6 and which can be communicated by controller U5 to the transmitter for output based on sensed conditions, charge accumulation, time, or combinations thereof. In this way the device can provide any level of information desired, from a collection of readings, to patterns, and so forth. The controller can process the data to determine max flexure, average, median, acceleration data, periodicity, turbulence, or other computations as desired so as to reduce the data that is to be transmitted.

Controller U5 can also be configured for alternatively, or additionally, sensing other conditions from sensor U7, such as temperature, chemical sensing, or any other metric desired to be sensed. The controller can perform sampling, or perform other operations as the data is available, as certain values are found, or in response to periodic nature, such as driven by a timer U8. The controller can thus activate the transmitter to pass along data to a remote receiver at the proper times.

It should also be appreciated that anti-collision mechanisms can be incorporated within the design to prevent the output from different sensors from overlapping and preventing the remote receiver from properly reading the data. One simple form of anti-collision can be performed by utilizing timer U8 with randomizing, wherein upon generating a first transmission a random interval within a specified range is then meted out for a second retransmission, and another random interval can be provided for a third transmission. Each transmission preferably being encoded with a transmission identifier (i.e. 0, 1,2) to provide addition information about the transmissions to the remote receiver. It will be appreciated that other forms of anti-collision can be performed, such as utilizing a receiver to sense activity and so forth as will be known to one of ordinary skill in the art.

Transmission from the device can be according to a single channel output, multi-channel output, or spread spectrum output in which pulsed transmissions are generated across a range of output frequencies.

In one embodiment, the piezoelectric device comprises an elongated element which is formed having a cylindrical cross-section similar to a string. In this way the turbulence readings can be made more accurate as torsional deflections are no longer a factor in the output of the device. It should also be appreciated that multiple elements may extend from a single RFID element, however, this can introduce interaction factors which would be undesired in many applications.

It should be readily appreciated that the RFID tag of the invention is capable of providing information about fluid motion proximal to the RFID tag as the “string” flexes in the turbulent flow. It should be appreciated that strings have been attached to structures for detecting flow for many decades, however, these string sensors must be viewed with very high-speed cameras and the video stream carefully examined to extract the desired information. In the present invention the data is immediately available in an electronic form and the units may be retained for use in permanently detecting flow rates, turbulence of flow, and so forth. The data can be utilized independently or in combination with images to determine aspects of the testing.

Aircraft Lighting Beacons and Landing Lights.

This aspect of the invention is related to utility patent application describing a Buoy Signal within docket “TransportRAST070103” Ser. No. 10/612,225 filed Jul. 1, 2003; and related provisional patent application related to the above Ser. No. 60/394,160 filed Jul. 1, 2002.

The present invention improves aircraft flight safety at night, in particular in view of private aircraft flying VFR, by the use of high visibility lighting systems.

Two aspects are described (1) a laser lighting beacon which increases the visibility of a flying aircraft at a distance, and (2) a laser based landing point indicator. These aspects of the invention can increase aviation safety and simplify landings.

18.1 Laser within Aircraft Beacon.

This aspect of the invention describes a laser aircraft beacon. The mechanicals of the laser beacon can provide a rotating output and may be modulated in tilt direction relation to the line of flight, if desired. A similar implementation which provides for the mechanical directing of the laser output is described within the Buoy Signal application which is incorporated herein by reference.

A rotating beacon for an aircraft which includes a laser beacon along with optional flashing light beacon, such as a plurality of high intensity LEDs, is described. The sweep of the laser provides a long range localized beam which can be more readily seen through obscuration at distance. It will be appreciated that the light from conventional beacons is dispersed wherein the pilot can not readily discern the location or flight level of a nearby aircraft. In contrast the path of a laser beam can be readily seen, especially with fog or similar obscuration which highlights the path of the beam. The high energy nature of the beam allows it to be seen for a much farther distance than conventional omnidirections beacons.

FIG. 48 depicts a simple laser beacon 1110 with outer transparent housing 1112, at least one solid state laser 1114, motor drive mechanism 1116, mirror 1118, rotating shaft 1120. The beam 1122 from laser 1114 is directed in sweeps about the periphery of the unit, preferably in a substantially horizontal plane in relation to the aircraft flight, typically aircraft are flying in a horizontal path. Non-directional light sources 1124 are depicted as a plurality of LEDs coupled to a controller for flashing the LEDs in a pattern. It should be appreciated that the obtuse size of the figure is provided for clarity, however the unit can be implemented in a small size consistent with current beacons, for example approximately 1-3 inches in height, and 2-4 inches in diameter.

Optionally the laser beacon, or mirror assembly, is gimbaled so that it maintains a level (horizontal) output over at least a range of aircraft ascent or descent angles. The leveling mechanism is preferably configured to operate within a small range of normal ascent and descent angles (i.e. +/−10°-30°).

Optionally the beam can be modulated to indicate that altitude changes are arising, such as by generating a output pattern spanning an angular spread in response to the ascent or descent angle.

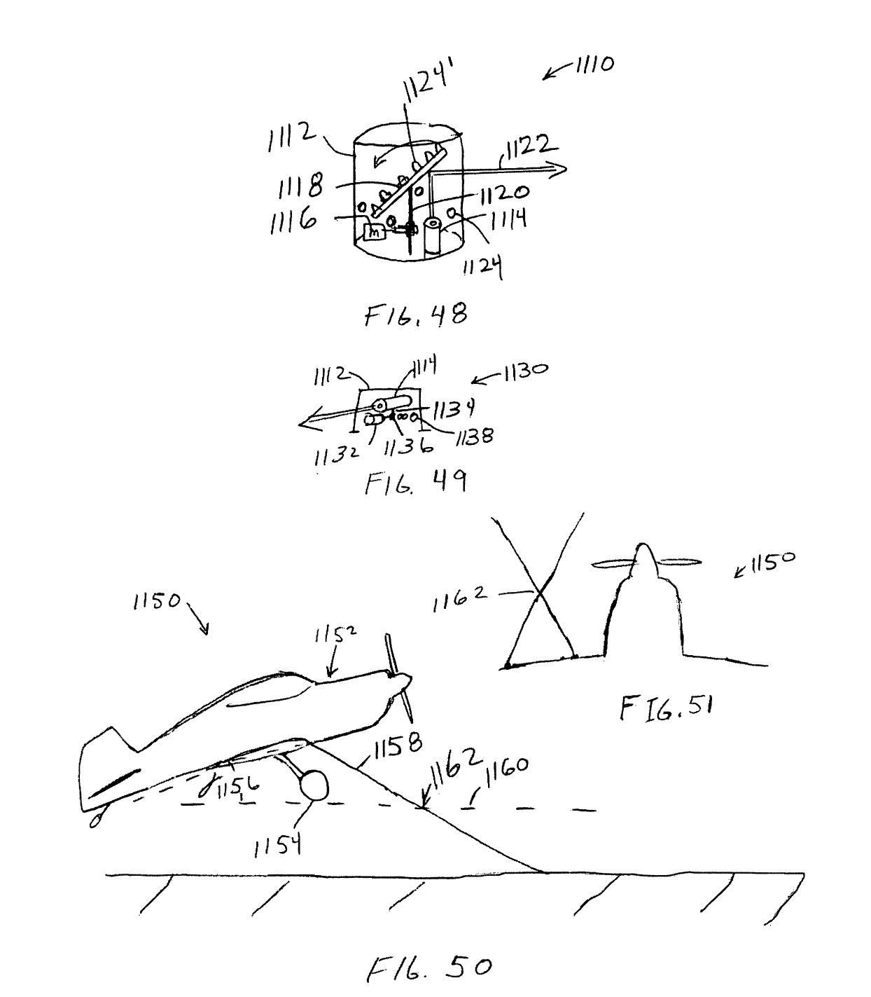

FIG. 49 depicts a similar device 1130 with housing 1112, laser 1114, configured for rotation by motor 1132 which drives axle 1134 through gearing 1136. Power is preferably supplied through brush contact(s) coupled to axle 1134 wherein unrestricted rotation can be generated. Optionally actuators (not shown) can be incorporated to control the inclination of the laser 1114. Again discrete lighting, preferably a plurality of LEDs 1138 can provide non-directional lighting, and preferably be coupled to a timing circuit or controller for a blinking lighting effect. It should be appreciated that the laser can be redirected in a substantially horizontal place by a rotating mirror, lenses, light pipes, or any other convenient light directing means.

18.2 Twinkling Navigation Lights.

In this aspect of the invention, the visibility of the navigation lights is increased by modulating them at fairly high frequency (well above a traditional strobing frequency), for example wherein the twinkle is barely noticeable but actually the subconscious has much greater awareness of variation. For example the light is preferably modulated at from 2 Hz to 20 Hz, and more preferably about 10 Hz. This effect may also be produced using a plurality of light elements, preferably LEDs, which turn on and off at varying times (i.e. each with about 84% duty cycle with 0.5 S on and 0.1 S off), providing a slight flickering effect as well. alternating n−1 bulbs active of n bulbs—fluctuations are more readily seen than conventional navigation lights.

18.3 Laser within Landing Light.

This aspect of the invention describes apparatus to assist the pilot in discerning landing point distance to increase landing safety. It will be appreciated that “featureless” runways, such as large international runways being landed on by a private plane provide a reduce level of height cues to the pilot increasing the opportunity for a “prang” to occur which damages the landing gear and can be sufficiently sever in some cases to lead to failure or loss of control leading to an injury accident.

This aspect describes a crossed laser device which visible to pilots as an aid to landing. The laser beams converge at a point which is approximately on a horizontal plane from the bottom of the extended main landing wheels. The pilot can then readily judge the touchdown point. The lasers can be set at a fixed position for use with a single landing configuration (angle of incidence) or configured to adjust manually or automatically to the flight configuration of the aircraft.

In summary the device generally comprises a lighting beacon for an aircraft which incorporates at least one laser output for increasing the distance over which the aircraft can be seen at night and during in climate weather situations. A form of landing light is shown which provides laser beams which cross at a touch down point that is on a horizontal plane from the bottom of the wheels and can be seen by the pilot.

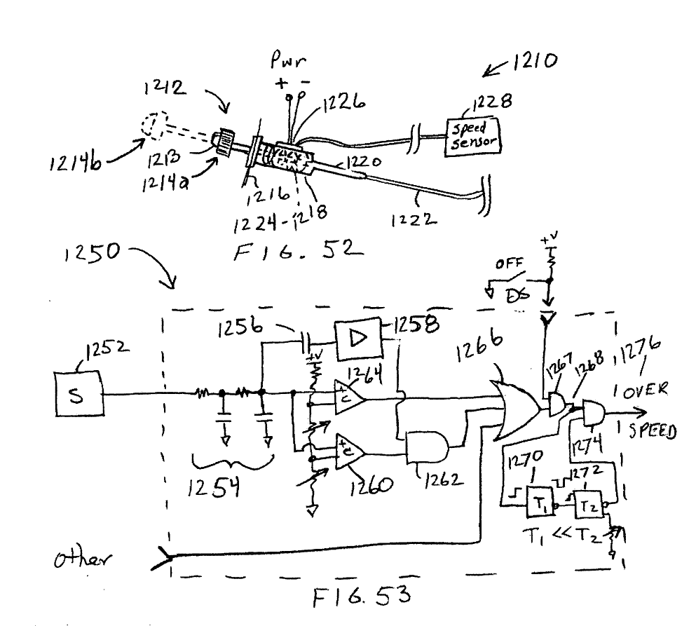

FIG. 50 and FIG. 51 depict the landing distance registration system 1150, coupled to aircraft 1152 with extended landing gear 1154 and in a landing attitude (exaggerated) at landing angle theta 1156. Output beams 1158a, 1158b from two lasers cross 1162 at distance equal to the intersection of a horizontal plane 1160 from the landing gear (presuming a flat runway which most are at least nearly so). In the diagram the lasers are coupled to one side of the aircraft so that the pilot can readily see the intersection and judge their relative distance from the touchdown point. The use of the crossing beams for judging distance was shown in the parent patent application.

Optionally, actuators and a controller modulate the angles of the laser beams in relation to the landing configuration. This can be modulated in response to inclination of the aircraft, or manually set by the pilot in response to landing configuration. For example depending on flaps and engine speed the landing attitude will vary. Preferably, a switch is coupled to the landing gear wherein the system is activated when the gear is deployed and turned off automatically once sufficient weight is applied to the landing gear, or after a given time period. A manual activation control may be provided within the cockpit, which may be wired or wireless coupled to the laser lighting devices. The use of a remote control unit is well suited for use with aftermarket lighting. The laser units themselves may be configured with batteries and have a housing configured for removable attachment to mounting housings attached to the aircraft. In this way the laser units can be removed after use and taken along with the pilot, thereby eliminating the chance of them being stolen.

In aircraft having separate landing lights for each landing gear, the lasers may be integrated with or coupled to the landing lights, such as with a fixed mounting coupled to the landing light. The units then draw power from the landing light arrangement and the position can be adjusted manually by the pilot/mechanic when installing the units on the aircraft. It will be appreciated that the mounting may include a receptacle and connectors for receiving laser modules, wherein they may be removed after use. Plastic sealing plugs being preferably inserted into the receptacles when the laser modules are removed.

Automatic operation may be facilitated by coupling an inclination sensing means with an actuator, and optional control circuit. Preferably the optional control circuit is utilized for filtering the inclination signal. The actuator is activated in response to changes in the inclination to change the angle of the laser output. For example in response to an increase in inclination angle the actuators increase the down angle to maintain the crossing of the lights 1162 at the appropriate height for intersecting the runway. Using this system the pilot can accurately gauge just when the wheels are about to touch so they can very flare accurately and land smoothly every time.

Aircraft V_{NE} Throttle Safety Restrictor.

These aspects of the invention are related to the utility patent describing Remote Landing Assist System and Systems for Stabilizing Aircraft Flight Pattern within docket “ConveySched_{—}061404” Ser. No. 10/867,615 filed Jun. 14, 2004 and associated provisional application docket “PPA_RAST061403” Ser. No. 60/478,900 filed Jun. 14, 2003, which are subject to common assignment.

19.1 Background.

Fatalities have arisen in small aircraft as a result of the pilot allowing the V_{NE} of the airframe to be exceeded leading to structural failure, breakup, and typically death for the pilot and passengers. With the possible advent of a sportsman's class license and loosened restrictions on aircraft the number of such fatalities could increase dramatically. In some cases this accidents arise when the aircraft under full power executes a maneuver (intentionally or inadvertently) improperly while at a high power setting. Having a high applied power is a dangerous situation, as in the wrong attitude the aircraft speed can very quickly raise and lead to failure. Pilots, however, are often more concerned with quickly restoring proper attitude—the two conditions work against one another and lead to disaster. The aircraft is safer even during any recovery maneuver at lower power settings. The pilot concentrates on recovering the attitude but unfortunately is not yet thinking about the airspeed as it relates to the structure of the aircraft. These horrific accidents often would not arise if the power level were cut prior to reaching V_{NE} airspeed.

A need therefore exists for a system and method for preventing V_{NE} related aircraft failures. The present invention fulfills that need and others and can be implemented on existing aircraft and new aircraft models at low cost.

19.2 Summary.

The inventor has recognized that the instincts of the pilot to correct the attitude and then afterward to worry about power levels poses a serious danger to the pilot, passengers, and even persons on the ground. This invention provides an automated method of reducing aircraft power levels toward preventing failures which arise as the aircraft exceeds the designated never exceed speed of the airframe. Few pilots realize that high airspeeds are their number one enemy when wild attitude fluctuations arise, even fewer have the composure to pull the power when an attitude “excursion” arises, and the aircraft design limits exceeded with breakup being the result.

If the aircraft is rapidly approaching V_{NE} then the system cuts the throttle. This mode of operation is particularly well suited for new to intermediate pilots, and those which fly conventional point-to-point routes. In one embodiment the invention provides an over-ride, such as a plug-in card or module, which will not cut the power so that advanced pilots performing aerobatics or other intentional high stress maneuvers are not hindered.

The invention may be implemented as a mechanical system, an electromagnetic separate system, or integrated within an auto piloting system which is preferably configured to perform select safety features even when the autopilot is inactive.

19.3 Mechanical Power Limiter.

A system and method of reducing V_{NE} related aircraft mishaps. Aircraft power is automatically reduced if V_{NE} is approached rapidly or exceeded, wherein the airframe stress is reduced the pilot is more likely to survive a spin or other aircraft attitude problem.

FIG. 52 illustrates an example embodiment 1210 of a power limiting mechanism coupled to the throttle actuator. This example utilizes the example of a push-pull style of throttle wherein control is by means of a knob 1212, typically with a lock button 1213, which is moved forward or rearwardly to change throttle settings, such as between positions 1214a and 1214b. The throttle extends from the firewall 1216 of the cockpit, and the throttle has a rearward elongate housing 1218, often with extension 1220 and from which a control cable 1222 extends which couples to the aircraft power plant (i.e. carburetor manifold of an internal combustion engine) for controlling the power output.

The present invention provides a means for moving the throttle to a lower power setting (i.e. biasing device 1224 in combination with an actuator 1226) in response to an over speed signal from a means for sensing aircraft airspeed 1228. These aspects are embodied in this example with a mechanical biasing element 1224, such as a spring, retained in housing 1218 and coupled to the shaft of the throttle. Moving the throttle to the high power setting requires force applied to biasing element 1224, which stores energy. In response to detecting an over speed condition, an actuator is activated which releases the lock on the throttle wherein the bias force in biasing element 1224 automatically lowers the power setting to avert the possibility of airframe damage. Preferably the

In this example presume full throttle is achieved by engaging button 1213 and pushing the throttle forward to the shown position. During flight presume the pilot gets the aircraft into a situation, for example enters a spin. The aircraft speed rapidly increases as sensed by speed sensor 1228 which outputs an over speed signal. The actuator 1226 is triggered by the over speed signal to release the throttle lock allowing biasing member 1224 to restore the throttle to a low power setting, therein reducing the stresses on the airframe while aiding attitude recovery.

It should be appreciated that although speed sensor 1228 can be configured to sense exceeding V_{NE} it more preferably senses the rate at which V_{NE} is being approached, wherein it may drop the power setting before V_{NE} is exceeded. Furthermore, speed sensor 1228 is configured to provide a limited generation of the output signal, for example once in a given period of time. In this way, the unit does not thwart a pilot that actually wants the full power applied, even though airspeed is fast approaching or exceeding V_{NE} Even it they are wrong—they had to consciously decide to use full power. Most pilots however, should welcome the alert and automatic power reduction which lowers their workload and increases their safety. The speed sensor may be coupled to existing speed sensors or be operated from an independent speed sensor.

It should be appreciated that this mechanism may be adapted to a number of different types of throttle control mechanisms. For example lever style throttles, wherein a biasing means or actuator is provided by way of the invention for restoring a lower power setting automatically. Other inputs may be coupled to said speed sensor 28, such as other aircraft conditions, such as sensing nose down attitude. In twin engine aircraft the throttle control also preferably senses a power loss on a first engine, wherein it immediately cuts power on the second engine, therein preventing the loss of pilot control which often arises when an engine is suddenly lost.

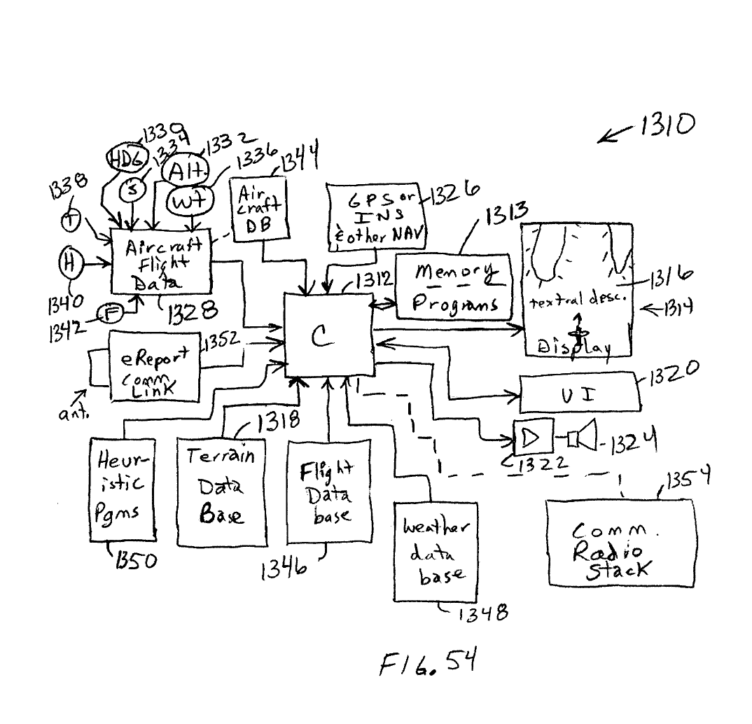

FIG. 53 illustrates an example of a speed sensing circuit 1250 according to the invention. A sensor for speed 1252, such as differential temperature types, vane types, turbine types, GPS signal output, navigation system outputs, or the traditional pitot tube pressure sensing variety may be configured with an electrical transducer for generating an electrical signal from sensor 1252 into circuit 1250.

Signal conditioning circuits 1254, prepare the signal, such as depicted with a low pass filter. The signal is then AC coupled to an amplifier section, wherein rapid speed increases generate an output signal to AND gate 1262. A first comparator 1260 provides a sub-V_{NE} threshold which is preferably selectably (i.e. around 80-95% of V_{NE}) set for the given aircraft and aircraft use (i.e. selectable by adjusting resistors). The AND gate 1262 is activated if the speed is rising at a rapid rate and the speed is within the selected percentage of V_{NE}. Another threshold condition is determined by speed, wherein if the speed exceeds V_{NE} then comparator 1264 is triggered. An OR gate 1266 provides for generating an over speed signal 1268 if the speed is rising rapidly to V_{NE} or has exceeded V_{NE}.

Furthermore an additional input to OR gate 1266 allows inputting other conditions for generating an over speed signal, for example a stall sensor input, or the engine out condition in a small multiengine aircraft. This raw over speed signal passed through an AND gate 1267 coupled to an switch DS input for deselecting the operation of the power reducing system. When the switch DS is closed AND gate 1267 prevents the propagation of the raw over speed signal. When switch DS is open AND gate passes the raw over speed signal 1268 which is conditioned by a timing circuit to prevent the system from continually dropping the power.

Over speed output 1268 triggers a first timer 1270 on a rising edge to provide a delay (or use gate delay), the output being inverted generating a low going pulse in response to over speed being triggered. When the time elapses on the first timer (for example about 1-10 mS) then the positive edge triggers a second timer 1272 whose inverted output generates a low going output for a period of time measured in minutes (i.e. 3-15 minutes) assuming that the user would not unintentionally be going from one V_{NE} problem condition to another. The AND gate 1274 gates the clock signal and raw over speed signal from OR gate 1266 to provide a time conditioned over speed signal 1276 in response to sensing a first over speed, the signal being a high going output signal for a duration equal to the length of clock 1270, after which subsequent generation of conditioned over speed signal 1276 is prevented while timer 1272 is still active from the first over speed condition. It will be appreciated that a number of mechanisms may be utilized for registering the speed and other conditions, and these will be apparent to one of ordinary skill in the art in view of the teachings above and thereby not depart from the teachings herein.

It should be appreciated that alternate embodiments of the invention may reduce power any desired amount, or an amount in response to the conditions that the power setting need not be dropped to idle, it may be dropped proportional to the situation,

19.4 Integration of Over speed Power Control.

It should be appreciated that many aircraft have autopilots and other control systems for controlling aspects of aircraft operation. These systems typically are configured for registering aircraft speed and other conditions affecting flight.

The present invention can be integrated within these systems, to provide an over speed safety mode which operates even when the autopilot or other system is not being utilized. Programming within the autopilot can similarly sense a fast approach to V_{NE}, or exceeding V_{NE} and drop the throttle setting accordingly to provide the similar safety features described above and shown in the block diagram. Similarly, the programming would limit the times it intervened with the presumption that the pilot generally knows best the first power drop being a reminder, but allowing the pilot to override the reduction if desired. Similarly a switch should be provided to allow the pilot, such as an advanced pilot intentionally performing high stress maneuvers. Incorporation of the present invention provides an important benefit because pilots often fly without autopilots engaged, wherein the present invention increases safety and reduces mishaps in which over speed V_{NE} contributed to the mishap.

Situational In-flight Aircraft Terrain Alerting System.

This aspect of the invention is related to copending application(s) describing a Common Mapping Interface within utility patent docket “TransportRAST070103” Ser. No. 10/612,225 as filed Jul. 1, 2003; and associated provisional patent application Ser. No. 60/394,160 as filed Jul. 1, 2002, which are subject to a common assignment.

20.1 Background.

Pilots often get themselves into situations from which their flying abilities and the limited turn and climb capabilities of their aircraft are unable to extricate them. By way of example, one such situation is that of a box canyon. The pilot flies into a narrowing canyon, and only too late realizes the situation, wherein as they are unable to climb out or turn tightly enough they strike the wall of the canyon, typically killing all aboard.

Therefore, a need exists for a system for preventing such disasters. The present invention fulfills that needs and others and can be readily implemented.

20.2 Summary of Invention.

The present invention is a method of system of generating pilot warnings in response to what is referred to herein as “second level” (also referred to herein as indirect or inferred hazards) flying hazards, such as the terrain hazard box canyon scenario described above. Furthermore, the system can incorporate additional information such as weather conditions, registered flight conditions (i.e. wind speed, temperature, humidity, time of day, fuel reserves, etc.) and the like for generating other forms of second level alerts, such as for possible wind sheer, downdrafts, and the like.

A first level hazard is a hazard which would be typically immediately recognizable to the pilot, such as flying into a thunderstorm or into a mountain peak having a height with exceeds their altitude. Although the present invention preferably provides improved generation of these forms of alerts, it is recognized within the invention, that these should be apparent to even a semi-alert pilot, and few accidents arise from these apparent conditions. However, situations which are not readily apparent are the ones that cost pilots their lives.

The invention is particularly well suited for small aircraft flown by private pilots, especially when flown at lower flight levels proximal to terrain.

20.3 Detailed Description.

The system is preferably configured for generating a number of various second level alerts, as well as preferably generating first level alerts. The system is preferably implemented in conjunction with, or integrated with a mapping system, such as moving map display which contains a terrain database. Programming associated with a computer is configured for analyzing aircraft information and other data in relation to the terrain database for registering a number of first and second level alerts to the pilot. These alerts being preferably generated as text or graphic alerts on a moving map display and/or audio or other forms of annunciation. The following are a partial listing of what can comprise first and second level alerts.

20.4 Implementation with a moving map.

FIG. 54 depicts an embodiment of a moving map system 1310 with a computer 1312 which is coupled to memory 1313 having RAM and programming for controlling a moving map display (or other flight data output system) and programming according to the present invention for generating first and more preferably first and second level alerts. A moving map 1314 is shown by which maps 1316, data for which is contained in a terrain database 1318, in relation to the current flight path are shown. A user interface 1320 and audio alert system with amplifier 1320 and speaker 1322, or preferably coupled into the intercom system of the aircraft, are provided for interfacing with the user to control the moving map display such as setting magnification and so forth and receiving information in return. The moving map registers the position of the aircraft, preferably with the position information means 1326, such as a global positioning system (GPS), inertial navigation system (INS), flight navigation system and other position indicating inputs.

The present system is preferably implemented primarily as programming within existing moving map display systems, or other forms of computer based flight information systems. The present system may be based on existing hardware or may provide additional functionality as additional hardware is coupled to the moving map, or other flight information system, for augmented data collection, data analyzation, and data output.

Additional information is also preferably supplied to the moving map system and computer therein. For example addition information about the aircraft is preferably provided by aircraft flight data systems 1328. Preferably, some inputs to these systems are redundant with information provided by the GPS to provide a cross check and to provide some functionality even when GPS signals are not available (i.e. satellite problems or aircraft receiver problems). The data received from flight system preferably includes heading 1330, altitude 1332 and speed 1334. Optionally, the weight of the aircraft 1336 and other conditions, such as outside temperature 1338 and humidity 1340, and fuel remaining 1342 can be registered.

An aircraft performance database 1344 is preferably coupled to the present invention for providing information about the relative capabilities of the aircraft and power plant under a variety of conditions. It will be appreciated that certain conditions which pose a danger for example to a Cessna 172, would not be a problem for a Beech craft® King Air, such as icing or climb performance. The database preferably contains figures for climb rates, turning rates, fuel consumption, handling of weather (i.e. icing systems) and parameters about the equipment on board. This data being preferably provided as curves based on loading and other pertinent factors. Furthermore, the database should support derating, such as based on aircraft age, use, known factors, or owner selected derating factors. Also the aircraft may have been upgraded with fairings, improved engines and so forth, wherein these changes can also be loaded into the information available. This database also preferably includes conventionally checklists for the aircraft, along with emergency checklist menus to be navigated in the case of an emergency.

An airspace data base 1346 is also preferably coupled to the system having airspace information which preferably includes flight restrictions, locations of airports, communication frequencies for each airport and other organizations. Also preferably included are approach plates for each facility, wherein these may be displayed on the moving map display. Furthermore, the system is configured to determine if the data in the database is up to date, such as by comparing database date information for the facility against an automated electronically encoded ATIS information (as described elsewhere). The airspace data base should also include typical flight patterns, especially around crowded airports wherein the user can be alerted so as to steer clear from those high traffic areas if possible.

A weather database 1348 is also preferably incorporated, which provides data about various how the weather affects specific terrain features. For example winds in certain directions can cause sever downdrafts or sheer in specific areas. Also areas are known for generating severe turbulence or sudden thunderstorms in response to a given range of weather conditions.

A heuristics database 1350 preferably contains a database of known relationships between terrain, weather, airspace data, and flight conditions for the generation of second level alert conditions. For example this program would contain the algorithms for determining if a box canyon alert should be generated, and how to generate the alert. A number of various algorithms, and parameters are preferably contained in this database for determining the level of risk associated with various activities of the aircraft in relation to the terrain, flight path, and weather conditions. A large portion of the heuristics may be embedded in the baseline programming 1313 for the computer, wherein only parameters and heuristic routines need be accessed from this database. It is preferred that the heuristics be contained separately from the programming within memory 1313, as the heuristic database would be refined periodically as new understandings of flight arise and the determination of threats are refined.

An electronic communication link 1352 is represented for collecting information on the fly as may be utilized for increasing the accuracy of the alerts and so forth. For example this may be configured for receiving electronic based ATIS information, wherein information about airport facilities may be updated on the fly based on actual information from the airport. In addition, this electronic channel can provide other forms of information download, such as for updating the other databases and electronically communicating status and location in the case of an emergency situation. The electronic data may be received from an adapted communication radio stack 1354. The radio stack 1354 is preferably configured to allow computer 1312 to adjust the settings of at least one of the radios in response to information in the air space data base and/or ATIS type information.

The programming of the present invention is preferably configured to detect as many possible threats as are foreseeable from the available data on terrain, flight path, flight condition, airspace information, estimated air traffic, weather conditions, and aircraft status in reference to the parameters for the given aircraft. The system includes the following checks and generates alerts accordingly.

First Level Alerts.

The system is preferably configured for generating all forms of what we term herein as first level alerts, such as approaching terrain, military training areas, and so forth. These first level alerts can be generated without considering the specific aspects of the flight of the aircraft.

Second Level Alerts.

Second level hazards are presented to the user generally based on the direction and altitude of flight. The more fluid the situation, for example frequent changes to flight levels and flight paths, the larger area over which the alerts are generated. The problems which arise from the current course and altitude being the primary subject of the alerts. The second level hazards which are preferably detected include the following:

Terrain, Box Hazard Detection.

The system detects a periphery of terrain that pilot is heading into, wherein present altitude and climb rate present a danger. The programming system compares current flight pattern with terrain (i.e. straight-ahead flight path). If a box situation or partial box is found (i.e. with limited exit possibility such as can be passed) then terrain alert generated with the subject box canyon areas being marked, such as in red on the moving map. Exits to the canyon can be marked in yellow, however, this may be better indicated at a later time in case pilot goes against better judgment, so as not to induce reckless pilot behavior. The can alert the pilot even if they initially have a sufficient altitude of climb rate should they descend or fail to climb appropriately as in cursing further into the situation. For example on descending the system preferably outlines the box obstruction and clearance problems, wherein the pilot is warned to ascend, turn, or take other corrective actions.

Flight Restrictions.

The system preferably compares present flight path, altitude, and possibly other metrics against a flight database for detecting if any flight restrictions exist. These could be displayed as colors on the moving map, such as yellow, wherein the actual restrictions at issue are preferably displayed as text, with contact information and wherein the pilot can select to get more information about the situation could be approaching airports or other areas where flight restriction exist for current flight level.

Atmospheric Related Terrain Alerts.

Data on atmospheric conditions are compared against the terrain database to determine dangerous conditions that can arise along the flight path. For example close approaches over hills and through canyons poses a much higher risk during high wind conditions.

The programming can preferably utilize wind speed information determined as the different between groundspeed, which is detected by the GPS unit coupled to the moving map, and airspeed which is or can be coupled to the moving map; the difference providing a direction and speed of the wind. The system utilizes this information in reference to the database to determine possible problems along the flight path.

In addition, the flight data base should contain specific information identified by the FAA for certain areas in reference to atmospheric conditions, to which the system can generate an alert. Again it is preferred that the area for which the problems may arise be highlighted on the moving map with indications (i.e. as text, speech, graphics etc.) of the identified risk situation.

Furthermore, the programming is preferably configured to automatically receive electronic reports of weather conditions for the area as well as nearby altimeter readings. The program is configured to alert the pilot to any upcoming in climate weather conditions, and then it continues to analyze these reports and determines if any significant dangers exist. Such as low ceilings over upcoming terrain, wind sheer conditions, limited visibility, and so forth. Again the weather patterns are preferably compared against a database to determine what other hazards may arise. For example a front striking the Sierra Nevada hills in California often results in extreme thunderstorms and lightning, which would not be readily discernable because the storm moving over the low lands may appear wholly benign.

The pilot can be warned to reduce airspeed in response to air turbulence conditions and the like. The programming preferably also generates an alert if local density altitude pressure settings are diverging from that to which the aircraft altimeter is set.

Preferably the system may be used on the ground or in the air. For example for takeoff (or landings) the data about the density altitude, aircraft loading, wind, and other conditions. Aircraft weight may estimated by the system and/or entered by the pilot, such as entering actual load information, or just the number of passengers and the fuel load. Preferably, the system is configured to register the actual weight of the aircraft (disclosed in another invention incorporated by reference) from which performance data can be computed for the given conditions and compared with the runway length and conditions to determine a safety factor.

Emergency Options.

An emergency options button is preferably provided by the system, which automates a number of the procedures normally performed in response to engine out, fire, structural problems and so forth which can be encountered.

The single button reduces pilot workload at a time when the pilot is most vulnerable to decision stress. Furthermore, the system can incorporate checklists for handling various emergency situations for the given aircraft. In the event of the engine out situation the system computes reachable emergency landing sites in response to current altitude, wind speeds, loading, weather conditions, and the glide performance of the aircraft. It can also alert the pilot if they have not established an optimal glide path (inexperienced pilots often excessively slow the aircraft causing increased descent rate). The system color codes various possible landing sites (i.e. airports, military bases, open fields, major roadways, and the like) and preferably color codes the viability of these possible landing sites. The frequency for contacting any of these controlling agencies is preferably displayed and the system may automatically make contact with a central agency (at pilots discretion) to alert them of the situation, wherein they may provide additional aid.

Enhanced ATIS (Aircraft Traffic Information System).

21.1 Background.

The information received by pilots is primarily by way of voice. Although the entire airspace system may adopt an electronic data component, a need exists for a simple means of increasing information readily available to the pilot.

21.2 Description.

Describes an enhanced ATIS (aircraft traffic and information system) for augmenting the audio information dissemination with electronic data that can be stored within the aircraft for later use. An enhanced ATIS service which includes encoded computer readable data, such as the runway in use and other information, or which directs an automated communication system within the receiving aircraft to a specific channel for receiving additional information about the facility.

Enhanced ATIS—Typically ATIS information is listened to by the pilot to provide information. However, with more advanced aircraft systems, it is preferable that the systems of the aircraft register conditions of the airport, wherein this information can be utilized for alerting the pilot as necessary and for properly indicating landing routes and so forth on moving map displays. The information collected from the ATIS system is preferably stored in an information database, wherein the airspace database retained on the aircraft is automatically updated.

The present invention includes encoding electronically readable information into the ATIS broadcast, wherein aircraft systems can utilize the information. This information includes the conventional ATIS information, but encoded electronically within the broadcast, or in a sub band or other frequency related to the ATIS, or for which a small amount of data encoded in the ATIS provides frequency data for an aircraft receiver to be automatically tuned to for receiving a data form of ATIS broadcast. The ATIS broadcast would also preferably include a designator for the name of the facility generating the broadcast, as well as the coordinates of a reference within that facility, allowing rapid correlation of received information with map data in the database. The ATIS information distributed on a channel of sufficient bandwidth should also comprise detailed information on all the current approach, and optionally data on all approaches for updating the pilot databases as an aid in future flight planning.

In-Aircraft Tire Weight Registration.

This aspect of the invention is related to copending application(s) utility patent application entitled “Predicting Tire Pressure—circumferential sensors”, “Powering a Stem-mounted Tire Pressure Sensor”, and describing a compliant wheel core generating an output in response to pressure within docket “Display_RAST092303” Ser. No. 10/670,432 as filed Sep. 23, 2003; and provisional patent application associated with the above Ser. No. 60/413,199 as filed Sep. 23, 2002; which are all subject to a common assignment.

22.1 Background.

The importance of registering tire pressure has recently become a big issue with automatic systems for registering tire pressure being mandated by government to take effect in the near term. However another important aspect for safety and for other concerns relates to determining the load being placed on the tires.

The loading factors on the vehicle and the relative loads placed on each tire are important factors for any vehicle operations, and are critical in operations of aircraft systems.

Therefore a need exists for a method and system of readily registering tire load, the present system fulfills that need and provides additional advantages.

22.2 Summary of Invention.

The present invention can share many of the aspects of the tire pressure sensing sensor described elsewhere in this application and the two may be embodied in the same sensor device. The preferred embodiment of the present system is particularly well suited for use in aircraft, wherein an imbalanced load, or excessive load, in relation the prevalent conditions can lead to a disaster.

In the preferred embodiment the weight applied to the axle or other structure is registered by a force gauge, or pressure transducer, and communicated for providing enhanced information to the operator and/or for controlling aspects of vehicle operation.

For example, the loaded weight and weight distribution on the wheels is an important factor in performing safe flight operations.

The force on each tire can be communicated to a control computer, user interface, or other system, such as in a similar manner as the tire pressure information is communicated between the tire and a control system.

22.3 Detailed Description.

A system and method for automated display of aircraft loading in preparation for flight. The invention can be implemented on existing aircraft or within new designs. In one embodiment the weight pressure is sensed on each tire. The sensed information can be utilized for increasing the accuracy of tire pressure warnings. Additionally, the weight value can be utilized for other purposes. For example a weight station may have equipment to register the outputs from each tire, wherein a drive by weighing of trucks can be performed.

In another application, the weight applied to the tires of an aircraft are summed to determine the total weight of the aircraft, wherein the pilot can be alerted to the over weight conditions, or balance conditions, such as if the weight supported on the landing gear indicates and out of balance conditions. The force sensors may be less preferably incorporated within the landing gear portions of the aircraft, or within the suspensions of vehicles. The system collecting the information can optionally take into account wind based factors, such as the lift and drag produced from a headwind of a given intensity, to further improve accuracy in overall weight and balance factors. On preferred mechanism for performing offsets for weight is in performing the measurements when the aircraft is oriented in different directions, wherein the contributions of the wind can be corrected for. Another correction mechanism provides for storing data about lift and drag factors for the given aircraft type in response to the relative direction that the wind is striking the aircraft. These empirical factors can then be utilized within simple calculations to correct wind induced loading factors. Alternatively, the system can perform calculations based on general types of aircraft, without the use of empirically collected data for the specific model, or instance.

The information can be collected based on near-field magnetic conditions (NFMC), radio frequency transmissions (i.e. RFID transducer with force pickup), wired coupling, audio output, and so forth. In one embodiment the pressure readings are automatically summed and transmitted through a Fast Track communication link to an automated station. (The output of the system can be correlated at conventional stations, or using additional weight registration equipment as described below).

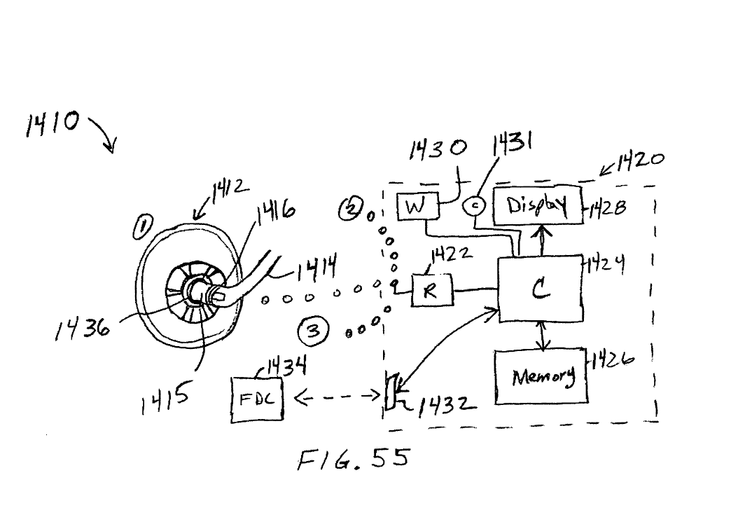

FIG. 55 illustrates a simple embodiment 1410 of the system mounted on an aircraft wheel 1412 and landing gear leg/axle 1414. A means for registering strain is coupled to the landing gear leg 1414, such as at or within the axle 1415. For example a strain sensor may be coupled within an elongated axle, preferably hardened steel, which is configured to sense minor deflections, strains, of the axles under the load which is applied primarily in response to the load on the aircraft. The strain information is read by a controller, such as by controller 1424 in conjunction with memory 1426, over a wireless communication link from a receiver 1422 configured for communicating (through a single or multiple channels) with strain gauges mounted on each wheel. It should be appreciated that other sensors (2, 3) may be utilized whose outputs can provide a measure of the load being applied at tire 1412 to landing gear leg 1414.

A wind sensor 1430 is preferably coupled to controller 1424 for allowing the system to incorporate wind data into the loading computations. The wind sensor preferably generates both direction and speed information to controller 1424. The wind sensor may comprise a separate unit or more preferably be provided by wind and direction information provided by other aircraft systems. Programming within memory 1426 for execution within controller 1424 being preferably configured for correlating winds with the pressures applied to the wheels. Furthermore, in response to varying winds the programming is configured to determine the amount of wind effect, wherein a base-line no-wind loading value can be accurately estimated. Alternatively, or additionally a compass sensor 1431, or compass output from other equipment can be coupled to controller 1424.

It will be appreciated that the system, such as through controller 1424, can be coupled to other instrumentation and control systems (i.e. moving map display, with the aircraft, such as through an interface 1432 to a flight data controller 1434, wherein the loading information may be displayed on an external display or utilized with other collected information output to the pilot, or other persons preparing the flight.

The pressure sensing may also be accomplished by incorporating a sensor 1436 within the wheel assembly, such as within the tire, rim or mounting hole. For instance a bearing assembly having a sensor may be incorporated. The sensor registers the deflection of a portion of the bearing in response to weight being applied. A system is described in the application Display_RAST092303, incorporated herein by reference, in which a compliant piezoelectric core about the axle is used for generating power in response to motion of the wheel. It will be appreciated that far less motion is necessary in sensing strain applied by the wheel to the axle shaft, wherein the compliance of the bearing in may cases can be sufficient to allow registering the weight loading at the wheel. Furthermore, the use of a statically sensitive sensor element (i.e. strain, pressure, etc.) is preferred over gauging the output of a piezoelectric transducer, whose output is in response to change and not to static conditions.

Automated Aircraft Weight and Balance System.

This aspect of the invention is related to copending application provisional patent application describing “Approaching vehicle traffic safety system” and “Intersection transgression alert” within docket “PPA_RAST120103” Ser. No. 60/526,376 dated Dec. 1, 2003, which is subject to a common assignment.

23.1 Background.

The loading of an aircraft is extremely important for assuring that the maximum load has not been exceeded and for assuring the resultant center of gravity is within acceptable limits. However, this is presently performed by doing calculations on the weights and moments of each article loaded into the aircraft. In many instances errors are made in computing loading factors, or the operating crew does ignores these important considerations and just loads the aircraft.

Therefore, a need exists for a system which is inexpensive but which can readily check the weight and balance of an aircraft. The present invention fulfills that need as well as others and is easily implemented.

23.2 Summary of Invention.

The present invention provides an accurate on field check of weight and balance for a loaded aircraft. The system may be implemented as a drive over system used at an airport for determining the loading factors and displaying these to the pilot while the aircraft is in the run up area and before the aircraft is cleared for the hold line. The system can perform the weight checking in a manner that is irrespective of wind loading, such as using a rotating platform or more preferably by having the aircraft weight sensed on portions of the taxiway that run in different directions.

23.4 Detailed Description.

FIG. 56 depicts two different forms of automated weight balance sensing 1510 according to the invention. A taxiway 1512, section of run-up area, or other area over which the aircraft will traverse is configured with pressure sensing strips 1514a-1514d. These may be constructed using conventional means for sensing pressure with a pneumatic mechanism, or more preferably utilizing the piezoelectric techniques described in a related application by inventor.

An aircraft 1516 with nose wheel 1518 and rear wheels 1520a, 1520b, is shown traversing the pressure sensing strips on taxiway 1512. The sensing strips 1514a-1514d sense the weight pressure applied by each tire to the strip. The strips are placed so that measurements are made from multiple angles in relation to the relative wind. In this instance each of the four sensors is oriented at a different angle in relation to the relative wind, wherein the controller can substantially nullify the effects of wind on the loading computations.

A less preferable alternative is shown as a rotating pad 1522 having sensors in a front portion 1524 and rear portion 1526. The aircraft can taxi onto the platform which contains pressure or weight sensors for registering loading on each wheel.

A computer device computes the relative loading from the sensor data, and corrects for wind factors. A display 1528 is shown for annunciating the processed information to the pilot, tower personnel, and/or other personnel. The loading information is preferably displayed as an overall load and a relative load, such as front to back. Optionally the side to side balance can be displayed, as well as computed factors such as center of gravity. This information can be utilized by the pilot as a final check that aircraft loading is within acceptable limits for the current flight conditions. For example, the pilot will have a chart for the particular aircraft which indicates a weight limit and a chart which depicts the allowed range of allowed front to back weight distributions for each given weight value. In this way the pilot can be informed of actual loading conditions, wherein they are less likely to guess. Typically weight and balance is not computed on small private aircraft as it is time consuming to determine total load and balance by measuring the weight of each passenger and article as well as the position each articles in relation to a datum line.

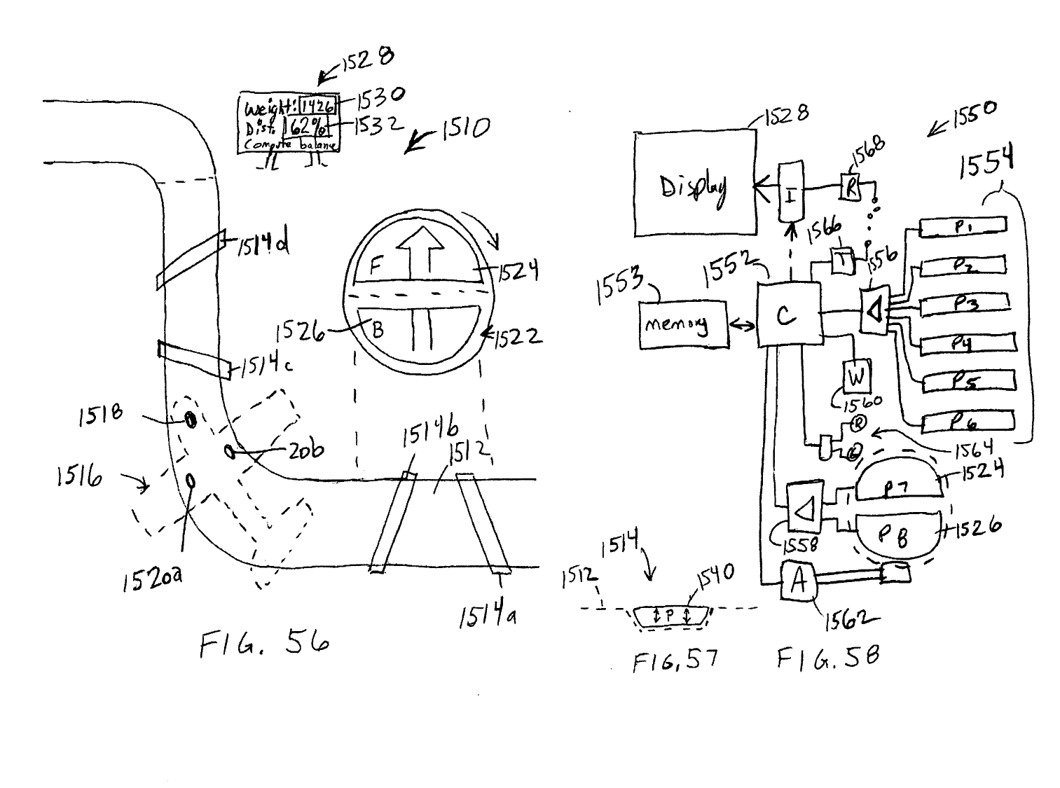

FIG. 57 depicts a preferred embodiment for the weight registration strips 1514 which are shown substantially flush mounted with the surface of taxiway 1512. It will be appreciated that the need for flush mounting depends on the thickness of the sensors being utilized. The width of each strip should be larger than the contact area of the tire with the taxiway, therein the entire weight from that landing gear will be applied to the strip during some moment as the tire passes over the strip. The pressure sensing technique described below for “Pressure sensing device” may also be utilized in sensing the loading on each wheel of the aircraft.

FIG. 58 illustrates a circuit 1550 for displaying the loading information and automatically correcting for wind affects. A controller 1552, such as a microcontroller or microprocessor, in combination with memory 1554 is shown coupled to a series of pressure strips P1-P6 1554. Also shown is the pressure sensing strips P7-P8 1524, 1526 from rotating pressure platform 1522 shown in FIG. 56. The inputs from the pressure sensors are input to conditioning circuits 1556, 1558 prior to being read by controller 1552. A wind speed detector 1560 is shown preferably configured for registering instantaneous wind speed and direction. An actuator 1562 is shown for rotating platform containing front and rear sensors 1524, 1526, (which may include additional sensors for registering side to side with information). A signal output 1564 is shown as red and green lights to aid the pilot in moving the correct distance over platform 1522. The system registers the loading as the aircraft moves over the platform and generates the green light when all wheels are on the platform and the wheels are sufficiently centered within the platform.

Output from the controller can be by a wired connection to an interface 1564, or a wireless connection through a transmitter 1566 and receiver 1568. Alternatively, transmitter 1566 can be configured for generating information to be read by a system within the aircraft, which receives the loading data for use within internal calculations, and/or for display within the aircraft such as on a graphical display unit, such as on a moving map display or similar.

It should be appreciated that these sensor strips may comprise piezoelectric sensing elements embedded with a flexible backing so that an output voltage is generated in response to the extent of flexure. Alternatively, strain gauge sensors or other forms of sensors may be utilized for detecting the weight being applied by the wheels of the aircraft. These sensors are described in other patent applications by the inventor. The sensing strips are preferably protected by a penetration-resistance surface, such as Kevlar™, to prevent damage to the sensing mechanism in response to sharp objects embedded in vehicle tires, (i.e. rocks stuck in treads, chunks of ice, studs on snow tires, tire chains, etc.). Furthermore, a compliant layer may be included to reduce the possibility of damage to the sensor. For example a polymeric material layer (i.e. 0.05-0.1 inch thick) placed over sensor and under the penetration-resistant surface, (alternatively above the penetration resistant material layer). Alternatively, or additionally, the compliant material layer may be placed beneath the sensor section. By utilizing the above the sensor can be shielded from damage. Rather than using a Kevlar layer or similar penetration-resistant layer, the compliant layer may be configured with sufficient rigidity to itself provide the penetration resistance, such as by utilizing a polymeric material that has sufficient rigidity throughout its thickness or through a layer of its construction (i.e. surface or base).

Another form of sensor that may be utilized is a bladder form of sensor may be utilized, as shown in FIG. 57, wherein the pressure within the bladder is equal to the weight applied from the tire to the bladder. A pressure sensor coupled to the bladder allows registering the weight being applied, the pressure signal being communicating to the computer for processing. The bladder preferably is configured with a small equalization port, wherein pressure equilibrium between with ambient conditions is maintained despite changes in temperature, environmental factors, and the radiant energy impinging on the bladder. Alternatively the pressure sensing mechanism described below can be incorporated into the bladder for registering the relative pressure.

It should be appreciated that a number of alternative embodiments of the aircraft loading registration system can be implemented from the above teachings. It should also be appreciated that the above system can be less preferably configured to provide a total load value without providing load distribution information. Eliminating the need to determine load distributions can reduce the number of sensors required as will as simplifying the control and display electronics.

24. Conclusion.

It should be appreciated that the foregoing examples, may include navigation and/or strobe lighting that is used in conjunction with the tip tracking system described within the present invention. Furthermore, these circuits are provided by way of example and may be adapted by one of ordinary skill in that art without creative efforts and without departing from the teachings of the present invention.

A number of implementation examples for the tip tracker system have been shown by way of example in the previous description, however, a number of variations may be implemented by one of ordinary skill without the need of creative efforts. The light sources have been shown utilizing laser lights, however, it will be recognized that other light sources are capable of functioning to project beams of light through a pattern so that the reflection can be recognized. Various mounting configuration were shown by example, however, the tip tracker may be mounted in various other configurations in which the light is projected forward of the travel of the surface to be protected.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An illumination bulb module, comprising:
a housing adapted for receiving power from a bulb receptacle into which it is inserted;
at least one solid state light emitting element joined to said housing and adapted to generate a partial or fully omni directional lighting pattern; and
a laser diode illumination source within said housing, adapted for directing a narrow beam of illumination in a predetermined direction.

2. A bulb as recited in claim 1, wherein said partial or fully omni directional lighting pattern is configured to be equivalent to a conventional illumination element.

3. A bulb as recited in claim 1, wherein a plurality of solid state light emitting elements is joined to said housing.

4. A bulb as recited in claim 1, wherein said solid state light emitting elements comprise light emitting diodes (LEDs).

5. A bulb as recited in claim 1, wherein said illumination bulb is configured for connection within an aircraft navigation or strobe lighting circuit.

6. A bulb as recited in claim 1, wherein said lighting system is an automotive, truck, motorcycle, or boat lighting system.

7. A bulb as recited in claim 1, further comprising a controller circuit within said housing, said controller circuit adapted for controlling the power applied to said laser diode element.

8. A bulb as recited in claim 7, wherein said controller circuit is further configured for controlling power application to said solid state light emitting element.

9. A bulb as recited in claim 7, wherein said controller circuit controls the duration that said laser diode illumination element is activated.

10. A light beacon apparatus for increasing aircraft recognition during flight comprising:
a housing having transparent portions and configured for attachment to an aircraft;
a power connection from said housing to receive power from an aircraft to which said housing is connected;
a laser light source retained in said housing;
a power supply receiving power from said power connection for regulating the current applied to the laser element in said laser light source;
at least one substantially non-directional light source configured to generate a flashed or rotating light output in response to power received from said power connection; and
means for directing the laser or its output light beam in a circular pattern about a substantially horizontal plane.

11. An apparatus as recited in claim 10, wherein said housing is configured for replacement of conventional light beacons.

12. An apparatus as recited in claim 10, wherein said means for directing said laser comprises a motorized stage for rotating the laser in a circular pattern.

13. An apparatus as recited in claim 10, wherein said means for directing said laser output beam comprises a motorized stage for rotating a mirror or lens for directing the laser output in a circular pattern.

14. An apparatus as recited in claim 10, wherein said substantially non-directional light source comprises a plurality of LEDs coupled to a flashing circuit.

15. An apparatus as recited in claim 10, wherein said substantially non-directional light source comprises a plurality of LEDs coupled to a rotating platform or directed to reflect from a rotating mirror assembly.

16. An apparatus for registering aircraft loading as an aircraft taxies, comprising:
a plurality of weight sensors configured for application to a taxiway and oriented at multiple different angles in relation to a given compass direction; and
means for generating aircraft loading information in response to the output signals from said plurality of weight sensors.

17. An apparatus as recited in claim 16, wherein said means for generating aircraft loading information comprises a computer element and programming configured for determining the weight applied at each landing gear to the taxiway, and the distribution of the weight between the landing gears.

18. An apparatus as recited in claim 16:
further comprising a display configured for being mounted in view of the pilot;
wherein said display is configured for displaying the registered total weight and weight distribution of the aircraft.

19. An apparatus as recited in claim 17:
further comprising a wind sensor configured for generating a signal in response to wind speed and direction for receipt by said controller; and
wherein said controller is configured for eliminating wind contributions to the measurement of loading.

20. An apparatus as recited in claim 16, wherein said multiple orientation of said sensors comprises a moving platform containing multiple sensors to register at least front to back weight distribution and/or side to side weight distribution and a movable platform configured for being rotated after all the wheels of an aircraft are moved into a position on the movable platform.

21. An apparatus for dropping aircraft power in response to airspeed, comprising:
a means for sensing airspeed;
a circuit for generating an over speed signal in response to the fast approach, or exceeding, of the aircraft V_{NE} airspeed; and
means for dropping aircraft power in response to receipt of said over speed signal.

22. An apparatus as recited in claim 21, further comprising means for preventing said apparatus from subsequently dropping aircraft power for a period of time after it is restored by the pilot.

23. An apparatus as recited in claim 21, wherein said apparatus is integrated within an autopilot system that remains active when the autopilot has not been selected for performing aircraft control functions according to an autopilot flight plan.

24. An apparatus as recited in claim 23, wherein said functions are integrated as programming within said autopilot system.

25. An apparatus as recited in claim 21, wherein said means for dropping aircraft power comprises an actuator which unlocks the throttle setting wherein a bias force moves the throttle to a lower setting.

26. An apparatus as recited in claim 21, wherein said means of sensing airspeed comprises a separate electronic airspeed sensing element, an aircraft airspeed sensor which generates an electrical output, or an electronic sensor which converts available airspeed information in an air pressure form or movement form into an electrical signal output.

27. An apparatus for automatically determining aircraft loading factors, comprising:
a strain sensor configured for mounting on each of the landing gear or wheels of an aircraft;
said strain sensors configured for registering the force applied to each of said landing gear from attached tire assemblies; and
means for determining aircraft loading in response to signals received from said strain sensors.

28. An apparatus as recited in claim 27, further comprising means for detecting wind direction and speed coupled to said means for determining aircraft loading.

29. An apparatus as recited in claim 27, wherein aircraft loading determination comprise displaying information relating to total load and the distribution of forces between the various landing gear.

30. An apparatus as recited in claim 27, further comprising means for computing a center of gravity for an aircraft based on said aircraft loading registered by said apparatus.

31. An apparatus as recited in claim 27, wherein said strain sensors communicated to said means for determining aircraft loading via a wireless communication link.

32. An apparatus as recited in claim 27, further comprising a display configured for outputting said aircraft loading information.

33. An apparatus as recited in claim 32, wherein said aircraft loading information is output in a graphical form.
